(19) United States
(12) Patent Application Publication
(10) Pub. No.: US 2026/0191224 A1
(43) Pub. Date: Jul. 9, 2026

(54) MIXED-USE REFRIGERATION MACHINE FOR EDIBLE PRODUCTS

(71) Applicant: Guangzhou Xin’an Trading Co., Ltd., Guangzhou (CN)

(72) Inventors: Xiangan Wu, Guangzhou (CN); Demin Zhu, Guangzhou (CN); Yongzhao Su, Guangzhou (CN); Guoliang Li, Guangzhou (CN); Wenzhan Hu, Guangzhou (CN); Quan Zhou, Guangzhou (CN)

(73) Assignee: Guangzhou Xin’an Trading Co., Ltd., Guangzhou (CN)

(21) Appl. No.: 19/559,329

(22) Filed: Mar. 6, 2026

Related U.S. Application Data
(63) Continuation-in-part of application No. 19/183,919, filed on Apr. 21, 2025.
(63) Continuation-in-part of application No. 19/082,164, filed on Mar. 17, 2025.
(63) Continuation-in-part of application No. 19/080,917, filed on Mar. 16, 2025.
(63) Continuation-in-part of application No. 19/079,609, filed on Mar. 14, 2025.
(63) Continuation-in-part of application No. 19/079,479, filed on Mar. 14, 2025.
(63) Continuation-in-part of application No. 19/079,536, filed on Mar. 14, 2025.
(63) Continuation-in-part of application No. 19/079,416, filed on Mar. 13, 2025.
(63) Continuation-in-part of application No. 19/078,343, filed on Mar. 13, 2025.
(63) Continuation-in-part of application No. 19/078,378, filed on Mar. 13, 2025.
(63) Continuation-in-part of application No. 29/991,965, filed on Mar. 5, 2025.
(63) Continuation-in-part of application No. 19/017,821, filed on Jan. 13, 2025.
(63) Continuation-in-part of application No. 19/006,353, filed on Dec. 31, 2024.
(63) Continuation-in-part of application No. 19/006,323, filed on Dec. 31, 2024.

(30) Foreign Application Priority Data
Aug. 20, 2024 (CN) 202422023774.8
Aug. 20, 2024 (CN) 202422023825.7
Aug. 29, 2024 (CN) 202411202973.3
Aug. 29, 2024 (CN) 202422118912.0
Aug. 29, 2024 (CN) 202422119009.6
Aug. 29, 2024 (CN) 202422120703.X
Aug. 29, 2024 (CN) 202422120722.2
Aug. 29, 2024 (CN) 202422120757.6
Aug. 29, 2024 (CN) 202422120855.X
Aug. 29, 2024 (CN) 202422120927.0
Sep. 5, 2024 (CN) 202411243857.6
Sep. 5, 2024 (CN) 202422182973.3
Sep. 5, 2024 (CN) 202422184804.3
Sep. 5, 2024 (CN) 202422184814.7
Sep. 5, 2024 (CN) 202422184878.7
Sep. 5, 2024 (CN) 202422184896.5
Sep. 5, 2024 (CN) 202430568536.8
Dec. 13, 2024 (CN) 202411842325.4
Dec. 13, 2024 (CN) 202423089608.4
Jan. 23, 2025 (CN) 202520163298.1

(51) Int. Cl. A23G 9/22; A23G 9/28

(52) U.S. Cl. CPC A23G 9/228; A23G 9/224; A23G 9/28

(57) ABSTRACT

A mixed-use beverage making apparatus is disclosed. The apparatus includes a cooling/mixing vessel defining a vessel chamber for receiving ingredients for producing the edible product and an agitator rotatably disposed in the vessel chamber for mixing the ingredients, a refrigeration system associated with the cooling/mixing vessel to refrigerate the ingredients, a mixing motor coupled to the agitator to rotate the agitator, a temperature sensor operatively arranged to measure a temperature of the ingredients, a current sensor configured to measure operation of the mixing motor, and an electronic controller operatively associated with the refrigeration system and the mixing motor and in communication with the temperature sensor and the current sensor.

### CROSS-REFERENCE TO RELATED APPLICATIONS

This application is a continuation-in-part of U.S. application Ser. No. 19/017,821, filed Jan. 13, 2025, which claims priority to Chinese application No. 2024220238257, filed on Aug. 20, 2024; and is a continuation-in-part of U.S. Ser. No. 19/006,323, filed on Dec. 31, 2024, which claims priority to Chinese application No. 2024112438576, filed Sep. 5, 2024, Chinese application No. 2024221829733, filed Sep. 5, 2024, to Chinese application No. 2024112029733, filed on Aug. 29, 2024, and to Chinese application No. 2024221209270, filed on Aug. 29, 2024; and is a continuation-in-part of U.S. Ser. No. 19/006,353, filed on Dec. 31, 2024, which claims priority to Chinese application No. 2024221848043, filed on Sep. 5, 2024, and to Chinese application No. 2024221207222, filed on Aug. 29, 2024; and is a continuation-in-part of U.S. design application Ser. No. 29/991,965, filed on Mar. 3, 2025, which claims priority to Chinese application No. 2024305685368, filed on Sep. 5, 2024; and is a continuation-in-part of U.S. Ser. No. 19/079,536, filed on Mar. 14, 2025, which claims priority to Chinese application No. 2024221848787, filed on Sep. 5, 2024, and to Chinese application No. 202422120703X, filed on Aug. 29, 2024; and is a continuation-in-part of U.S. Ser. No. 19/080,917, filed on Mar. 16, 2025, which claims priority to Chinese application No. 2024221848147, filed on Sep. 5, 2024, and to Chinese application No. 2024221190096, filed on Aug. 29, 2024; and is a continuation-in-part of U.S. Ser. No. 19/078,378, filed on Mar. 13, 2025, which claims priority to Chinese application no. 2024221848965, filed on Sep. 5, 2024, and to Chinese application No. 2024221207576, filed on Aug. 29, 2024; and is a continuation-in-part of U.S. Ser. No. 19/078,343, filed on Mar. 13, 2025, which claims priority to Chinese application No. 2024221189120, filed on Aug. 29, 2024; and is a continuation-in-part of U.S. Ser. No. 19/082,164, filed on Mar. 17, 2025, which claims priority to Chinese application No. 202422120855X, filed on Aug. 29, 2024; and is a continuation-in-part of U.S. Ser. No. 19/079,416, filed on Mar. 13, 2025, which claims priority to Chinese application No. 2024220237748, filed on Aug. 20, 2024; and is a continuation-in-part of U.S. Ser. No. 19/079,479, filed on Mar. 14, 2025, which claims priority to Chinese application No. 2024230896084, filed on Dec. 13, 2024; and is a continuation-in-part of U.S. Ser. No. 19/079,609, filed on Mar. 14, 2025, which claims priority to Chinese application No. 2024118423254, filed on Dec. 13, 2024; and is a continuation-in-part of U.S. Ser. No. 19/183,919, filed on Apr. 21, 2025; which claims priority to Chinese application No. 2024221207222, filed on Aug. 29, 2024, to Chinese application No. 2024221848043, filed on Sep. 5, 2024, and to Chinese application No. 2025201632981, filed on Jan. 23, 2025. The disclosures of the aforementioned applications are hereby incorporated by reference in their entireties.

### TECHNICAL FIELD.

The present disclosure relates to a refrigeration machine for preparing edibles at a low temperature and, more particularly, to a versatile mixed-use machine for preparing a variety of edibles at different temperatures and of differing phases and consistencies.

### BACKGROUND

A variety of different machines are available for the production of frozen or low-temperatures edible products and beverages. These products and the machines for producing them vary between serving temperature, consistency, and texture. For example, an ice cream machine produces a solid frozen edible product consisting of frozen dairy milk with other ingredients mixed for flavoring, sweetening, and texture. An ice cream machine typically includes a freezing cylinder in which the temperature of the ingredients are lowered by refrigeration while simultaneously being churned by a paddle or dasher to entrain air into the frozen concoction. The entrapment of air provides a softer more enjoyable texture to the ice cream.

Other types of machines may be designed to produce semi-frozen products and beverages such as smoothies or slushies. These semi-frozen beverages are produced by mixing the ingredients in a refrigerated container to a low temperature where ice particles begin forming yet the product remains in a substantially flowable state. Other low temperature edibles that may be produced by dedicated machines include sorbet, gelato, and soft serve. The machines for producing the low-temperature products differ in operation and capabilities to regulate characteristics such as temperature and mixing speed which determines the properties of the produced product.

A class of refrigeration machines are designated as mixed-use machines and are designed to be highly configurable and versatile to produce edible products that differ greatly in temperature, consistency, and texture. Mixed-use machines produce a variety of edible products including frozen and solidified ice creams and readily flowable beverages such as slushies, juices, and alcohol-containing cocktails like margaritas and daiquiris. The present disclosure is directed at improvements and advances in refrigeration machines and techniques to improve suitability for mixed-use operation in commercial environments.

### SUMMARY

In an aspect of the disclosure, there is described a beverage making apparatus for preparing an edible product. The apparatus includes a cooling/mixing vessel defining a vessel chamber for receiving ingredients for producing the edible product and an agitator rotatably disposed in the vessel chamber for mixing the ingredients, a refrigeration system associated with the cooling/mixing vessel to refrigerate the ingredients, a mixing motor coupled to the agitator to rotate the agitator, a temperature sensor operatively arranged to measure a temperature of the ingredients, a current sensor configured to measure operation of the mixing motor, and an electronic controller operatively associated with the refrigeration system and the mixing motor and in communication with the temperature sensor and the current sensor. The electronic controller is programmed to regulate operation of the mixed-use refrigeration machine in a torque mode in response to measurements from the current sensor and in a temperature mode in response to measurements from the temperature sensor.

In an aspect, the beverage making apparatus further includes a control panel operatively associated with the electronic controller. The control panel is adapted to receive a user input causing the electronic controller to operate in one of the torque mode and the temperature mode.

In an aspect, during the torque mode of the operation of the apparatus, the electronic controller compares a current draw of the mixing motor measured by the current sensor with a threshold current that is indicative of a high viscosity associated with the ingredients. In response to the current draw matching or exceeding the current threshold, the electronic controller switches to regulate operation of the mixed-use refrigeration machine in a temperature maintenance mode that is responsive to measurements from the temperature sensor. During the temperature maintenance mode, the electronic controller is configured to compares the temperature measurements with a temperature threshold corresponding to the high viscosity of the ingredients and activate and deactivate the refrigeration system responsively to the comparison of temperature measurements and the temperature threshold.

In an aspect, during the temperature mode the electronic controller is configured to compare measurements from the temperature sensor with a liquid temperature threshold indicative of a user input. In response to the temperature measurements less than or equal to the liquid temperature threshold, the electronic controller switches to regulate operation of the mixed-use refrigeration machine in a temperature maintenance mode. During the temperature maintenance mode, the electronic controller is configured to compares the temperature measurements with the temperature threshold, and activate and deactivate the refrigeration system responsively to the comparison of temperature measurements and the temperature threshold.

In aspect, the mixing motor is a variable speed motor and the electronic controller is configured to operate the mixing motor at a first mixing speed and a second maintenance speed, and the first mixing speed is faster than the second maintenance speed.

In an aspect, the electronic controller is configured to determine the ingredients are being dispensed from the vessel chamber and respond by increasing a speed of the mixing motor.

In an aspect, the beverage making apparatus further includes a dispensing apparatus mounted with respect to the cooling/mixing vessel to dispense the ingredients from the vessel chamber, the dispensing apparatus associated with a handle for controlling dispensing.

In an aspect, the beverage making apparatus further includes an optical sensor configured to detect operation of the handle.

In an aspect, the dispensing apparatus is detachably mounted to an exterior housing of the mixed-use refrigeration machine. The optical sensor is disposed on the exterior housing. The optical sensor further includes an infrared generator configured to direct light toward the handle and an infrared receiver configured to receive light reflected from the handle.

In an aspect, the cooling/mixing vessel further defines a vessel axis extending between a first axial end and a second axial, the second axial end associated with a dispensing outlet. The mixed-use refrigeration machine further includes a mounting clamp for mounting the dispensing apparatus to the exterior housing. The mounting clamp is configured as a twist lock with tabs and recesses engaged by rotation with respect to the vessel axis. The mounting clamp applies an axial force parallel to the vessel axis upon engagement by rotation with respect to the vessel axis.

In an aspect, the cooling/mixing vessel and the refrigeration system are operatively arranged for external cooling. The refrigeration system includes a refrigerant conduit located externally on a vessel barrel surrounding the vessel chamber. The cooling/mixing vessel includes a thawing gap proximate a dispensing outlet of the vessel barrel, the thawing gap characterized by the absence of the refrigerant conduit.

In an aspect, the cooling/mixing vessel further defines a vessel axis extending between a first axial end and a second axial. The agitator includes at least one stirring blade spirally disposed about an agitator shaft coaxially aligned with the vessel axis. The at least one stirring blade and the agitator shaft radially offset from each other to define an agitator void for movement of the ingredients parallel to the vessel axis.

In an aspect, there is described a method of preparing low-temperature edible products using a mixed-use refrigeration machine. The method includes receiving a user input indicative of a desired edible product, receiving ingredients into a cooling/mixing vessel of the mixed-use refrigeration machine, mixing the ingredients in the cooling/mixing vessel with an agitator coupled to a mixing motor, cooling the ingredients in the cooling/mixing vessel with a refrigeration system operative associated with the cool/mixing vessel, and in response to the user input, operating the cooling/mixing vessel in one of a torque mode responsive to operation of the mixing motor and a temperature mode responsive to temperature measurements of the ingredients.

In an aspect, the method further includes, during the torque mode, comparing a current draw of the mixing motor with a threshold current that is indicative of a high viscosity associated with the ingredients and maintaining a temperature of the ingredients in response to the current draw matching or exceeding the current threshold.

In an aspect, the step of maintaining the temperature of the ingredients further includes reducing a speed of the mixing motor and modulating the refrigeration system responsively to comparing the temperature measurements and a temperature threshold corresponding to the high viscosity of the ingredients.

In an aspect, the method further includes, during the temperature mode, comparing the temperature measurements with a liquid temperature threshold indicative of the desired edible product and modulating the refrigeration system in response to comparing the temperature measurements with the liquid temperature threshold.

In an aspect, the method further includes determining whether the ingredients are being dispensed from the cooling/mixing vessel and responsively increasing a speed of the mixing motor.

In an aspect, the step of determining whether the ingredients are being dispensed includes directing light to a handle of a dispensing apparatus associated with the cooling/mixing vessel and receiving the light, by an optical sensor, reflected from the handle.

In an aspect, the method further includes modulating the rotation of the mixing motor by reversing direction.

In an aspect, there is described a mixed-use refrigeration apparatus for preparing edible products. The apparatus includes a user-input unit for receiving a user input indicative of a desired edible product, a vessel defining a vessel chamber for receiving ingredients and an agitator rotatably disposed in the vessel chamber for mixing the ingredients, a refrigeration system associated with the cooling/mixing vessel to refrigerate the ingredients, a motor coupled to the agitator to rotate the agitator, and an electronic controller operatively associated with the motor and the refrigeration system and programmed to control the motor and the refrigeration system, in response to the user input, to selectively form the desired edible product in a first mode and form the desired edible product in a second mode according to the user input. The desired edible product in the first mode includes an ice cream product and the desired edible product in the second mode includes a liquid product.

The disclosure also describes a refrigeration machine for preparing edible products including an exterior housing and a cooling/mixing vessel disposed in the exterior housing. The cooling/mixing vessel defines a vessel chamber and a vessel axis extending between a first axial end and a second axial associated with a dispensing outlet. The refrigeration machine includes an agitator rotatably disposed in the vessel chamber for mixing ingredients introduced to the cooling/mixing vessel. The refrigeration machine includes a refrigeration system associated with the cooling/mixing vessel to refrigerate the ingredients in the vessel chamber. The refrigeration machine also includes a dispensing apparatus detachably mountable to the exterior housing by a mounting clamp to cover the dispensing outlet at the second axial end.

In an aspect, the mounting clamp operates by rotation with respect to the vessel axis.

In an aspect, the mounting clamp is configured as a twist lock with tabs and recesses engaged by rotation with respect to the vessel axis.

In an aspect, the mounting clamp applies an axial force parallel to the vessel axis upon engagement by rotation with respect to the vessel axis.

In an aspect, the exterior housing comprises a front panel having a dispensing opening and an annular mounting recess concentricly aligned to the vessel axis.

In an aspect, the dispensing apparatus comprises a dispensing cap having a mounting ring installable in the annular mounting recess to engage the mounting clamp.

In an aspect, the mounting clamp comprises a plurality of first engaging blocks located angularly about the mounting ring and a plurality of second engaging blocks located angularly about the annular mounting recess.

In an aspect, the pluralities of first and second engaging blocks each have a L-shaped geometry including an axial leg parallel with the vessel axis and a circumferential leg circumferential to the vessel axis.

In an aspect, the pluralities of the first and second engaging blocks is configured as a female structure having a female socket disposed with the circumferential leg and the other of the pluralities of the first and second engaging blocks is configured as a male structure having a male protrusion disposed with the circumferential leg.

In an aspect, the refrigeration machine further comprises a microswitch configured to detect mounting of the dispensing apparatus.

In an aspect, the microswitch is located on the front panel proximate to the dispensing opening to interact with the dispensing apparatus.

In a further aspect, the front panel includes a reference hole arranged circumferentially with respect to the vessel axis and the microswitch interacts with the dispensing apparatus via the reference hole.

In an aspect, the microswitch includes a contact that extends through the reference hole and arranged to contact the dispensing apparatus when mounted to the front panel.

In an aspect, the microswitch is operatively associated with a mixing motor coupled to the agitator and controls operation of the mixing motor.

In an aspect, the mounting clamp is associated with a keying feature to align the dispensing apparatus with the annular mounting recess of the front panel.

In an aspect, the dispensing apparatus is associated with a handle for controlling dispensing of ingredients from the cooling/mixing vessel.

In an aspect, the dispensing apparatus comprises an dispensing cap having an annular sidewall concentric to the vessel axis and an axial plate perpendicular to the vessel sidewall.

In an aspect, a dispensing port is disposed through the axial plate establishing communication with the vessel chamber for dispensing the ingredients.

In an aspect, the handle is operatively connected to a sealing valve to open and close the dispensing port.

In an aspect, the dispensing apparatus comprises a spout with a dispensing plate oriented perpendicular to the vessel axis.

In an aspect, the sealing valve is configured to open and close the dispensing port.

The disclosure also describes a refrigeration machine for preparing low-temperature edible products including a cooling/mixing vessel defining a vessel chamber for receiving ingredients for producing the edible product. The cooling/mixing vessel comprising a barrel wall that is cylindrical and that is concentrically disposed around a vessel axis. The refrigeration machine includes an agitator rotatably disposed in the vessel chamber for mixing the ingredients, the agitator including at least one stirring blade spirally disposed about an agitator shaft coaxially aligned with the vessel axis. The at least one stirring blade and the agitator shaft are radially offset from each other to define an agitator void for movement of the ingredients parallel to the vessel axis. The refrigeration machine includes a refrigeration system associated with the cooling/mixing vessel to refrigerate the ingredients, the refrigeration system comprising a refrigerant conduit that is annularly wound exteriorly on the barrel wall for external cooling.

In an aspect, the at least one stirring blade is radially coextensive interiorly to the barrel wall to provide a running clearance.

In an aspect, the cooling/mixing vessel comprises a first axial end associated with a feed inlet and a second axial end associated with a dispensing outlet.

In an aspect, the cooling/mixing is associated with a thawing gap proximate the second axial end characterized by absence of the refrigerant conduit.

In an aspect, the refrigeration machine further comprises a dispensing apparatus mounted proximate to the second axial end to cover the dispensing outlet.

In an aspect, the dispensing apparatus comprises a spout that is operatively associated with a dispensing plate oriented perpendicular to the vessel axis, the spout configured to redirect ingredients from flowing parallel with the vessel axis to flowing perpendicular to the vessel axis through the dispensing plate.

In an aspect, the dispensing apparatus comprises a handle and a sealing valve that are operative to close the dispensing plate.

In an aspect, the spout include a U-shaped shroud and the sealing valve moves within the U-shaped shroud perpendicular to the vessel axis.

In an aspect, the dispensing apparatus is mounted by a mounting clamp that engage by rotation of the dispensing apparatus with respect to the vessel axis.

In an aspect, the dispensing apparatus comprises a dispensing cap having an annular sidewall disposed around the vessel axis and an axial plate perpendicular to the vessel sidewall.

In an aspect, the dispensing cap defines a dispensing cavity and the at least one stirring blade extends axially into the dispensing cavity.

In an aspect, a dispensing port is disposed through the axial plate establishing communication with the vessel chamber for dispensing the ingredients.

In an aspect, the at least one stirring blade is associated with a reflow flange adapted to rotate past the dispensing port.

In an aspect, the reflow flange includes an L-shaped plate that connects the at least one stirring blade to the agitator shaft.

In an aspect, the reflow flange defines a reflow groove adapted to direct flow ingredients toward the first axial end upon rotation of the agitator.

In an aspect, the refrigeration machine comprises a mixing motor operatively coupled to the agitator through a first axial end of the cooling/mixing vessel via a coupling assembly.

In an aspect, the refrigeration machine further comprises an insulation housing accommodating the cooling/mixing vessel.

In an aspect, the coupling assembly include a first coupling seat disposed between the cooling/mixing vessel and the insulation housing and a second coupling seat located exteriorly of the insulation housing.

In an aspect, the coupling assembly includes a rotating shaft that is coaxial to vessel axis and that extend through the first coupling seat and the second coupling seat.

In an aspect, the coupling assembly includes an anti-rotation sleeve fixedly disposed with respect to the first coupling seat, the anti-rotation sleeve accommodating a first seal fixed in rotation to the rotating shaft.

A possible advantage of the disclosed beverage making apparatus is that it provides a mixed-use function that allows for preparation of different desired edible products, such as ice cream, soft serve, slushies, smoothies, semi-frozen juices, flavored ices, and other cold beverages, which can only be prepared using different dedicated conventional machines.

### BRIEF DESCRIPTION OF THE DRAWINGS

FIG. 1 is a perspective view of a mixed-use machine for preparing low temperature edibles and beverages in accordance with the disclosure.

FIG. 2 is another perspective view of the mixed-use machine.

FIG. 3 is a perspective view of the rear of the mixed-used machine.

FIG. 4 is a schematic diagram of an electronic controller and control system for the mixed-use machine.

FIG. 5 is a perspective view of the mixed-use machine with the exterior coverings removed to show the internal arrangement of the operative components.

FIG. 6 is another perspective view of the mixed-use machine with the exterior coverings removed.

FIG. 7 is a perspective view of the mixed-use machine with the internal components removed to show the upright stand corresponding to the supporting framework.

FIG. 8 is an elevational view of the mixed-use machine showing the horizontal mounting arrangement of the cooling/mixing vessel aligned with the longitudinal direction.

FIG. 9 is a sectional view of the mixed-use machine showing the cooling/mixing vessel in the horizontal mounting arrangement in the upper space and operatively connected with the dispensing assembly, the hopper, and the mixing motor.

FIG. 10 is a sectional view of the cooling/mixing vessel having an agitator rotatably disposed therein and a refrigerant conduit exteriorly wound about the barrel wall.

FIG. 11 is a detailed view of a thawing gap between the refrigerant conduit and the second axial end of the cooling/mixing vessel.

FIG. 12 is a schematic view of a temperature sensor for the cooling/mixing vessel.

FIG. 13 is an exploded view of the cooling/mixing vessel showing the assembly of the vessel barrel with respect to the feed inlet.

FIG. 14 is another exploded view of the cooling/mixing vessel showing the assembly of the vessel barrel with respect to the feed inlet.

FIG. 15 is an assembly schematic of the cooling/mixing vessel showing assembly of the agitator, vessel barrel, dispensing apparatus and mixing motor.

FIG. 16 is a perspective view of the agitator embodied in a twin blade configuration with first and second stirring blades helically wound around an agitator shaft.

FIG. 17 is detailed view of the dispensing port associated with the dispensing assembly.

FIG. 18 is a perspective view of the insulation housing for accommodating the cooling/mixing vessel operatively coupled to the mixing motor.

FIG. 19 is perspective view of the insulation housing defining a drive mounting hole through the rear housing panel.

FIG. 20 is an exploded view of the drive coupling assembly disposed between the mixing motor and the cooling/mixing vessel.

FIG. 21 is an exploded view of the drive coupling assembly.

FIG. 22 is a sectional view of the drive coupling assembly coupling the mixing motor to the cooling/mixing vessel through the insulation housing.

FIG. 23 is detailed view of the drive coupling assembly as indicated in FIG. 22.

FIG. 24 is an exploded view of the mixed-used refrigeration machine showing the dispensing apparatus detachably mountable to the front panel of the exterior housing.

FIG. 25 is a perspective view of the rear of the dispensing apparatus configured with a mounting clamp including a plurality of radial tabs for detachably mounting to the exterior housing.

FIG. 26 is a perspective view of the front panel of the exterior housing configured with a corresponding plurality of interlocking recesses associated with the mounting clamp.

FIG. 27 is a perspective view of the rear of the dispensing apparatus showing an embodiment having a circumferentially engageable mounting clamp.

FIG. 28 is a perspective view the front panel of the exterior housing configured with the circumferentially engageable mounting clamp.

FIG. 29 is a detailed view of a female socket of the circumferentially engageable mounting clamp as indicated in FIG. 27.

FIG. 30 is a detailed view of the male protrusion of the circumferentially engageable mounting clamp as indicated in FIG. 28.

FIG. 31 is another detailed view of the male protrusion of the circumferentially engageable mounting clamp.

FIG. 32 is an exploded view of the mixed-used refrigeration machine showing the dispensing apparatus and front panel attachable to the exterior housing.

FIG. 33 is a detailed view of the arrangement of the mounting clamp arranged attachable to the front panel of the exterior housing associated with a microswitch sensor as indicated in FIG. 32.

FIG. 34 is a perspective view of the mixed-used refrigeration machine showing the ceiling panel removed and the front panel associated with an optical sensor to sense movement of the handle associated with the dispensing assembly.

FIG. 35 is a detailed view of the microswitch located on the front panel engaging with mounting clamp of the dispensing assembly.

FIG. 36 is an exploded view of the dispensing apparatus showing the handle and spout detached from the dispensing cap.

FIG. 37 is an exploded view of the handle operatively connected to a sealing valve via a linkage.

FIG. 38 is a schematic sectional view illustrating the dispensing apparatus in a closed configuration with the handle positioned upright and the sealing valve occluding the dispensing port and dispensing disk.

FIG. 39 is a schematic sectional view illustrating the dispensing apparatus in an open configuration with the sealing valve internally moved by the handle pivoted to move the sealing valve vertically away from the dispensing port and dispensing valve.

FIG. 40 is a perspective view of the sealing valve in operative relation to a link of the linkage.

FIG. 41 is another perspective of the sealing valve in operative relation to the link of the linkage.

FIG. 42 is a detailed view of the optical sensor associated with the front panel of the exterior housing showing the arrangement of the optical sensor with respect to the handle as indicated in FIG. 34.

FIG. 43 is a perspective view of another embodiment of the exterior housing for the mixed-use refrigeration machine.

FIG. 44 is a sectional view of the embodiment of the mixed-use refrigeration machine of FIG. 43.

FIG. 45 is a flow diagram of an algorithm for regulating operation of the refrigeration machine in a mixed-use capacity to produce a variety of low-temperature products.

FIG. 46 is a flow diagram of a maintenance operation to maintain the characteristics of the content of the cooling/mixing vessel.

### DETAILED DESCRIPTION

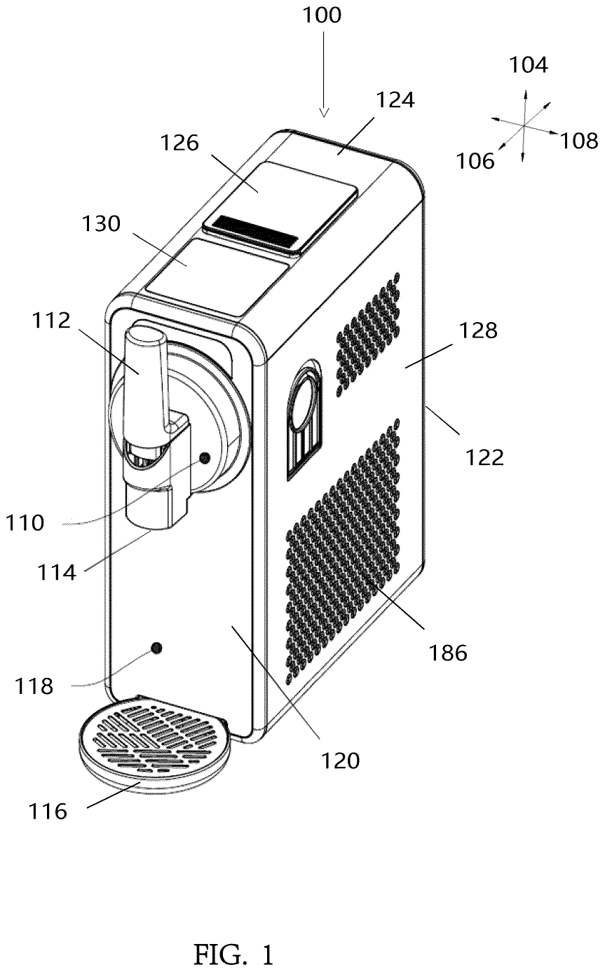

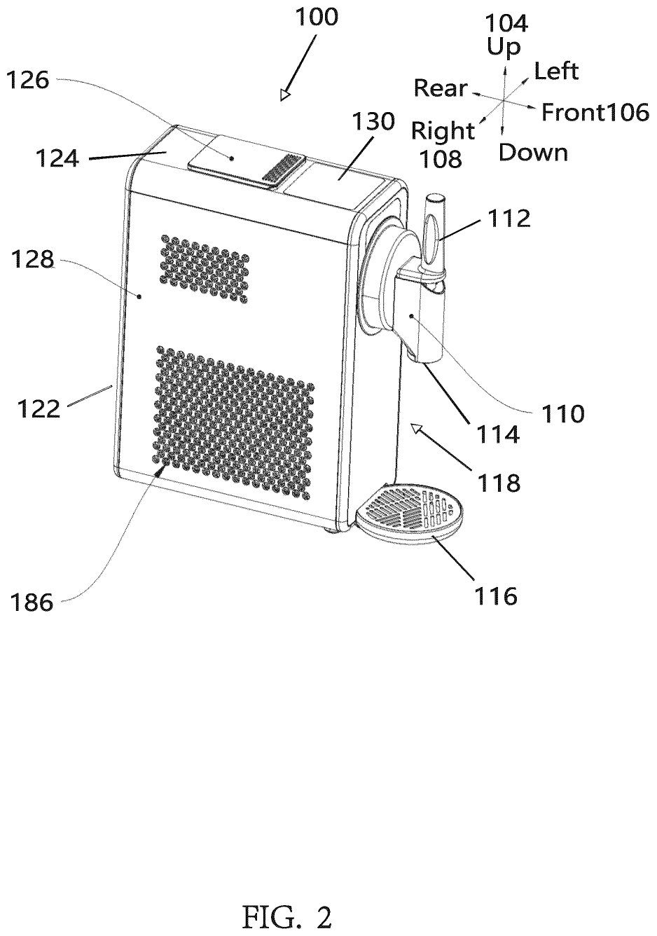

Now referring to the drawings, wherein whenever possible like reference numbers refer to like elements, there is illustrated in FIGS. 1 and 2 an example of a mixed-use refrigeration machine 100 for the preparation of frozen edibles and cold beverages at low temperatures for consumption. Examples of edible products include frozen desserts and confectionaries such as ice cream, gelato, frozen yogurt and sorbet. Further examples include semi-frozen or cold liquid drinks like slushies, smoothies, semi-frozen juices, flavored ices, and juice. The mixed-use refrigeration machine 100 makes a variety of these edibles at the desired low temperatures and consistency for individual consumption in a continuous or sustained operation. The refrigeration machine 100 includes features and operational techniques that enhance versatility for the production of several different edible products as characterized by different serving temperatures and/or consistencies.

The illustrated embodiment of the mixed-use refrigeration machine 100 is intended for retail or commercial settings where the machine is designed to repeatedly produce and dispense many servings of the edible product for individual consumption in a continuous or sustained manner. However, aspects of the disclosure may also apply to larger-scale batch production as well as to domestic or home-use applications. The mixed-use refrigeration machine 100 should demonstrate durability and ruggedness, simplicity of operation and use, and ease of cleaning and decontamination for sanitation. While the disclosure may describe a commercial configuration of the beverage making apparatus, aspects of the disclosure may be applicable to other settings and uses, including configurations to make proportionally larger batches.

As shown in FIGS. 1 and 2, the mixed-use refrigeration machine 100 can be supported on a horizontal surface such as a shelf or counter and may be geometrically configured to have a minimal footprint and to reduce the counterspace required. The mixed-use refrigeration machine 100 can have an overall prismatic shape and is adapted to stand upright on the horizontal surface or shelf. For example, the mixed-use refrigeration machine 100 can include an exterior housing 102 or casing that accommodates the internal components and is generally rectangular or cubic in shape. For reference purposes, the mixed-use refrigeration machine 100 can be associated with an upright or vertical direction 104, a longitudinal direction 106 that determines the front and rear of the external housing 102, and a lateral direction 108 that corresponds to the width of the mixed-use refrigeration machine 100. The reference coordinates intersect at right angles.

Located at the front of the mixed-use refrigeration machine 100 is a dispensing apparatus 110 or assembly through which the consumable beverage or product is dispensed to a container such as a cup or mug. The dispensing apparatus 110 is configured as a spigot or a tap for the controlled discharge of the product and can include a handle 112 for operation. The handle 112 is operatively associated with an internal valving mechanism that is opened and closed for controlling fluid flow. The handle 112 may be lever-type which is manipulated by pivoting the upright handle 112 longitudinally forward to commence dispensing of the product and can be returned to the upright position for ceasing flow. The handle 112 may also utilize other mechanisms and can be manipulated by rotating or linear displacement. The handle 112 can be a frustum structure the tapers in diameter from top to bottom to provide greater supporting area and enhance stability when grasped.

The dispensing apparatus 110 also includes a spout 114 that is directed vertically downward to guide the edible product to exit from the mixed-use refrigeration machine 100 and fall under the effect of gravity to the serving container. Located vertically below the spout 114 can be drip tray 116 or waste plate that can capture and accommodate any spillage. The dispensing apparatus 110 and the drip tray 116 may comprise a dispensing region 118 of the mix-used machine 110 and is located at the forward face or front of the exterior housing 102. Preferably the dispensing region associated with the dispensing apparatus 110 and drip tray 116 is sufficient to accommodate a variety of serving containers including cups, bowels, cones, mugs, etc.

The prismatic shape of the exterior housing 102 can include a forward or front panel 120 from which projects the dispensing apparatus 110 and the drip tray 116 which are spatially fixed in location. The front panel 120 can be a planar component having a rectangular shape to conform with the prismatic or cubic shape of the exterior housing 102. The front panel 120 and the other components of the exterior housing 102 can be made from a vacuum molding process although other materials and manufacturing methods are possible.

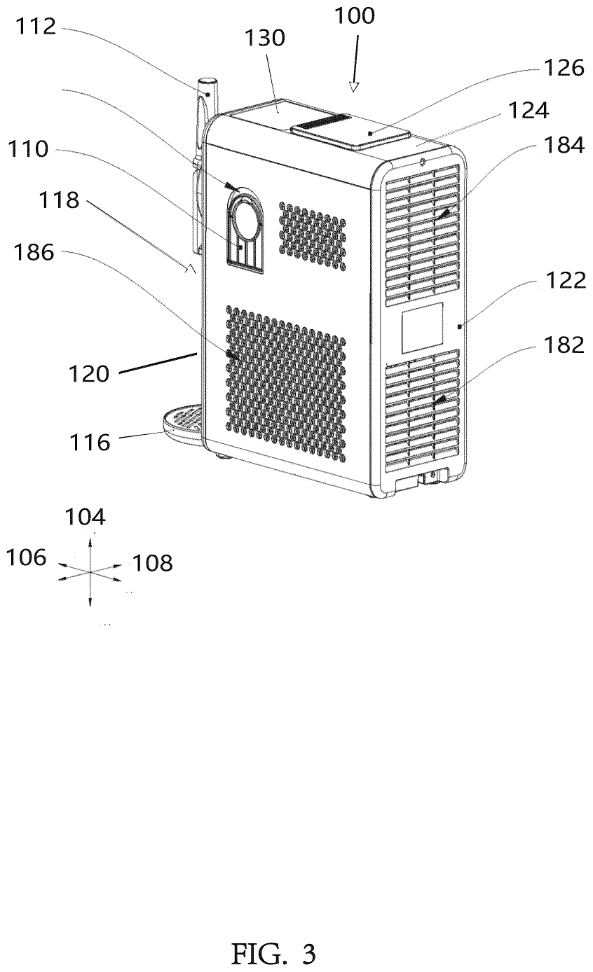

Referring to FIG. 3, there is located opposite the front panel 120 in the longitudinal direction 106 a rearward panel 122 that can have a similar rectangular outline. To cool the interior of the exterior housing 102, the rear panel 122 can include a plurality of vents or gratings, which may be supplemented by internal fans to increase airflow. The rear panel 122 can also include various ports and connectors for making external connections. For example, to power the mixed-use refrigeration machine 100, a power cord can extend from the rear panel 122 that can be configured for plugging into a conventional electrical socket to receive 120 V/60 Hz or 220 V/50 Hz electricity. In possible embodiments, the rear panel 122 can also include fluid ports to receive water and data ports such as USB ports for exchange of electronic information.

The top of the exterior housing 102 can include a ceiling panel 124 which defines the upright extension of the exterior housing 102 in the vertical direction 104. To receive the ingredients for making the beverage or frozen edible product, a hopper 126 can be disposed in the ceiling panel 124. The hopper 126 corresponds to the upstream entrance to the mixed-use refrigeration machine 100 and is located in the upper ceiling panel 124 of the exterior housing 102 for accessibility and to assist in gravity-feeding the ingredients to the internal processes of the mixed-use refrigeration machine 100. The exterior housing 102 may also include first and second side panels 128 that are parallel and spaced apart from each other in the lateral direction 108.

To operate the mixed-use refrigeration machine 100, a control panel 130 can be located at a readily accessible position on the exterior housing 102 such as the ceiling panel 124. The control panel 130 functions as a user interface and can receive commands and can output status information regarding operation of the mixed-use refrigeration machine 100. In an embodiment, the control panel 130 can be a visual display such as an LCD display with touchscreen capabilities. In an embodiment, the control panel 130 can be a manual interface with tactile buttons and switches, LED indicator lights, and similar manual controls. The controls and settings associated with the control panel 130 include characteristics like product selection, temperature, thickness and consistency, and other properties of the edible products being produced.

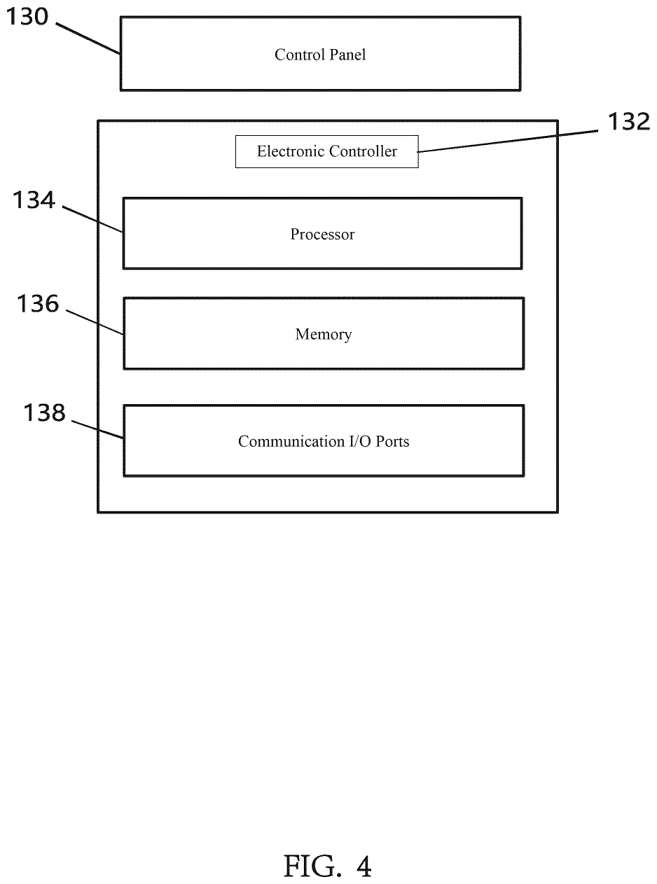

Referring to FIG. 4, to regulate the operations and processes for producing the edible products, the control panel 130 is functionally associated with an electronic control unit or module referred herein as an electronic controller 132. The electronic controller 132 is an electronic or computer-enabled device configured for active and automated control and execution of operations and functions associated with the mixed-use refrigeration machine 100. The electronic controller 132 can be embedded system with the hardware and functionality located on a signal chip or package, although in possible configurations the functionality of the electronic controller 132 may be distributed on a plurality of devices.

The electronic controller 132 can include processor 134 that can include digital circuitry and logic circuits capable of conducting logic operations. The microprocessor 134 can be embodied as a central processing unit (CPU), an application specific integrated circuit (ASIC), or a field programmable gate array (FPGA) comprising a plurality of transistors and similar circuits that are capable of reading, manipulating and outputting data in electronic form. The processor 134 can include logic circuits for processing computer readable programs and applications embodied in executable software code and written in a suitable programming language.

The electronic controller 132 can include non-transient programmable memory 136 or other data storage capabilities that may be in random access memory or more permanent non-volatile forms of data storage media. Common examples of computer-readable memory 136 include RAM, PROM, and EPROM, a FLASH-EPROM, and any other memory chip or cartridge. The memory 136 is capable of storing software instructions form the computer executable programs and applications including instructions and associated data that can be read and processed by the microprocessor 134. The software and data may take the form of instruction sets, rules, definitions, applications, routines, libraries, databases, lookup tables, data sets, and the like.

To exchange information and send commands, the electronic controller 132 can include one or more input/output (I/O) communication ports 138. The communication ports 138 can send and receive data and information in the form of electronic data signals transmitted through electrical conductors including wires, conductive traces, and communication busses. The communication ports 138 can operate on any appropriate communication protocol.

### Compact Mixed-Use Refrigeration Machine

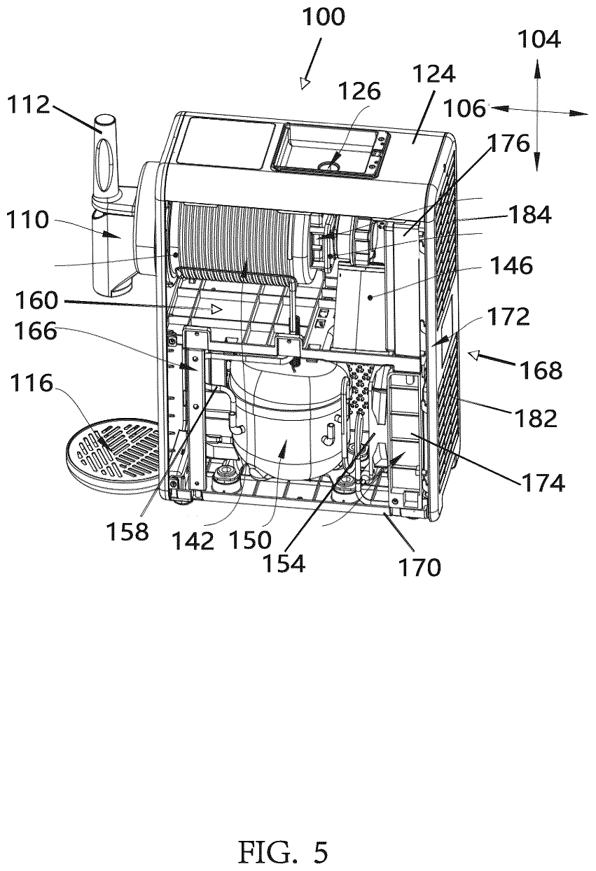

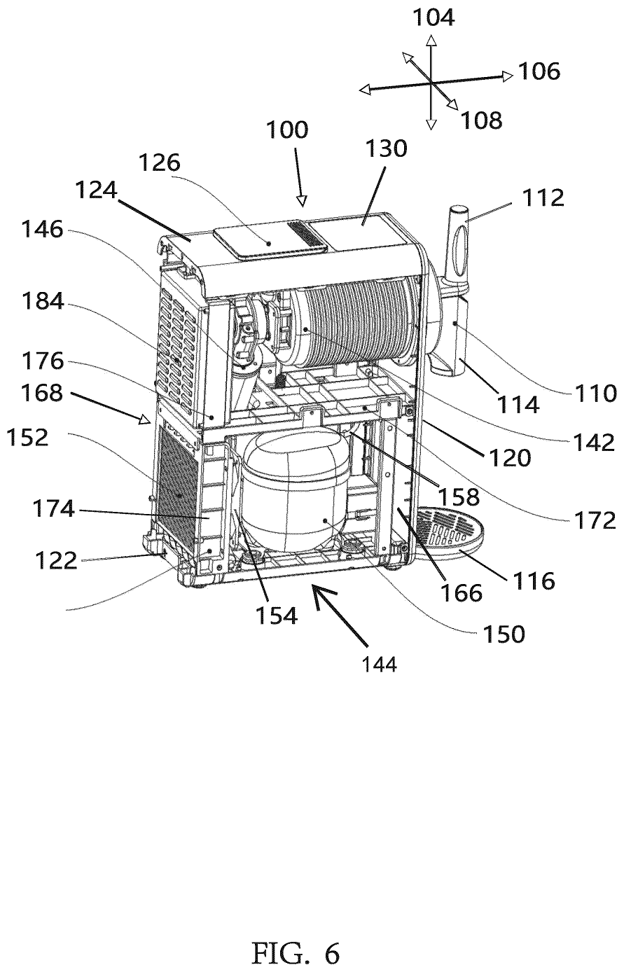

Referring to FIGS. 5 and 6, the panels of the exterior housing 102 are detachable and can be removed to access the interior of the mixed-use refrigeration machine 100 for maintenance and cleaning. The panels of the exterior housing 102 can be attached to an upright stand 140 that functions as a supporting framework of the mixed-use refrigeration machine 100. The upright stand 140 can be a rigid structure that fixates and braces the internal systems and assemblies in spatial relation to each other and with respect to the reference coordinate system including the vertical direction 104, the longitudinal direction 106, and lateral direction 108. The upright stand 140 provides structural support for the internal components of the mixed-use refrigeration machine 100 enhancing stability during installation and operation.

The upright stand 140 can be made from mold plastic components that are joined together by fasteners or snap fit connections, although in other examples, the upright stand 140 can be made from metal beams and plates like steel or aluminum. The upright stand 140 assists in organizing the fluid piping and conduits, which may comprise rigid tubes and/or flexible hoses and/or machined bore holes and/or other suitable fluid conduits, and electrical conductors such as conductive wiring for conducting power and/or data control signals inside the exterior housing 102. The arrangement of systems and assemblies in the FIGS. is exemplary only and may vary in different embodiments.

A primary function of the mixed-use refrigeration machine 100 is to reduce the temperature of the ingredients to produce the cold beverage or frozen edible product at low temperatures. The mixed-use refrigeration machine 100 is accordingly constructed to conduct a thermodynamic refrigeration cycle and the operative components may include a cooling/mixing vessel 142 for the mixing and cooling of the ingredients and a refrigeration system 144. The cooling/mixing vessel 142 and the refrigeration system 144 operatively interact in conducting a vapor expansion and compression cycle to remove thermal energy from the cooling/mixing vessel 142 and thereby cooling the contents. For example, the refrigeration system 144 directs a compressed, pressurized refrigerant to the cooling/mixing vessel 142. To prompt thermal interaction, the cooling/mixing vessel 142 is associated with a mixing motor 146 that stirs the contents in proximity to the refrigerant. The mixing motor 146 is associated with a motor sensor 148 to adjust operation of the mixing/cooling vessel 142. The refrigerant vaporizes and expands in an endothermic reaction removing thermal energy from the cooling/mixing vessel 142 which can be discharged externally of the mixed-use refrigeration machine 100. The vaporized refrigerant is compressed and liquified again to repeat the cycle.

To compress the refrigerant, the refrigeration system 144 includes a refrigerant compressor 150 which may utilize any suitable mechanical technique for pressurizing the refrigerant. For example, the compressor 150 can use a reciprocal piston, a rotary vane arrangement, or a rotating scroll assembly. The refrigeration system 144 may also include a heat exchanger 152 that receives and condenses the compressed refrigerant from the compressor 150. To promote airflow across the heat exchanger 152, a cooling fan 154 is included with the refrigeration system 144. The condensed, liquified refrigerant is directed to the cooling/mixing vessel 142 which is operatively associated with an evaporator. The refrigeration system 144 also includes a throttle valve disposed between the heat exchanger 152 and the cooling/mixing vessel 142. To fluidly interconnect the components, the refrigeration system 144 includes a refrigeration circulation pipeline 158, which may be rigid pipes, flexible hoses, or other types of fluid conduits.

Through the operation of the compressor 150 and heat exchanger 152, the refrigerant absorbs heat and transforms from a liquid to a gas. The refrigerant vapor then undergoes heat exchange with the outer wall of the cooling/mixing vessel 142 through the refrigeration circulation pipeline 158 which may be externally wrapped there around and which incorporates the throttle valve to promote expansion and vaporization of the refrigerant. The mixing motor 146 rotates the contents of the mixing vessel 142 around its own axis, stirring the ingredients in the cooling/mixing vessel 142 bringing it closer to the inner wall of the cooling/mixing vessel 142, for heat exchange. The contents of the cooling/mixing vessel 142 may be cooled and solidified for producing frozen confectionaries like ice cream or semi-frozen to produce cold drinks.

To accommodate the operative components and facilitate their interaction, the upright stand 140 defines an internal space 160 or working envelop. The internal space 160 is organized vertically to reduce the footprint of the mixed-use refrigeration machine 100 without the need for occupying excessive space. The upright stand 140 accordingly enables the operative components to be compactly assembled without the need for excessive internal space 160. By arranging the components vertically by the structural organization of the upright stand 140, the volume of the internal space 160 of the mixed-use refrigeration machine 100 is reduced, thereby reducing the overall dimensions of the mixed-used refrigeration machine 100. This results in less occupied countertop space, making it suitable for smaller places such as home kitchens.

To thermally separate the operative components, the upright stand 140 can divide and organize the internal space 160 into an upper space 162 designated for mixing and preparation and a lower space 164 designated as a heat exchange and refrigeration layer. The upper space 162 and lower space 164 are arranged vertically with respect to the vertical direction 104. The cooling/mixing vessel 142 is placed in the upper space 162, or the mixing and preparation layer, and the compressor 150, heat exchanger 152 and cooling fan 154 are located in the lower space 164 designed for heat exchange and refrigeration. The arrangement ensures that the temperature of the cooling/mixing vessel 142 is not affected by the other components of the refrigeration system 144 while the volume of the exterior housing 102 is reduced, thereby reducing the overall dimensions of the mixed-use refrigeration machine 100. This results in less occupied countertop space, making the mixed-use refrigeration machine 100 suitable for smaller places such as home kitchens.

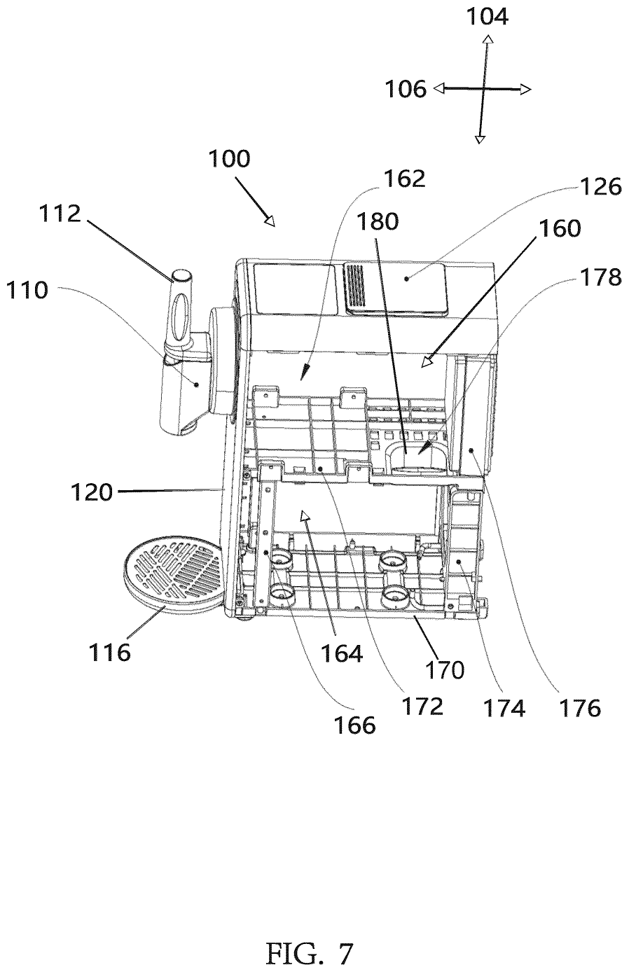

Referring to FIG. 7, in an embodiment, the upright stand 140 can include a front support frame 166, a rear support frame 168 located longitudinally opposite the front support frame 166, a lower base plate 170, and intermediate support plate 172 that extend longitudinally between the front and rear support frames 166, 168. The intermediate support plate 172 may spatially separate the upper space 162 and the lower space 164 of the internal space 160 and may be located above the base plate 170 in the vertical direction 104. The rear support frame 168 may be separated into a first lower plate 174 and a second upper plate 176.

The upper end of the front support frame 166 is detachably connected to the front end of the intermediate support plate 172, and the lower end of the front support frame 166 is detachably connected to the base plate 170 located at the bottom of the internal space 160. The upper end of the first lower plate 174 is detachably connected to the rear end of the intermediate support plate 172, and the lower end of the first lower plate 174 is detachably connected to the base plate 170 at the bottom of the internal space 160. The lower end of the second upper plate 176 is connected to the top surface of the intermediate support plate 172, and the upper end of the second upper plate 176 is detachably connected to the top of the exterior housing 102.

The front support frame 166 and first lower plate 174 cooperate to form the lower space 164, where the compressor 150 and heat exchanger 152 are located. The front supporting frame 166 and the second upper plate 176 cooperate to form the upper space 162 where the cooling/mixing vessel 142 is located. The upper end of the second upper plate 176 is equipped with support plate fixing screw holes, and through the cooperation of screws and these screw holes, the upper end of the second upper plate 176 is screw-connected to the intermediate support plate 172, achieving fixation. The front support frame 168 may also be rigidly connected to the base plate 170 and intermediate support plate 172 by fixation screws.

Adopting the above structure optimizes the assembly layout of the upright stand 140 while reducing the number of supports, reasonably utilizing space, and making the installation positions of components such as the cooling/mixing vessel 142, compressor 150, heat exchanger 152, mixing motor 146, and other components of the refrigeration system 144 more compact. This results in a reduced volume for the mixed-use refrigeration machine 100, achieving miniaturization and adapting it to smaller spaces such as home kitchens.

In an embodiment, to reduce the spatial volume of the internal space 160, the mixing motor 146 is arranged vertically within the internal space 160 and is fixated with respect to the vertical direction 104 by the upright stand 140. For example, the mixing motor 146 can extend from the lower space 164 to the upper space 162 by traversing the intermediate support plate 172. Referring to FIG. 7, to enable the mixing motor 146 to pass between the upper and lower spaces 162, 164, the intermediate support plate 172 can include an installation recess 178 aligned in the vertical direction 104.

In a specific embodiment, to arrange and orientate the mixing motor 146 at inclined or skewed angle with respect to the vertical direction 104, the installation recess 178 is provided with an inclined surface 180 that inclines toward one of the lateral sides of the internal space 160 as oriented in the lateral direction 108. The inclined surface 180 is angularly set and skewed at a non-perpendicular angle with respect to the vertical direction 104 and the lateral direction 108 as measures angularly about the longitudinal direction 106. The exterior frame of the mixing motor 146 abuts against the inclined surface 180 causing the mixing motor 146 to incline laterally in the internal spacing 160

Adopting the above arrangement utilizes space by installing the mixing motor 146 at an angle with respect to the vertical direction 104. When using a mixing motor 146 of the same length, abutting the motor against the inclined surface 180 reduces the vertical space required for installing the mixing motor 146, eliminating the need to reserve excessive height for accommodating the mixing motor 146. This decreases the overall height of the internal spacing 160 defined by the upright stand 140, further achieving reduction of the space occupied by the mixed-use refrigeration machine 100.

As shown in FIGS. 5-6, the heat exchanger 152 can be installed vertically in the lower chamber 164 adjacent to the first lower plate 174. The first lower plate 174 can be provided with a plurality of louvered vent holes 182 disposed therein establishing fluid communication between the internal space 160 and the exterior environment. The cooling fan 154 located in the lower chamber 164 can be arranged to direct airflow over the heat exchanger 152 through the louvered vent holes 182. The heat exchanger 152 can be comprised of a multiple heat exchange tubes that are spatially fixed by a rigid cover or brace. The heat exchange tubes allow fluid flow of refrigerant and may be connected to adjacent heat exchange tubes by elbows to form multiple S-shaped arrangement of the heat exchange tubes.

The rotating vanes of the cooling fan 154 passes airflow across heat exchange tubes of the heat exchanger 152 before being expelled or received through the louvered vent holes 182. Heat is transferred from the refrigerant in the heat exchanger 152 to the airflow and causes the pressurized refrigerant to condense before reaching the throttle valve. The cooling fan 154 may also draw airflow around the compressor 150 improving the efficiency of heat removal from the refrigeration system 144 and heat dissipation effect. Adopting the above arrangement improves the space utilization rate of the internal space 160, reducing the width of the upright stand 140 and the overall dimensions of the mixed-use refrigeration machine 100, further lessening the occupied countertop area.

The second upper plate 176 can also be provided with a plurality of louvered vent holes 184 that establish fluid communication with the upper spacing 162 accommodating the cooling/mixing vessel 142. The position of the first louvered vent holes 182 is compatible with and communicates with the lower spacing 164 and the position of the second louvered vent holes 184 is compatible with and communicates with the upper spacing 162. Further, referring to FIGS. 1, 2, and 3, heat dissipation holes 186 can be disposed in the first and second side panels 128 associated with the lateral sides of the exterior housing 102 to aid in heat dissipation. The cooling fan 154 can be set to allow airflow to enter through the first and second louvered vent holes 182, 184 and exit though the heat dissipation holes 186 or the cooling fan 154 can be set so airflow enters through the heat dissipation holes 186 and exits the louvered vent holes 182, 184.

Referring to FIG. 3, optionally one or more of the first and second side panels 128 can include holder 188 that is hinged to a recessed cavity. The holder 188 is configured to hold ice cream cones or cups. When the holder 188 is not needed, it can be pivoted for storage in the recessed cavity. When the holder 188 is needed, it can be pivoted outward from the cavity perpendicular to the first or second side panel 128.

### Cooling/Mixing Vessel

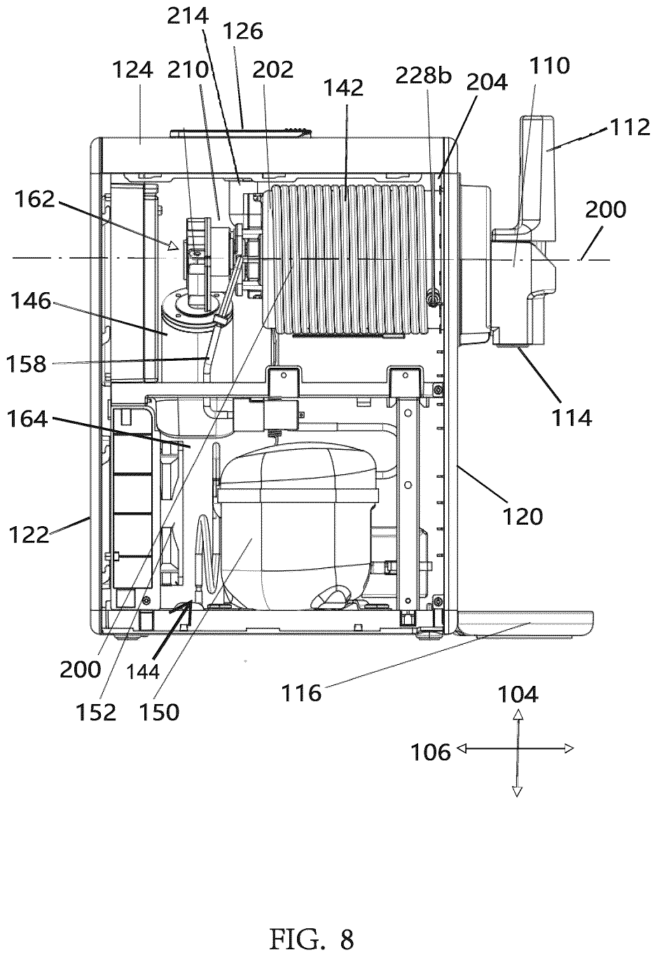

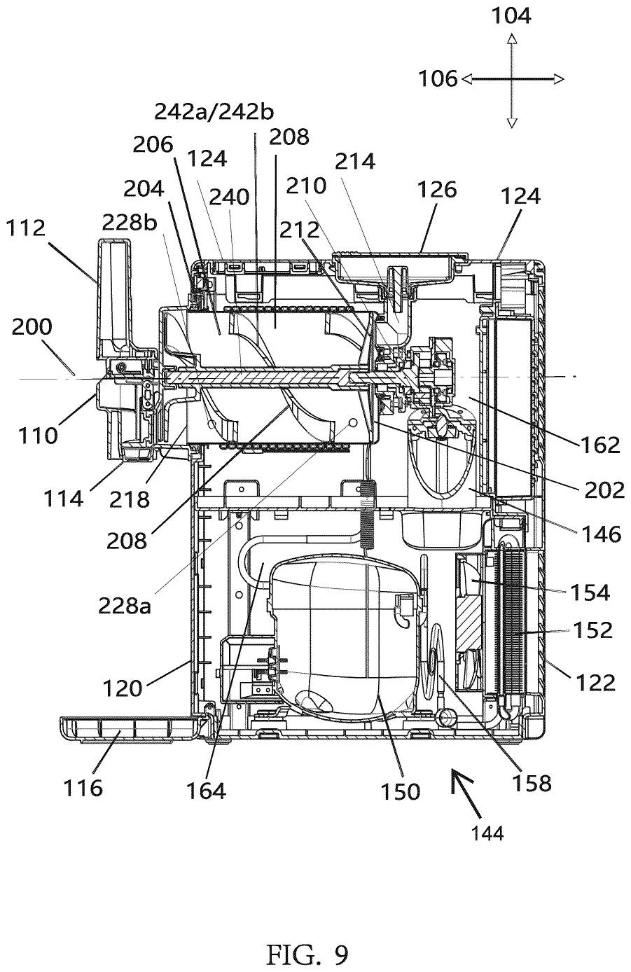

Referring to FIGS. 8 and 9, there is shown the spatial arrangement of components in the upper space 162. The cooling/mixing vessel 142 is responsible for cooling and mixing the ingredients to produce and dispense the low-temperature beverage or edible product and is configured to conduct a refrigeration or temperature control function and a mixing or agitation function. The cooling/mixing vessel 142 is cooperatively associated with the other components of the mixed-use refrigeration machine 100 to assist in the functions.

In the illustrated example, the cooling/mixing vessel 142 is disposed in a horizontal mounting arrangement with respect to the upright stand 140. The horizontal mounting arrangement refers to the direction which the ingredients proceed through the cooling/mixing vessel 142 which is aligned with the longitudinal direction 106 of the coordinate system. The horizontal mounting arrangement functions to direct the ready to serve ingredients longitudinally forward to be dispensed at the dispensing apparatus 110 located on the front panel 120 of the mixed-use refrigeration machine 100.

To coincide with the horizontal mounting arrangement, the cooling/mixing vessel 142 can define a vessel axis 200 that extends parallel with the longitudinal direction 106 between the front panel 120 and rearward panel 122. The cooling/mixing vessel 142 includes a first axial end 202 that is oriented toward the rearward panel 122 and a second axial end 204 oriented toward the forward panel 120. The first and second axial ends 202, 204 are located axially opposite each other with respect to the vessel axis 200. The first axial end 202 is configured to receive the ingredients that are directed longitudinally in the vessel axis 200 to the second axial end 204 that is operatively associated with the dispensing apparatus 110.

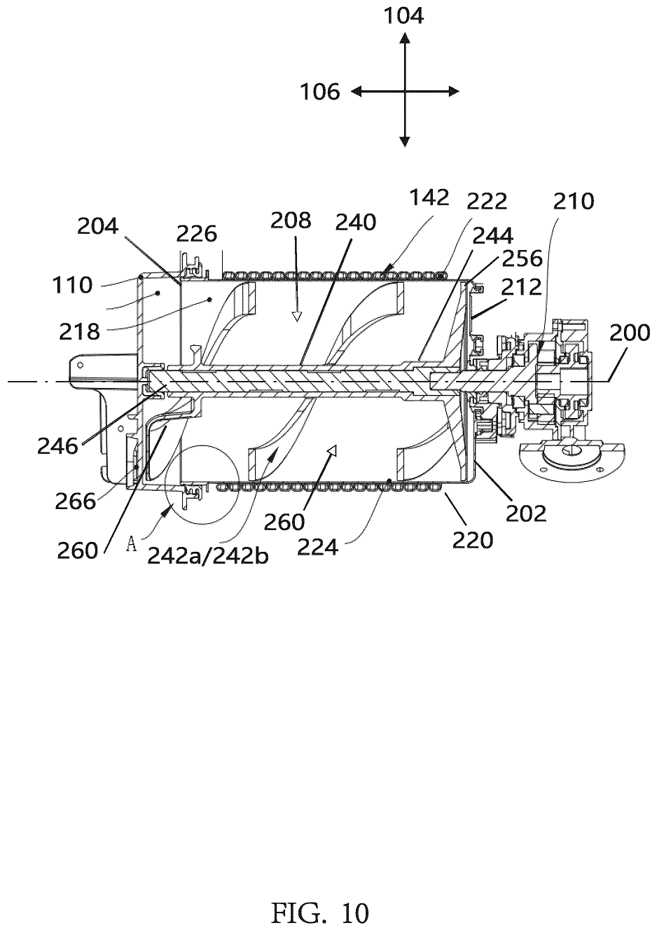

Referring to FIGS. 9 and 10, to accommodate and transfer the ingredients between the first and second axial end 202, 204, the cooling/mixing vessel 142 defines a vessel chamber 206 in which an agitator 208 is rotatably disposed. The vessel chamber 206 is an enclosed space defined by the cooling/mixing vessel 142 and the agitator 208 extends between first axial end 202 and second axial end 204 and is rotationally aligned with the vessel axis 200. The agitator 208 is operatively coupled to the mixing motor 146 at the first axial end 202 to drive rotation with respect to the vessel axis 200. Rotation of the agitator 208 functions to mix the ingredient in the vessel chamber 206 and transfer the ingredients between the first and second axial ends 202, 204 of the cooling/mixing vessel 142.

Referring to FIGS. 8-10, a coupling assembly 210 is operatively associated with the cooling/mixing vessel 142 to couple the mixing motor 146 with the agitator 208 disposed in the vessel chamber 206. The coupling assembly 210 is connected at the first axial end 202 of the cooling/mixing vessel 142 and can be coaxially aligned with the vessel axis 200. The coupling assembly 210 protrudes axially from the first axial end 202 into the upper space 162 to connect with the mixing motor 146. In embodiments where the mixing motor 146 is oriented in the vertical direction 104, the coupling assembly 210 functions to redirect torque at a right angle (90°) to align with the vessel axis 200. The coupling assembly 210 enables coaxial rotation of the agitator 208 with respect to the vessel axis 200.

Referring to FIG. 9, to direct and receive the ingredients into the vessel chamber 206 from the hopper 126, a feed inlet 212 is disposed at the first axial end 202 of the cooling/mixing vessel 142. The feed inlet 212 is connected to a feed conduit 214 that is also connected to the hopper 126 disposed on the ceiling panel 124 of the exterior housing 102. The feed conduit 214 can be a pipe elbow that establishes communication between the hopper 126 and the feed inlet 212 leading into the vessel chamber 206. The feed conduit 214 can be a 90° elbow to create a right-angled path that redirects incoming ingredients from the vertical direction 104 associated with the hopper 126 to the longitudinal direction 106.

The second axial end 204, located axially opposite the feed inlet 212, can define a dispensing outlet 218. The dispensing outlet 218 can be a large opening aligned with the vessel axis 200 through which the agitator 208 may partially extend. The dispensing outlet 218 directly interfaces with the dispensing apparatus 110 when attached to the second axial end 204 of the cooling/mixing vessel 142.

To refrigerate the contents in the vessel chamber 206, the mixing/cooling vessel 142 is operatively associated with the refrigeration system 144. Referring to FIGS. 8 and 9, the components of the refrigeration system 144 are situated in the upright stand 140 including the compressor 150, the heat exchanger 152 and the throttle valve which are fluidly interconnected by the refrigeration circulation pipeline 158. One end of the refrigeration circulation pipeline 158 is connected to the inlet of the compressor 150. An outlet of the compressor 150 is fluidly connected to the heat exchanger 152 that condenses the compressed refrigerant vapor to liquid refrigerant. The outlet of the heat exchanger 152 is fluidly connected to the throttle valve which the liquid refrigerant flows through before being directed to the cooling/mixing vessel 142.

In the illustrated example, the cooling/mixing vessel 142 is configured for external cooling. In an external cooling arrangement, the low-temperature sink originates externally of the cooling/mixing vessel 142 to draw thermal energy from the vessel chamber 206. For example, the cooling/mixing vessel 142 is arranged so the thermal transfer occurs from the ingredients inside the vessel chamber 206 outwardly to the exterior of the cooling/mixing vessel 142. The external cooling arrangement is distinguished from other possible cooling configurations such as an arrangement in which refrigerant is directed internally through the agitator 208 for example. Aspects of the disclosure, however, may be applicable to other types of cooling configurations including through the agitator 208.

Referring to FIG. 10, to facilitate the thermal exchange, the cooling/mixing vessel 142 may include a vessel barrel 220 and a refrigerant conduit 222. The vessel barrel 220 is a hollow container that surrounds the vessel chamber 206. The vessel barrel 220 may be cylindrical in geometry and may include a barrel wall 224 that is cylindrical and concentric to the vessel axis 200. In possible embodiments, the vessel barrel 220 may have other geometries such as a polyhedron and may be associated with baffles or flow direction structures disposed radially inwardly from the barrel wall 224 into the vessel chamber 206 to enhance the transfer of the ingredients.

The refrigerant conduit 222 which is annularly wound on the exterior of the barrel wall 224 and extends axially from the first axial end 202 toward the second axial end 204. The refrigerant conduit 222 can be a refrigerant tube or pipe through which the refrigerant medium can be circulated to remove heat from the vessel chamber 206 thereby maintaining the cooling/mixing vessel at a low temperature. Since the refrigerant conduit 222 is annularly distributed over the exterior of the barrel wall 224, it clings to the cooling/mixing vessel 142 providing refrigeration of the vessel chamber 206. The vessel barrel 220 can be made from a metallic material for thermal conductivity and the refrigerant conduit 222 can be a continuous rigid metal pipe or tubing bent into a continuous spiral around the barrel wall 224.

Referring to FIGS. 9 and 10, when the cooling/mixing vessel 142 is cooled, low-temperature and low-pressure refrigerant vapor from the refrigerant conduit 222 is directed to the compressor 150 from the cooling/mixing vessel 142. Through compression, the temperature and the pressure of the refrigerant vapor are increased and conveyed to the heat exchanger 152. Through condensation, the heat exchanger 152 is configured to cool the high-temperature and high-pressure refrigerant vapor and convert it into a low-temperature liquid. The low-temperature liquid is then input to the refrigerant conduit 222 disposed as a coiled tube about the vessel barrel 220, such that the low-temperature liquid refrigerant is evaporated back into refrigerant vapor. For example, the refrigerant liquid is re-charged to the refrigerant conduit 222. The refrigerant conduit 222 is wound on the exterior of the barrel wall 224 of the vessel barrel 220. The vessel chamber 206 of the cooling/mixing vessel 142 is accordingly cooled by means of heat exchange.

During operation, under the rotational action of the agitator 208 driven by the mixing motor 146, the contents of the cooling/mixing vessel 142 are moved in the longitudinal direction 106 from the first axial end 202 toward the second axial end 204. The agitator 208 brings the contents into contact with the inner surface of the vessel wall 224. The operation of the refrigerant conduit 222 adjacent to the vessel wall 224 lowers the temperature inside the vessel chamber 206 and cools the ingredients to the required low serving temperature of the cold beverage or frozen edible. The rotation of the agitator 208 about the vessel axis 200 ensures that the ingredients inside the vessel chamber 206 are thoroughly mixed and evenly cooled, resulting in the formation of the frozen beverages and edibles. Finally, the refrigerated contents are dispensed outside the cooling/mixing vessel 142 through the dispensing apparatus 110 at the second axial end 204.

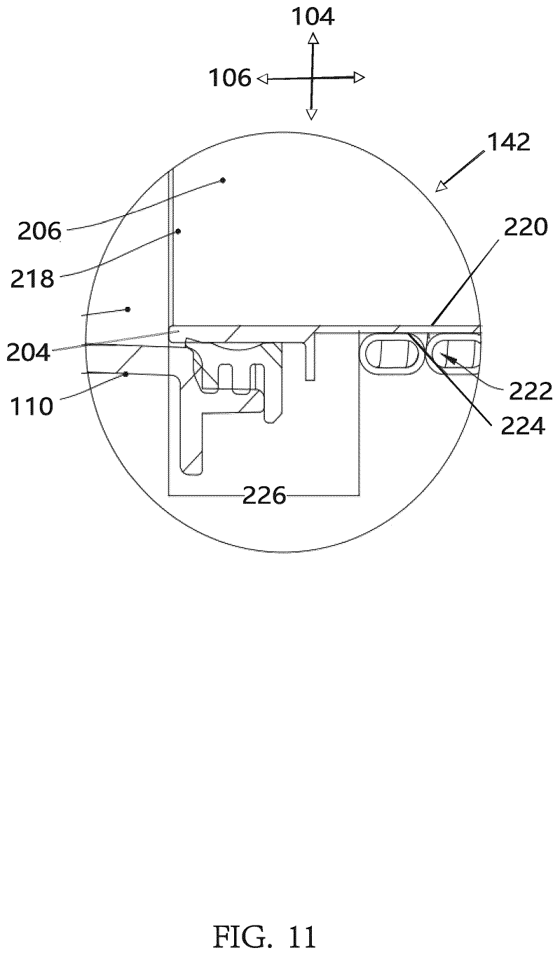

Referring to FIGS. 10 and 11, in the illustrated configuration, the cooling/mixing vessel 142 is provided with a dispensing outlet 218 at the second axial end 204 and the refrigeration conduit 222 is wound around the exterior of the barrel wall 224 extending from the first axial end 202 toward the second axial end 204 in the direction of the vessel axis 200. In a possible embodiment, the cooling/mixing vessel 142 is configured to provide a melting gap or thawing gap 226 proximate the second axial end 204 associated with the dispensing outlet 218. The arrangement with the thawing gap 226 separates the vessel chamber 206 into different axial regions with different temperatures, enabling improved material flow at the dispensing outlet 218 of the vessel barrel 220.

Specifically, the refrigeration conduit 222 may proceed spirally from the first axial end 202 toward the second axial end 204 in spiral wraps around the vessel barrel 220 coaxially aligned with the vessel axis 200. The refrigeration conduit 222 stops axially short of the second axial end 204 creating the thawing gap 226 between the axial termination of the refrigeration conduit 222 and the second axial end 204 of the vessel barrel 220. This allows the vessel barrel 220 to be divided into two axial regions with different temperatures, ensuring ice-making capacity while improving the fluidity at the dispensing outlet 218 of the cooling/mixing vessel 142, thus solving the problem of insufficient fluidity during discharge in conventional cold beverage machines where the refrigeration zone maintains a single temperature.

More specifically, the cooling/mixing vessel 142 defines a vessel chamber 206, with the dispensing outlet 218 exposed at one axial end of the vessel barrel 220 for discharging or transferring refrigerated materials from the cooling/mixing vessel 142. The first axial end 202 of the vessel barrel 220 is provided with the feed inlet 212 and disposed exteriorly about the vessel barrel 220. Starting at the first axial 202 is the refrigerant conduit 222, which has a refrigeration function to reduce the temperature of the exterior of barrel wall 224 of the vessel barrel 220, thereby keeping the vessel chamber 206 of the cooling/mixing vessel 142 at a low temperature suitable for material storage. Since the refrigerant conduit 222 associated with the refrigeration system 144 extends from the first axial end 202 of the cooling/mixing vessel 142 toward the middle of the vessel barrel 220 (here, “middle of the vessel barrel 220” does not refer to the absolute middle but any position between the opening at one axial end and the other axial end of the cooling/mixing vessel 142), the portion of the barrel wall 224 in contact with the refrigerant conduit 222 can maintain the storage temperature of the materials, keeping them in a frozen (ice) or semi-frozen state with low fluidity.

As shown in FIG. 11, the thawing gap 226 formed between the first axial end 202 and the dispensing outlet 218 in the second axial end 204 of the vessel barrel 220 allows the barrel wall 224 at the second axial end 204 corresponding with the thawing gap 226 to be in contact with air, which heats this portion of the barrel wall 224, raising the temperature in the thawing gap 226. As a result, the materials in the thawing gap 226 partially melt or thaw, increasing the fluidity of the materials in the vessel chamber 206 and thus the speed at which the contents are discharged from the dispensing outlet 218 at the second axial end 204, preventing material residue at the dispensing outlet 218. This solution addresses the problem of insufficient fluidity during discharge due to the single temperature maintained in the refrigeration zone of conventional cold beverage machines.

In a possible embodiment, to measure the temperature of the ingredients in the vessel chamber 206, the cooling/mixing vessel 142 is provided with one or more temperature sensors 228a, 228b. The temperature sensor 228a, 228b can be configured to directly measure the temperature of the contents in the vessel chamber 206 and can be disposed through the chamber wall 224 to be exposed to the vessel chamber 206. The temperature sensor 228a, 228b can directly measure the ingredients at different axial locations within the vessel chamber 206 and improves accuracy over other temperature measurement techniques that rely on indirect measurement of the ingredients through estimation. An example of a suitable temperature sensor may be a thermocouple, although other temperature measuring techniques can be used. The temperature sensor 228a, 228b outputs an electrical signal representing the measured temperature of the ingredients in the cooling/mixing vessel 142.

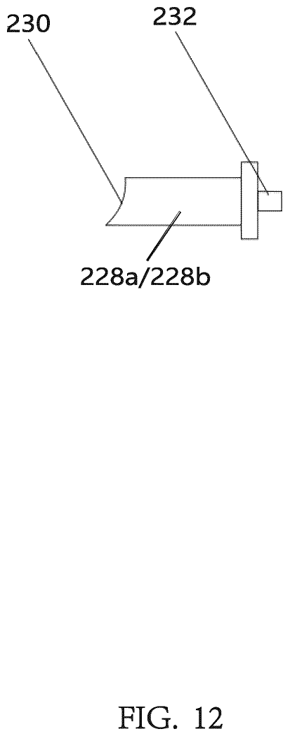

Referring to FIG. 12, the temperature sensor 228a, 228b can include a sensing end 230 and a connecting end 232. The sensing end 230 is adapted to be disposed flush within the interior surface of the barrel wall 224 of the vessel barrel 220. In the illustrated embodiment, the sensing end 230 is designed with an arc-shaped surface with a radius matching the radius of the vessel barrel 220 to sit flush with the interior cylindrical surface of the barrel wall 224. The connecting end 232 is provided exteriorly of the barrel wall 224. The connecting end 232 is electrically connected by wires or electrical conductors to the electronic controller 132 associated with the mixed-use refrigeration machine 100.

In operation, referring to FIG. 9, ingredients are poured through the hopper 126. In the example of ice cream, the ingredients may include milk and dairy products. The ingredients enters the vessel chamber 206 through the feed inlet 212 at the first axial end 202 of the cooling/mixing vessel 142. After the refrigerating system 144 is started, the cooling/mixing vessel 142 is cooled by heat exchange with the refrigerant conduit 222 wrapped exteriorly about the barrel wall 224 to reduce a temperature of the ingredients in the vessel chamber 206. During the refrigeration process, the ingredients such as milk can be stirred by the agitator 208. Agitation entrains more air to the ingredients during crystallization, and makes ice cream softer and more palatable. When the ingredients reaches a certain temperature, the dispensing assembly 110 can output the ice cream or other low-temperature product.

To detect the temperature of the ingredients better in the present embodiment, a through hole is disposed in the barrel wall 224. The temperature sensor 228a, 228b is mounted in the through hole. The sensing end 230 of the temperature sensor 228a, 228b is exposed directly to the vessel chamber 206 and can come in direct contact with the ingredients to obtain the temperature of the material more accurately. The connecting end 232 of the temperature sensor 228a, 228b is electrically connected to the electronic controller 132 through a circuit. The detected temperature of the material can be directly fed back to the electrical controller 132. According to a temperature displayed on the control panel 130 associated with the electronic controller 132, whether the ingredients are frozen into the ice cream can be determined. Meanwhile, power of the refrigeration system 144 and power of the agitator 208 can be adjusted by touching the display screen.

Because the agitator 208 is provided in the vessel chamber 206 and rotating with respect to the vessel axis 200, if the sensing end 230 of the temperature sensor 228a, 228b protrudes from the barrel wall 224 of the vessel barrel 220 into the vessel chamber 206, it may be scraped by the agitator 208 possibly to cause damage to the temperature sensor 228a, 228b. If the sensing end 230 of the temperature sensor 228a, 228b is recessed in the chamber wall 224 of the vessel barrel 220, a part of the material will remain adhered in the through hole of the barrel wall 224 to increase the cleaning difficulty of the cooling/mixing vessel 142. As shown in FIG. 12, the arc-shaped surface of the sensing end 230 of the temperature sensor 228a, 228b enables the sensing end 230 to be flush with the barrel wall 224 of the vessel barrel 220. This ensures that the temperature sensor 228a, 228b does not affect normal operation of other devices or processes, while contacting the material.

Referring to FIGS. 8 and 9, the second temperature sensor 228b may be provided close to the dispensing outlet 218 at the second axial end 204 of the cooling/mixing vessel 142. The ingredients continuously stirred by the agitator 208 are pushed forward and then stacked to a second axial end 204 of the cooling/mixing vessel 142 axially close to the dispensing apparatus 110. The temperature detection is intended to detect whether the ingredients have reached a temperature for forming the ice cream or the desired product. When the contents are dispensed by the dispensing apparatus 110, the ingredients at this position is squeezed. As long as the ingredients at this position is maintained at a crystallization temperature, the ice cream can be formed and dispensed by the dispensing apparatus 110.

If the temperature sensor 228a, 228b is close to the agitator 208, new ingredients may be added when the temperature sensor 228a, 228b detects the temperature of the material. Even though the contents at the second axial end 204 are crystallized into the ice cream, the temperature detected by the temperature sensor 228a, 228b still does not reach the crystallization temperature of the ingredients to prolong waiting time of the user. To address the issue, in a possible embodiment shown in FIGS. 9 and 10, there can be least two temperature sensors 228a, 228b, including a first temperature sensor 228a and a second temperature sensor 228b. The first and second temperature sensors 228a, 228b are axially spaced apart to measure different temperatures in different axial regions of the vessel chamber 206. The first temperature sensor 228a is provided close to the feed inlet 212 disposed at the first axial end 202. The second temperature sensor 228b is provided close to second axial end 204 associated with the dispensing apparatus 110. The first temperature sensor 228a and the second temperature sensor 228b are electrically connected to the electronic controller 132.

As shown in FIGS. 8 and 9, in a further embodiment, there are a plurality of temperature sensors 228a, 228b. The plurality of temperature sensors 228a, 228b are longitudinally spaced with respect to the vessel axis 200 to determine temperatures at different axial regions of the cooling/mixing vessel 142 to better control the refrigeration assembly 144. For example, normally, a temperature detected by the second temperature sensor 228b at the second axial end 204 should be the same as a temperature detected by the first temperature sensor 228a at the first axial end 202. In this case, the refrigeration assembly 144 can be controlled to maintain the temperature of the vessel chamber 206. When new ingredients are added, the temperature detected by the second temperature sensor 228b becomes less than the temperature detected by the first temperature sensor 228a. To accelerate reducing the temperature, the power of the refrigeration assembly 144 can be increased to form the ice cream more quickly. When the temperature detected by the first temperature sensor 228a is approximately the same as the temperature detected by the second temperature sensor 228b, the power of the refrigeration system 144 is readjusted.

Preferably, both the first temperature sensor 228a and the second temperature sensor 228b are electrically associated with the agitator 208. When ingredients are added, the temperature detected by second temperature sensor 228b is less than the temperature detected by the first temperature sensor 228a. To accelerate crystallization, the agitator 208 can increase its power according to a difference between the temperature detected by the first temperature sensor 228a and the temperature detected by second temperature sensor 228b. Under an action of centrifugal inertia, a portion of the ingredients is thrown to the inner surface of the barrel wall 224 in contact with the refrigerant conduit 222 to increase contact area between the ingredients and the barrel wall 224 of the vessel barrel 220, thereby improving heat exchange efficiency, and forming the ice cream more quickly.

Preferably, the first temperature sensor 228a is disposed in the stationary barrel wall 224 at a location vertically below the vessel axis 200 and the agitator 208. The first temperature sensor 228a proximate the first axial end 202 and the feed inlet 212 mainly functions to detect the temperature of the newly added ingredients. If the position of the first temperature sensor 228a is vertically above the vessel axis 200, and an amount of the newly added ingredients are small, the first temperature sensor 228a cannot contact the newly added ingredients to get a new temperature feedback and erroneous temperature measurements are avoided.

In possible embodiments, to facilitate cleaning and sanitation, the vessel barrel 220 can be integrally formed through a stamping or drawings process. The vessel barrel 220 can be made from metal such as steel or aluminum to facilitate manufacturing and thermal conductivity. Compared with traditional barrels made by welding multiple components, the integrally formed vessel barrel 220 eliminates welding gaps on its surface, preventing ingredient residues from accumulating in such gaps. This design facilitates thorough cleaning of the cooling/mixing vessel 142, reducing both the difficulty and cost of cleaning. During cleaning, the vessel barrel 220 can be easily accessed by simply detaching the dispensing apparatus 110 from the first axial end 202.

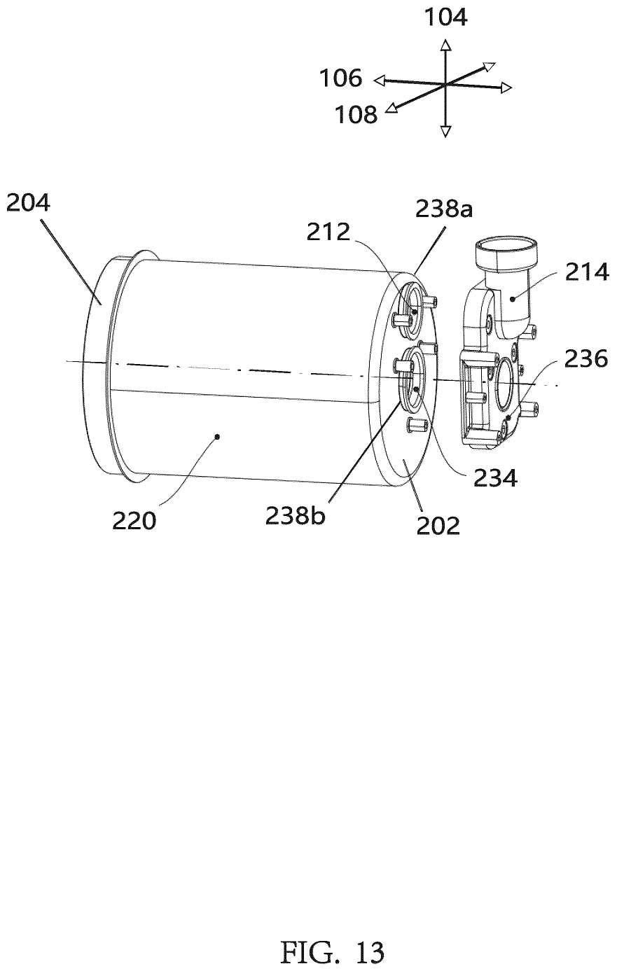

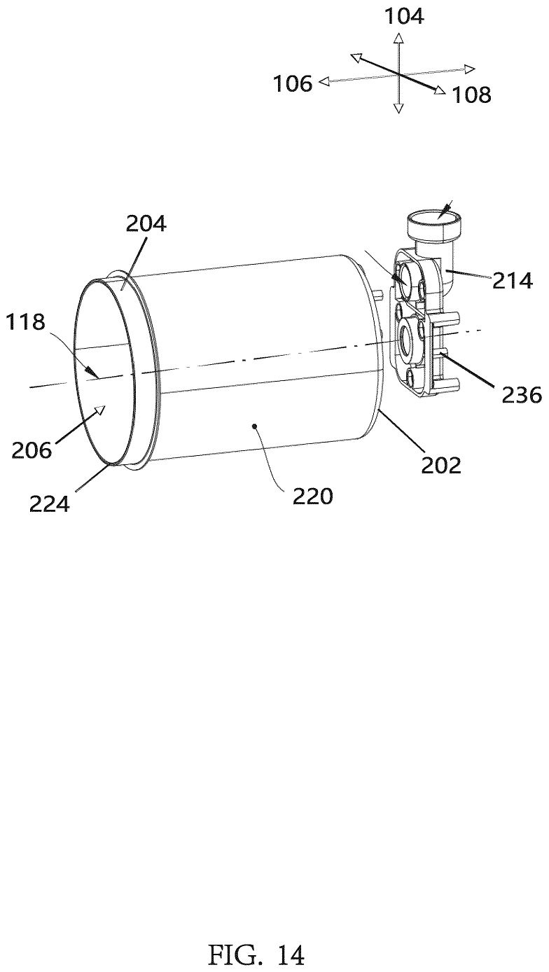

Referring to FIGS. 13 and 14, the vessel barrel 220 can be formed as a cylindrical container with the cylindrical barrel wall 224 concentrically disposed about the vessel axis 200. The first axial end 202 of the cooling/mixing vessel 142 may be a blind end and closed off by an axial wall perpendicular to the barrel wall 224 to occlude the vessel chamber 206. To provide access for the ingredients, the feed inlet 212 is disposed through the axial wall and communicates with the vessel chamber 206 internally in the vessel barrel 220. To couple the mixing motor 146 with the agitator, a drive coupling aperture 234 is also disposed through the axial wall and communicates with the vessel chamber 206. The feed inlet 212 is orientated in the longitudinal direction 106 and directs the ingredients into the vessel chamber 206 parallel to the vessel axis 200.

In an embodiment, the drive coupling aperture 234 is coaxially aligned with the vessel axis 200 extending through the cooling/mixing vessel 142. Accordingly, when the mixing motor 146 and the agitator 208 are coupled through the drive coupling aperture 234, the agitator 208 is coaxially aligned with the vessel axis 200. The feed inlet 212 and the drive aperture 234 are provided as holes oriented with vessel axis 200 that are stamped or machined into the axial wall at the first axial end 202. The feed inlet 212 may be radially offset from the vessel axis 200 above the drive coupling aperture 234 with respect to the vertical direction 104. The feed inlet 212 communicates with the vertically upper regions of the vessel chamber 206 defined by the vessel barrel 220.

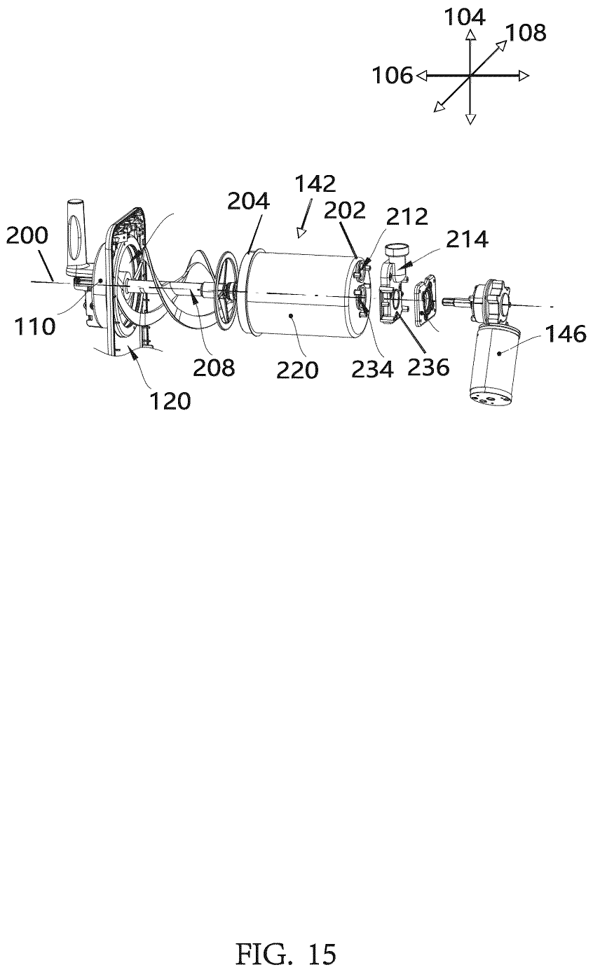

The second axial end 204 of the cooling/mixing vessel 142 may be formed as an opened end of the vessel barrel 220 which corresponds with the dispensing outlet 218. Referring to FIG. 15, during assembly, the agitator 208 is axially inserted through the dispensing outlet 218 into the vessel chamber 206 defined by the barrel wall 224. The dispensing apparatus 110 can be attached to the second axial end 204 to occlude the dispensing opening 352. The dispensing apparatus 110 may attach directly to the front panel 120 which the second axial end 204 abuts against or the dispensing apparatus 110 can pass through the front panel and mount directly to the second axial end 204 of the cooling/mixing vessel 142. The feed conduit 214 can be attached to the first axial end 202 to communicate with the feed inlet 212 and the coupling assembly 210 can be attached to the first axial end to align with the drive coupling aperture 234 and the vessel axis 200.

Referring to FIGS. 13 and 14, in some embodiments, the feed conduit 214 can be associated with a first mounting frame 236 and a first sealing ring 238a. The first axial end 202 of the vessel barrel 220 associated with the cooling/mixing vessel 142 is provided with a feed inlet 212. The elbow pipe associated with the feeding conduit 214 comprises an input pipe end and an output pipe end. The first sealing ring 238a, which may be an annular compression ring or gasket, is coaxially arranged at the feed inlet 212 of the vessel barrel 220. The mounting frame 236 is installed at the first axial end 202 of the cooling/mixing vessel 142. The feed conduit 214 is integrated with the mounting frame 236 so that the input pipe end is in communication with the hopper and the output pipe end is in communication with the feed inlet 212.

The arrangement of the annular sealing ring 238a ensures the sealing of the feed inlet 212, preventing the ingredients from leaking outside the vessel barrel 220 or external impurities from entering the vessel chamber 206. Additionally, during the cleaning process, the first sealing ring 238a helps prevent wash water from leaking out of the feed inlet 212 to the exterior of the cooling/mixing vessel 142. The arrangement of the first mounting frame 236 provides support and fixation for the feed conduit 214, such that the feed conduit 214 is securely mounted on the first axial end 202 of the cooling/mixing vessel 142. Since the input pipe end of the feed conduit 214 is in communication with the hopper and the output pipe end is in communication with the feed inlet 212, the feed conduit 214 enables the ingredients to be transported from the hopper into the vessel chamber 206 of the cooling/mixing vessel 142.

In a possible embodiment, the coupling assembly 210 can be partially integrated with the mounting frame 236. To seal the drive coupling aperture 234, the mounting frame 236 can be associated with a second sealing ring 238b that is also an annular compressible gasket. The second sealing ring 238b can be coaxially arranged at the drive aperture 234 disposed at the first axial end 202 of the vessel barrel 220 of the cooling/mixing vessel 142. The coupling assembly 210 is coupled with the first mounting frame 236, and the drive shaft of the mixing motor 146 extends through the drive coupling aperture 234.

The arrangement of the second sealing ring 238b ensures the sealing at the drive coupling aperture 234 where the mixing motor 146 couples with the cooling/mixing vessel 142, preventing the ingredients from leaking. Additionally, during the cleaning process, the second sealing ring 238b helps prevent wash water from leaking through the drive coupling aperture 234, thereby protecting the mixing motor 146 from any potential impact. Since the coupling assembly 210 is joined with the first mounting frame 236, the arrangement provides support for the coupling assembly 210.

### Agitator

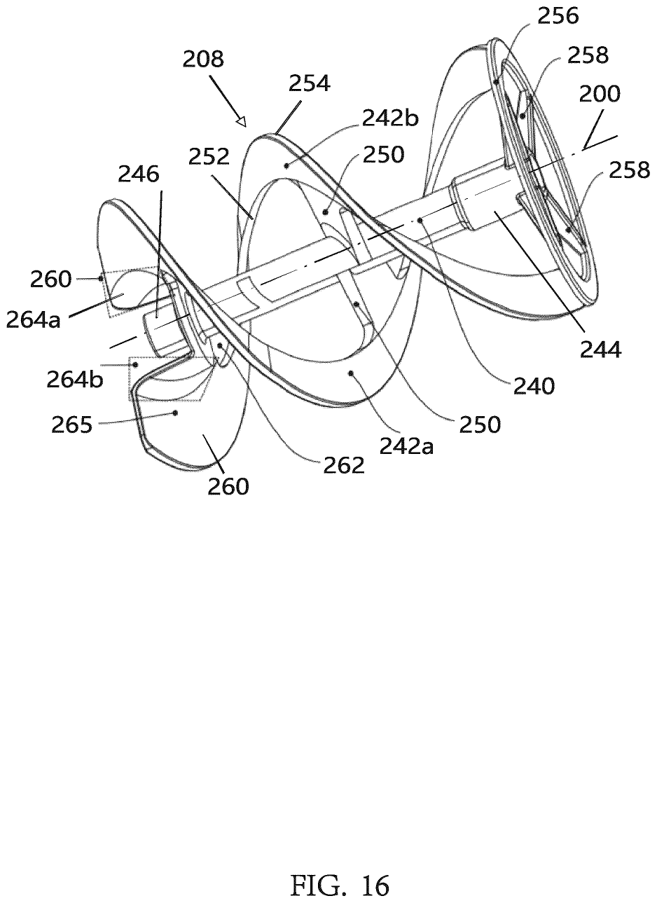

Referring to FIG. 16, the agitator 208, which may be referred to as a dasher or paddle in the art, is structurally configured for improved use in a dual-use refrigeration machine 100 that may produce frozen solid edibles such as ice cream and semi-frozen/liquid beverages such as smoothies or juice. The agitator 208 can include an agitator shaft 240 and at least one stirring blade 242a, 242b that is spirally disposed around the agitator shaft 240. The agitator shaft 240 corresponds to the vessel axis 200 and the at least one stirring blade 242a, 242b is helically wound and concentric with respect to the vessel axis 200. The agitator shaft 240 can extend in the longitudinal direction 106 between a first shaft end 244 and a second shaft end 246 axially opposite each other.

In a possible embodiment, the agitator 208 can have a twin blade configuration including a first stirring blade 242a and a second stirring blade 242b that are connected to the agitator shaft 240. The first and second stirring blades 242a, 242b symmetrically spiral concentrically about the agitator shaft 240. For example, the pair of stirring blades 242a, 242b are connected to the central agitator shaft 240 and surround the agitator shaft 240 spirally and alternately along the axial length between the first shaft end 244 and the second shaft end 246. The first and second stirring blades 242a, 242b may be fixedly connected to the agitator shaft 240 to rotate with respect to the vessel axis 200.

During rotation of the agitator 208, the spiral arrangement of the first and second stirring blade 242a, 242b imparts directional displacement to the ingredients with respect to the vessel axis 200 and the longitudinal direction 106. For example, because of the spiral configuration, the stirring blades are orientated angularly with respect to the vessel axis 200. The angular orientation of the stirring blade 242a, 242b pushes the ingredients longitudinally toward either the first or second shaft ends 244, 246 as well as moving the ingredients rotationally around the vessel axis 200. The longitudinal direction of displacement toward either the first or second axial shaft ends 244, 246 can be determined by the clockwise or counter-clockwise rotation of the agitator 208 with respect to the vessel axis 200.

The first and second stirring blades 242a, 242b are radially offset from the agitator shaft 240 and define an outer diameter or envelope of the agitator 208 that correspond with the cylindrical dimensions of the cooling/mixing vessel. The radially offset between the agitator shaft 240 and stirring blades 242a, 242b defines an agitator void 248 between the concentric structures. During rotation of the agitator 208, the ingredients can be contacted by the first and second stirring blades 242a, 242b and directed radially inward to the agitator void 248 for further stirring and agitation. This solves the problem of easy agglomeration of the material in the local area due to the insufficient stirring and the small stirring range of the existing ice maker.

Referring to FIG. 16, to fixedly connect the first and second agitator blades 242a, 242b to the agitator shaft 240, the agitator 208 includes one or more blade connecting ribs 250 that are radially directed outwardly with respect to the vessel axis 200. The connecting ribs 250 each include one end connected to the agitator shaft 240 and the other end connected to an inner ring of the stirring blades 242a, 242b. A plurality of connecting ribs 250 are arranged along the axial length direction of the agitator shaft 240 to attach to the stirring blades 242a, 242b at different axial locations. The connecting ribs 250 space apart the agitator blades 242a, 242b radially from the agitator shaft 240 and define the agitator void 248 concentrically disposed between the agitator blades 242a, 242b and the agitator shaft 240.

There may be a plurality of connecting ribs 250. This is mainly intended to connect different axial positions of the stirring blades 242a, 242b to the agitator shaft 240 and to make the fixation between the agitator shaft 240 and the stirring blades 242a, 242b connected more firmly. The stirring blades 242a, 242b may not deform or shake easily in rotation to improve mechanical strength of the agitator 208. Meanwhile, the stirring blades 242a, 242b are distributed spirally. The plurality of connecting ribs 250 are angularly spaced with respect to the vessel axis 200 and are angularly separated from each other radially between the agitator shaft 240 and the first and second stirring blades 242a, 242b. The angular spacing between the plurality of connecting ribs 250 defines in part the agitator void 248 and assists in the longitudinal displacement and flow of ingredients during rotation of the agitator 208.

Each stirring blade 242a, 242b may include the inner ring or blade edge 252 and an outer ring or blade edge 254. The inner blade edge 252 is connected to the connecting rib 250. The radial area between the inner blade edge 252 and the outer blade edge 254, i.e., the radial width of the stirring blade 242a, 242b, is the main stirring range. The connecting rib 250 connected to the inner blade edge 252 may further be configured to stir the material on the inner blade edge 252 of the stirring blades 242a, 242b, which can make up the blind stirring area of the stirring blades 242a, 242b. The outer blade edges 254 define the outer envelope of the agitator 208 and may have a diameter corresponding with the vessel barrel 220 to be coextensive with the inner surface of the chamber wall 224.

Preferably, the agitator 208 can further include an annular stirring base 256 shaped as an annular ring fixedly connected to the first shaft end 244 by one or more reinforcing ribs 258 directed radially outward with respect to the vessel axis 200. The stirring blades 242a, 242b each have one horizontal end connected to the annular stirring base 256. The reinforcing ribs 258 include one end connected to the agitator shaft 240 and the other end connected to the annular stirring base 256. In an embodiment, a plurality of reinforcing ribs 258 can be angularly spaced around the circumference of the agitator shaft 240.

The reinforcing ribs 258 are provided at one axial end of each of the stirring blades 242a, 242b. Through the reinforcing ribs 258, the annular stirring base 256 is fixedly connected to the agitator shaft 240. The first shaft end 244 of the agitator shaft 240 is connected to the annular stirring base 256 through the reinforcing ribs 258. There are a plurality of reinforcing ribs 258 that are angularly spaced around and extend radially inward from the annular stirring base 256. This makes the annular stirring base 256 and the agitator shaft 240 connected more firmly. Meanwhile, the reinforcing rib 258 can stir the material at the proximal ends of the stirring blades 242a, 242b, which can make up the blind stirring area of the stirring blades. Moreover, the axially proximal ends of the stirring blades 242a, 242b are connected to the annular stirring base 256, and the connecting ribs 258 are connected to the stirring blades 242a, 242b, such that the connection stability between the stirring blades 242a, 242b and the agitator shaft 240 is further improved.

In an embodiment, the agitator 208 can include a reflow flange 260. The reflow flange 260 can be located toward the second shaft end 246 and fixedly connects the distally axial ends of the first and second stirring blades 242a, 242b to the agitator shaft 240. The reflow flange 260 can be geometrically shaped to axially redirect the fluid or semi-fluid ingredients in the longitudinal direction 106 at the second shaft end 246 of the agitator 208.

For example, the reflow flange 260 can include a collar 262 that is disposed concentrically around the agitator shaft 240 longitudinally inward from the distal-most end of the agitator shaft 240 at the second shaft end 246. The collar 262 extends radially outward, perpendicular to the vessel axis 200 and joins to a bifurcated pair of L-shaped structures or plate 264. The L-shaped plates 264a, 264b are diametrically opposed with respect to the agitator shaft 240. The L-shaped plates 264a, 264b extends perpendicularly from the circumference of the collar 262 in the axial direction to connect with the distal most ends of the radially offset first and second stirring blades 242a, 242b. The L-shaped plates 264a, 264b are radially offset from and concentric to the second shaft end 256 and partially circumscribes the vessel axis 200.

The geometry of the L-shaped plates 264a, 264b associated with the reflow flange 260 creates a reflow region configured, for example, as a spiraling reflow groove 265 behind the trailing surface of the first and second stirring blades 242a, 242b. The L-shaped plates 264a, 264b that join the stirring blades 242a, 242b to the agitator shaft 240 function to axially direct the fluid or semifluid ingredients in the longitudinal direction 106 axially rearward due to the spiral shape of the first and second stirring blades 242a, 242b. For example, the backsides of the spiral-shaped first and second stirring blades 242a, 242b can push material in the longitudinal direction 106 from the second shaft end 256 toward the first shaft end 244.

Referring back to FIG. 10, the agitator 208 is disposed in the vessel chamber 206 so that the agitator shaft 240 coaxially aligns with the vessel axis 200. The first and second stirring blades 242a, 242b fixedly connected to the agitator shaft 240 extend substantially coextensively between the first axial end 202 and the second axial end 204 of the cooling/mixing vessel 142. The annular stirring base 256 attached at the first shaft end 244 is located at the first axial end 202 formed as a closed blinded end and can sweep past the feed inlet 212 during rotation of the agitator 208. The mixing motor 146 can be coupled to the first shaft end 244 by the drive coupling assembly 210 to transfer torque and rotation to the agitator shaft 240. Rotation of the agitator 208 and the geometry of the first and second stirring blades 242a, 242b moves the longitudinally in the cooling/mixing vessel with respect to the vessel axis 200 between the first and second axial ends 202, 204.

The first and second annular stirring blades 242a, 242b are offset radially from the agitator shaft 240 aligned with the vessel axis 200 and may have a dimension corresponding to the inner diameter of the vessel barrel 220. The outer blade edges 254 of the stirring blades 242a, 242b are radially coextensive with the inner surface of the barrel wall 224 and can form a running clearance with respect to the barrel wall 224. The contour of the first and second stirring blades 242a, 242b directs the cold ingredients proximate the barrel wall 224, which has been refrigerated by operation of the refrigerant conduit 222, radially inward to the agitator void 248 for further mixing and further thermal cooling.

The agitator 208 may have a twin blade or double blade configuration. Referring to FIG. 16, the stirring blades 242a, 242b extend from the first shaft end 244 of the agitator shaft 240 to the second shaft end 246 of the agitator shaft 240. The stirring blades 242a, 242b are distributed spirally and alternately. That is, while a section of one stirring blade 242a is wound on the agitator shaft 240, a section of the other stirring blade 242b is wound correspondingly under the agitator shaft 240. In this way, the pair of stirring blades 242a, 242b can surround the agitator shaft 240 alternately and seamlessly to form an alternately distributed spiral structure.

In response to half rotation of the agitator shaft 240, one stirring blade 242a pushes the material forward by one unit. In response to continuous half rotation of the agitator shaft 240, the other stirring blade 242b pushes the material forward by one unit. The pair of stirring blades 242a, 242b can push the material forward seamlessly, thereby shortening retention time of the material in movement. Since the material is not stayed at a position, the material in the cooling/mixing vessel 142 is not prone to agglomeration and can be stirred sufficiently. Meanwhile, since the outer blade edges 254 of the stirring blades 242a, 242b are close to the inner surface of the vessel wall 224 of the vessel barrel 220, the outermost side of the stirring blades 242a, 242b can be close to the interior of the cooling/mixing vessel 142, and the stirring blades 242a, 242b have a large stirring range, and can stir the material sufficiently. The stirring blades 242a, 242b are distributed spirally, so the stirring blades 242a, 242b in rotation pushes the material to the second axial end 204 corresponding with the dispensing outlet 218, and the material can be dispensed. The material can further be dispersed when being pushed. Therefore, the agitator 208 solves the problem of easy agglomeration of the material in the local area due to the insufficient stirring and the small stirring range of the existing ice makers.

The reflow flange 260 associated with the second shaft end 246 locationally corresponds to the second axial end 204 of the cooling/mixing vessel 142 and may be disposed in the dispensing outlet 218. The reflow flange 260 can be configured to redirect flow of the cold ingredients at the second axial end 204 and can prevent accumulation and blockage of the dispensing outlet 218.

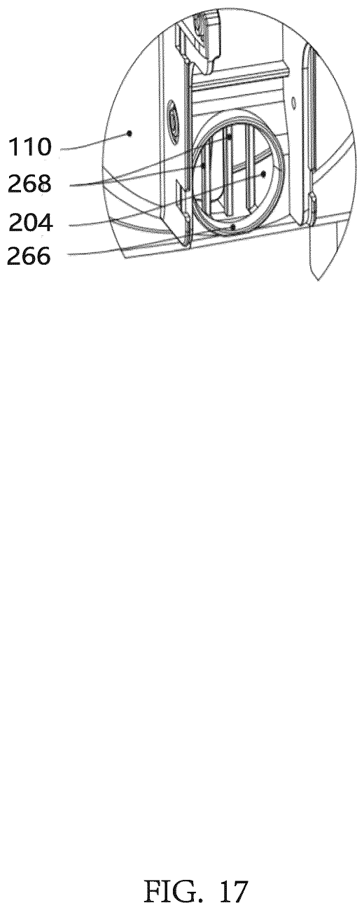

For example, referring to FIG. 17, the dispensing apparatus 110 can be associated with a dispensing port 266 that is embodied as a circular hole disposed in a structural plate perpendicular to the vessel axis 200 through which the cold material can pass. The dispensing port 266 may be substantially smaller in diameter than the dispensing outlet 218 of the vessel barrel 220 and can be located at the lower circular segment of the second axial end 204 to communicate with the lower region of the vessel chamber 206. The dispensing port 266 can be associated with a plurality of grid plates 268 or bars that form a grid or mesh. The grid plates 268 can be linear bars that extend in the vertical direction 104 across the opening defined by the dispensing port 266.

Referring to FIG. 10, the stirring blades 242a, 242b attached to the reflow flange 260 extend near the dispensing port 266 associated with the dispensing apparatus 110. As shown in FIG. 16, due to spiral surrounding of the stirring blades 242a, 242b, two distally axial ends of the stirring blades 242a, 242b extend in a cambered manner. The L-shaped plates 264 are provided at the axial distal end of the stirring blades 242a, 242b. The reflow groove 265 is formed between the tail end of the stirring blades 242a, 242b and the L-shaped plates 264. The stirring blades 242a, 242b in rotation drives the L-shaped plates 264 to rotate cyclically. Between the stirring blades 242a, 242b and the L-shaped plates 264, the reflow groove 265 in rotation scrapes an interior wall of the dispensing apparatus 110 near the dispensing port 266, thereby receiving scraped material between the stirring blades 242a, 242b and the L-shaped plates 264.

The material rotates with the reflow groove 265. Since the tail end of the stirring blades 242a, 242b are cambered, the L-shaped plates 264 stop the material at a low position, and the material does not fall off easily in the area of the reflow flange 260. When the L-shaped plates 264 rotates to a high position, the space under the stirring blades 242a, 242b is empty, the material is not supported by the reflow flange 260, and the material is unloaded in the area axially rearward of the L-shaped plates 264 and separated from the dispensing port 266. The material neither remains easily at the dispensing port 266, nor is accumulated at the dispensing port 266. This reduces influences of the accumulated material on the subsequent discharge and prevents the material at the dispensing port 266 from being frozen into the ice. Only with the single drive source, the agitator 208 is driven to rotate, thereby realizing the material stirring function, the material conveying function, and the anti-accumulation function at the dispensing port 266.

In an optimal embodiment, the stirring blades 242a, 242b extend near the dispensing port 266 in communication with the cooling/mixing vessel 142. That is, in the area out of the reflow flange 260, the material is conveyed to vessel chamber 206 during rotation of the agitator 208. In this way, the material does not fall off in the area of the reflow flange 260, namely in the area of the dispensing port 266. When the L-shaped plates 264 extends in the longitudinal direction 106 into the cooling/mixing vessel 142 (such as the dispensing outlet 218 at the second axial end 204 of the vessel barrel 220), the L-shaped plates 264 do not support the material after rotating with respect to the dispensing port 266 of the dispensing apparatus 110, and the material falls into the dispensing outlet 218 of the second axial end 204 of the vessel barrel 220. Therefore, the material is quickly reflowed from the dispensing port 266 to the cooling/mixing vessel 142, and the material is not accumulated in the dispensing port 266.

Referring to FIG. 10, the reflow flange 260 rotatably passes by the plurality of grid plates 268. The plurality of grid plates 268 are arranged in the dispensing port 266 of the dispensing apparatus 110 to form a plurality of branch ports. Each branch port can convey the material independently. This can prevent the accumulation of the material at the single branch port. Meanwhile, the stirring blades 242a, 242b and the L-shaped plates 264 rotatably passes through the plurality of grid plates 268 in the dispensing port 266, such that the material at each branch port can be scraped and reflowed to the cooling/mixing vessel 142. Particularly for the agitator 208 with two stirring blades 242a, 242b in the present disclosure, the two stirring blades 242a, 242b scrape the dispensing port 266 alternately, and can scrape the plurality of branch ports in the dispensing port 266 repeatedly. Therefore, the material is not accumulated easily at the dispensing port 266 and is removed at high efficiency.

In a possible embodiment, referring to FIG. 10, the mixing motor 146 configured to drive the agitator 208 is a bidirectional or reversible motor configured to rotate clockwise or counterclockwise, and configured to longitudinally push the material of the cooling/mixing vessel 142 to the second axial end 204 associate with the dispensing apparatus 110 via the dispensing outlet 218 in one rotation direction, and move the material away from the second axial end 204 through the reflow flange 260 in the other rotation direction.

The mixing motor 146 has the adjustable rotation direction and rotates clockwise or counterclockwise. As shown in the FIG. 10, in response to counterclockwise rotation of the agitator 208, the stirring blades 242a, 242b pushes the ingredients of the cooling/mixing vessel 142 to the dispensing port 266. As long as the agitator 208 rotates counterclockwise, ingredients can be pushed out by the stirring blades 242a, 242b. Upon completion of discharge of cold ingredients through the dispensing port 266, the rotation direction of the dive 146 can be switched, and the agitator 208 is switched to rotate clockwise. By scraping the inner wall of the dispensing apparatus 110 near the dispensing port 266 through the L-shaped plates 264, the material remaining near the dispensing port 266 is reflowed to move away from the dispensing port 266 and back into the cooling/mixing vessel 142.

### Coupling Assembly

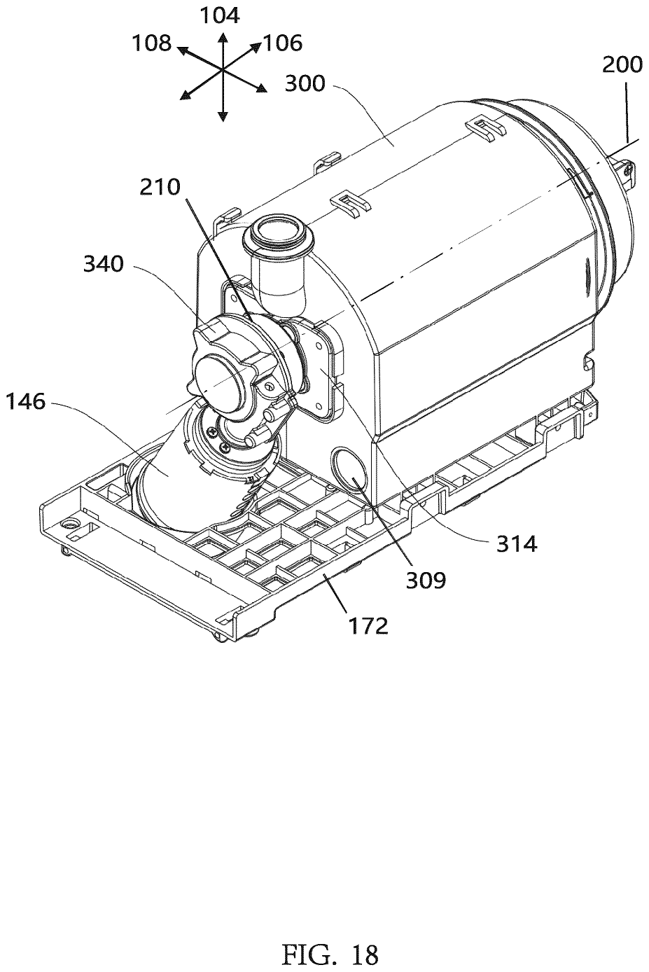

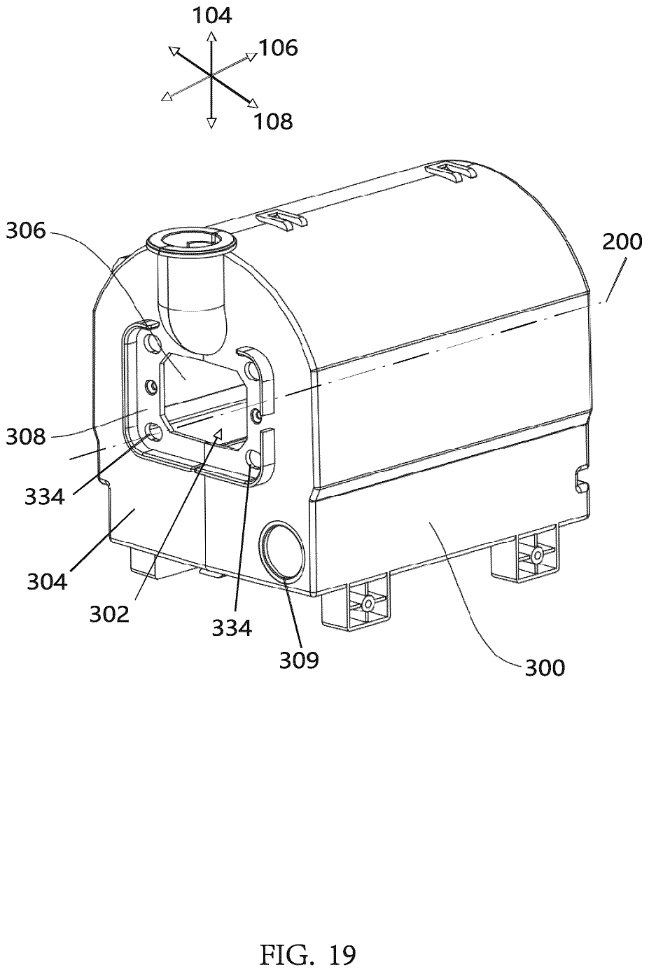

Referring to FIGS. 18-19, to improve refrigeration of the ingredients, the mixed-use refrigeration machine 100 can include an insulation housing 300 or cabinet that can accommodate the cooling/mixing vessel 142 can be located. The insulation housing 300 is an enclosure or container having exterior walls that define a housing enclosure 302 inside of which the cooling/mixing vessel 142. The insulation housing 300 is sized to receive the cooling/mixing vessel 142 and to be mounted in the upper space 162 of the upright stand 140. For example, the insulation housing can be fixedly mounted to the intermediate support plate 172 of the upright stand 140 and aligned in the longitudinal direction 106.

The insulation housing 300 can be geometrically shaped as a polyhedron that may be aligned along the vessel axis 200 when accommodating the cooling/mixing vessel 142. The insulation housing 300 can have a rear housing panel 304 that is perpendicular to the vessel axis 200. To enable coupling between the cooling/mixing vessel 142 in the housing enclosure 302 and the mixing motor 146, a drive mounting hole 306 is disposed into the rear housing panel 304. The drive mounting hole 306 is located in the rear housing plane 304 to align with the vessel axis 200. The drive mounting hole 306 can be associated with a mounting groove or mounting recess 308 formed on the rear housing panel 304. To accommodate the refrigeration circulation pipeline 158, a pipeline hole 309 can also be disposed in the rear housing panel 304.

Referring to FIG. 18, to connect the mixing motor 146 to the agitator 208 in the cooling/mixing vessel 142, the drive coupling aperture 234 is disposed through the closed blinded configuration of first axial end 202 of the vessel barrel 220. The drive coupling aperture 234 is aligned with the vessel axis 200. When the cooling/mixing vessel 142 is disposed in the insultation housing 300, the drive coupling aperture 234 and the drive mounting hole 306 coaxially align with the vessel axis 200.

To directly connect the mixing motor 146 with the agitator 208, the coupling assembly 210 can be situated between the mixing motor and the first axial end 202 of the cooling/mixing vessel 142. The coupling assembly 210 is configured to align the components with the vessel axis 200 to transfer torque between the mixing motor 146 and the agitator 208. To prevent leakage and prolong the operation of the mixed-used refrigeration machine 100, the coupling assembly 210 is configured to seal the torque transferring connections between the mixing motor 146 and the cooling/mixing vessel 142 that extend through the drive coupling aperture 234 of the vessel barrel 220 and the drive mounting hole 306 of the insulation housing 300.

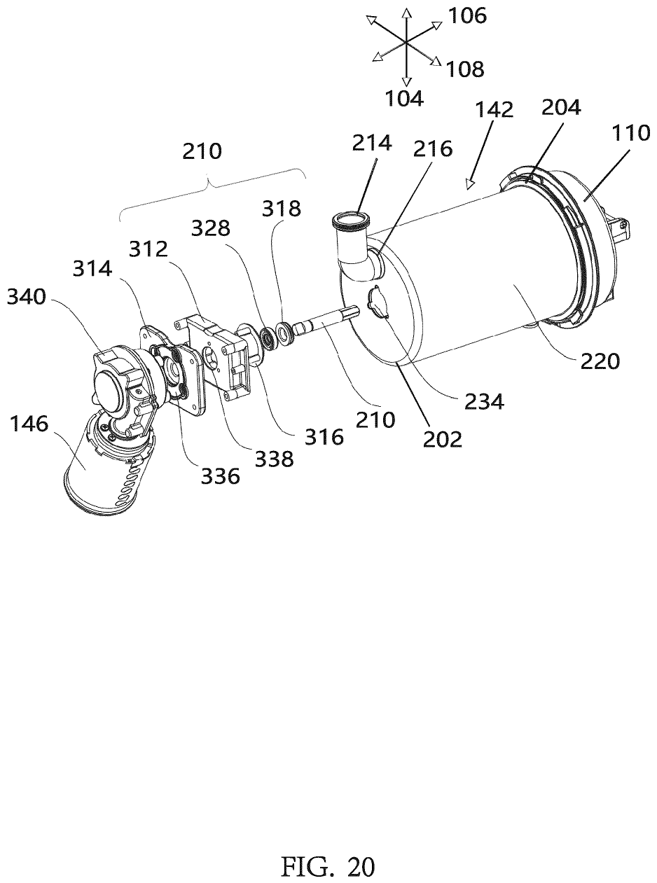

Referring to FIG. 20, to connect and rotationally lock the mixing motor 146 and the agitator 208, the coupling assembly 210 includes a rotating shaft 310 that penetrates through the drive coupling aperture 234 of the cooling/mixing vessel 142 and the drive mounting hole 306 of the insulation enclosure 300. The rotating shaft 310 is aligned with the vessel axis 200. To hold the rotating shaft 310 in alignment while sealing against leakage, the coupling assembly 210 includes first coupling seat 312 and a second coupling seat 314 that cooperatively interact to direct the rotating shaft 310 through the drive coupling aperture 234 and the drive mounting hole 306.

For example, the first coupling seat 312 is disposed between the first axial end 202 of the cooling/mixing vessel 142 and the rear housing panel 304 of the insulation housing 300. The first coupling seat 312 is longitudinally located between the cooling/mixing vessel 142 and the insulation housing 300 along the vessel axis 200. The second coupling seat 314 is disposed on the exterior of the rear housing panel 304 of the insulation housing 300.

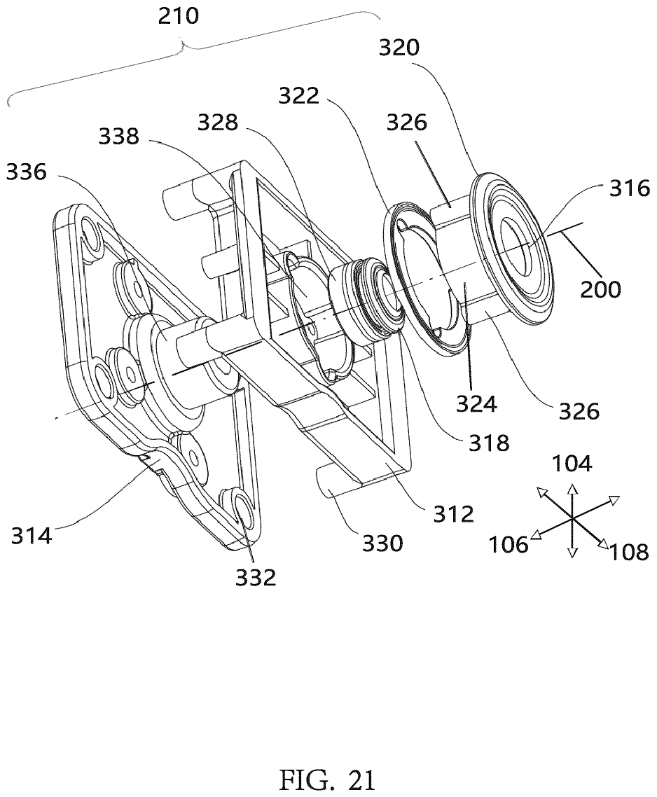

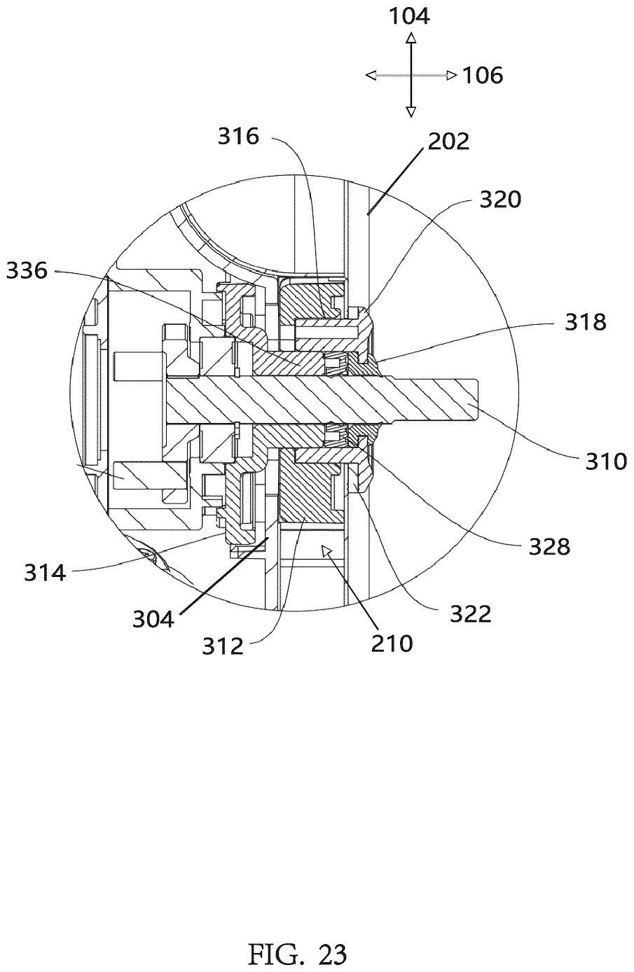

Referring to FIGS. 21 and 23, the first coupling seat 312 is operatively connected with an anti-rotation sleeve 316. The anti-rotation sleeve 316 is inserted into the drive mounting hole 306 disposed in the rear housing panel 304 and is rotationally locked with second axial end 202 of the cooling/ming vessel 142 against rotation about the vessel axis 200. For example, the anti-rotation sleeve may include a plurality of radial protruding ribs that run axially along the exterior surfaces and that mate with corresponding radial cutouts arranged angularly around the drive coupling aperture 234. The anti-rotation sleeve 316 is thereby prevented from rotation and is held stationary with respect to the rotating shaft 310. The anti-rotation sleeve 316 is in sealing connection with the drive coupling aperture 234. The rotating shaft 310 is received in and extends through a bore disposed longitudinally through the anti-rotation sleeve 316.

Referring to FIG. 21, a first seal 318 is disposed between the rotating shaft 310 and the anti-rotation sleeve 316. The first seal 318 may be annular in shape and includes an inner ring periphery in compressive sealing contact with the rotating shaft 310 and an outer ring periphery that forms a clearance fit with the bore disposed in the anti-rotation sleeve 316. The first coupling seat 312 holds the anti-rotation sleeve 316 in alignment with the drive coupling aperture 234 of the cooling/mixing vessel 142 and the anti-rotation sleeve 316 aligns the first seal 318 with the rotating shaft 310 to establish a sealing connection with the cooling/mixing vessel 142. This can effectively ensure assembly stability of the sealing apparatus.

Because of the clearance fit between the outer ring periphery of the first seal 318 and the bore of the anti-rotation sleeve 316, during rotation of the rotating shaft 310, the rotating shaft 310 can oscillate or elliptically move in sealing connection with the first coupling seat 312 and the anti-rotation sleeve 316 through the first seal 318. This reduces the wear between first seal 318 and the rotating shaft 310, prolongs the service life of the first seal 318, and ensures sealing performance between the rotating shaft 310 and the first coupling seat 312, thereby effectively lowering a leakage risk of the liquid water of the cooling/mixing vessel 142, and ensuring a refrigeration rate of the ingredients in the vessel barrel 220. The first seal 318 can be made of a wear-resistant and corrosion-resistant material such as polytetrafluoroethylene (PTFE) or rubber to prevent wear or corrosion of the first seal 318 during longtime use.

In an embodiment, the first coupling seat 312 is sealed about the drive coupling aperture 234 located in the first axial end 202 of the cooling/mixing vessel 142. The sealing performance between the first coupling seat 312 and the cooling/mixing vessel 142 is ensured. For example, to ensure a sealing fit between the anti-rotation sleeve 316 and the drive coupling aperture 234 in the cooling/mixing vessel 142, the end of the anti-rotation sleeve 316 inserted axially into the drive coupling aperture 234 includes a circular flange 320 that extend radially outward from the anti-rotation sleeve 316. The circular flange 320 defines an axial abutting surface that can abut against the closed, blinded configuration of the first axial end 202 of the cooling/mixing vessel 142 through a sealing gasket 322 in a sealing manner.

The inner rim of the sealing gasket 322 contacts the outer ring periphery of the first seal 318 as to ensure that the first seal 318 is limited against rotation with the rotating shaft 310 through the anti-rotation sleeve 316. The sealing gasket 322 can cause deformation under a pressure to adaptively fill up a gap between abutting surfaces. The sealing gasket 322 is used to adapt to an abutment gap between the circular flange 320 of the anti-rotation sleeve 316 and the first axial end 202 of the cooling/mixing vessel 142 to realize sealing contact between the anti-rotation sleeve 316 and the cooling/mixing vessel 142. This prevents leakage of liquid in the cooling/mixing vessel 142 from an abutment position between the anti-rotation sleeve 316 and the first axial end 202 of the cooling/mixing vessel 142 and further lowers the leakage risk of the liquid in the cooling/mixing vessel 142.

Optionally, the anti-rotation sleeve 316 is made of an elastic material such as rubber. After the anti-rotation sleeve 316 is inserted into the drive coupling aperture 234 of the cooling/mixing vessel 142, a sidewall of the anti-rotation sleeve 316 is rebound and closely abuts against the rim of the drive coupling aperture 234 to further enhance sealing performance between the anti-rotation sleeve 316 and the cooling/mixing vessel 142. The anti-rotation sleeve 316 is not limited to the elastic material such as the rubber and may also be made of a hard material. When the anti-rotation sleeve 316 is made of the hard material, the anti-rotation sleeve 316 is detachably connected to the first coupling seat 312 to ensure ease of assembly between the anti-rotation sleeve 316 and the first coupling seat 312.

Referring to FIG. 21, to secure the anti-rotation sleeve 316 to the first coupling seat 312, the anti-rotation sleeve 316 includes an axially extending post 324 that extends longitudinally from the circular flange 320. A plurality of fastener bosses 326 defining threaded holes are angularly located about the periphery of the axially extending post 324. When the anti-rotation sleeve 316 is installed in the first coupling seat 312, the axially extending post 324 may axially penetrate through the drive coupling aperture 234 in the cooling/mixing vessel 142. The anti-rotation sleeve 316 and first coupling seat 312 are connected through threaded fasteners thereby ensuring ease of assembly between the anti-rotation sleeve 316 and the first coupling seat 312.

A second seal 328 can be included to seal against the rotating shaft 310. The second seal 328 can be placed axially adjacent to the first seal 318 and both can be located in the inner bored defined through the anti-rotation sleeve 316. The second seal 328 includes an inner ring periphery in sealing contact with the rotating shaft 310 and an outer ring periphery radially abutting the bore disposed through the anti-rotation sleeve 316. The second seal 328 further reduces the gap between the anti-rotation sleeve 316 and the rotating shaft 310, thereby further enhancing sealing performance between the elements.

The second seal 328 can be configured as a seal lip. A section of the seal lip is an oblique plane. Through the second seal 328, an oil seal or a dynamic running seal is formed between the rotating shaft 310 and the anti-rotation sleeve 316 as well as between the rotating shaft 310 and the first coupling seal 312. Through cooperation between the second seal 328 and the first seal 318, stable and reliable sealing performance is provided for the rotating shaft 310, the first coupling seat 312, and anti-rotation sleeve 316.

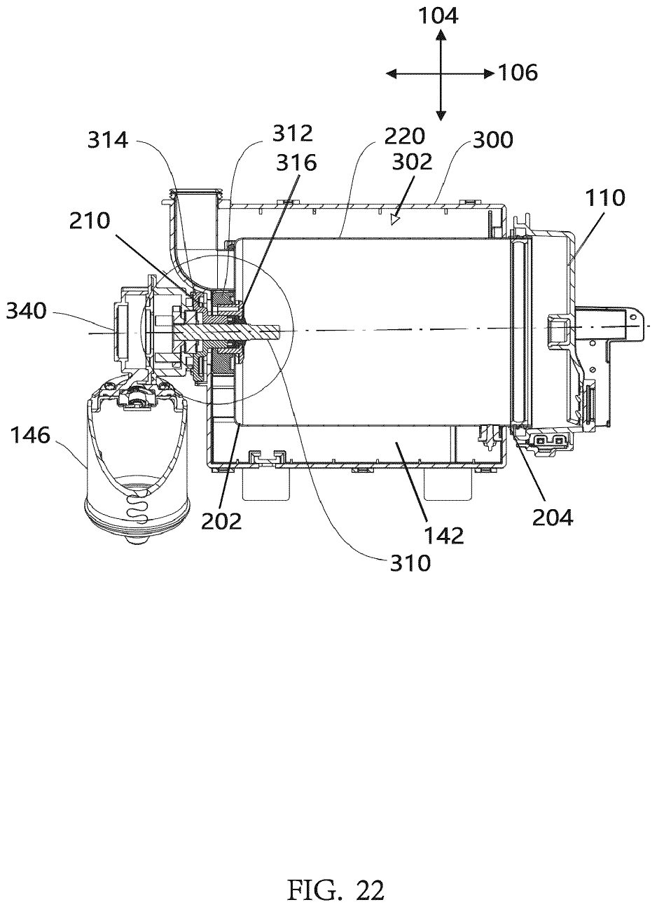

Referring to FIG. 22, to ensure the mounting stability between the cooling/mixing vessel 142 and the insulation housing 300, the first coupling seat 312 is configured to be disposed axially between the components and in axially abutting contact with the components. For example, the first coupling seat 312 has a preset thickness in the longitudinal direction 106. The preset thickness matches the axial distance between the first axial end 202 of the cooling/mixing vessel 142 and the rear housing panel 304 of the insulation housing 300.

When the first coupling seat 312 is assembled between the cooling/mixing vessel 142 and the insulation housing 300, the first coupling seat 312 can be clamped by the rear housing panel 304 of the insulation housing 300 and the first axial end 202 of the cooling/mixing vessel 142. The first coupling seat 312 is further connected to the drive coupling aperture 234 in the first axial end 202 by the anti-rotation sleeve 316. This ensures assembly stability of the first coupling seat 312 between the insultation housing 300 and the cooling/mixing vessel 142 and prevents the first coupling seat 312 from shaking to affect the sealing performance of the first and second seals 318, 328.

Referring to FIG. 21, to interface with the first coupling seat 312 disposed between the cooling/mixing vessel 142 and the insultation housing 300, the second coupling seat 314 is provided on the exterior of the insulation housing 300. The second coupling seat 314 can be detachably connected to the first coupling seat 312. The size of the second coupling seat 314 is larger greater than the size of the drive mounting hole 306 disposed in the rear housing panel 304 of the insulation housing 300. When the second coupling seat 314 is attached to the rear housing panel 304 of the insulating housing 300, the second coupling seat 314 can shield the drive mounting hole 306 to prevent an internal components of the insulation housing 300 from being exposed and realize dust prevention for the insulation housing 300. The second coupling seat 314 can be fixedly seated in the mounting recess 308 formed on the rear housing panel 304.

To detachably connect the first coupling seat 312 and the second coupling seat 314, the first coupling seat 312 includes one or more connecting bosses 330 longitudinally projecting from the axial surface. The connecting bosses 330 are parallel to the vessel axis 200 and offset from the vessel axis 200 in a pattern disposed about the axial face of the first coupling seat 312. To interface with the connecting bosses 330, the second coupling seat 314 can have a complementary pattern of connecting boss holes 332. The connecting boss hole 332 are configured to receive and mate with the connecting bosses 330 when the first and second coupling seats 312, 314 are moved together in the longitudinal direction 106. To allow the connecting bosses 330 and the connecting boss holes 332 to mate, a plurality of connecting apertures 334 arranged in corresponding pattern is disposed through the rear housing panel 304 of the insulation housing 300 as shown in FIG. 19.

Referring to FIG. 21, to further couple the first and second coupling seats 312, 314, the second coupling seat 314 includes a central boss 336 that axially protrudes perpendicularly from an axial face of the second coupling seat 314. The central boss 336 may be a post that is coaxially aligned with the vessel axis 200 in the center of the second coupling seat 314. To receive the central boss 336, a corresponding central boss hole 338 is disposed in the first coupling seat 312 in the longitudinal direction 106 and is coaxially aligned with the vessel axis 200.

When the first and second coupling seats 312, 314 are moved together in the longitudinal direction 106, the central boss 336 is coaxially received in and mated with the central boss hole 338. The mating connection between the central boss 336 of the second coupling seat 314 and the central boss hole 338 of the first coupling seat 312 is limited axially and radially. This further ensures sealing performance of the first and second seals 318, 328 between the first coupling seat 312 and the second coupling seat 314.

The central boss hole 338 is coaxial with the drive coupling aperture 234 and is disposed in the first axial end 202 of the cooling/mixing vessel 142 and the drive mounting hole 306 of the insulation housing 300. A hollow bore is formed in the central boss 336. The rotating shaft 310 is rotatably inserted through the hollow bore. The central boss 336 of the second coupling seat 314 is used to limit and protect the rotating shaft 310 to further ensure rotational stability of the rotating shaft 310.

Referring to FIGS. 20 and 22, in the embodiment where the mixing motor 146 is aligned in the vertical direction 104, a drive connection 340 can be included and may be associated with a transmission or gear set to enable the right-angled transfer of torque from the vertical direction 104 to alignment with the vessel axis 200 in the longitudinal direction 106. An output shaft of the mixing motor 146 is connected in fixed rotation to the drive connection 340 associated with the transmission set. A driven end of the transmission set is connected in fixed rotation to the rotating shaft 310. The mixing motor 146 can drive the driving end of the transmission set associated with the drive connection 340 to rotate, thereby driving the driven end of the transmission set and the rotating shaft 310 to rotate. Therefore, the rotating shaft 310 can drive the agitator 208 located in the cooling/mixing vessel 142.

The drive connection 340 may provide dust prevention for the transmission set as well as a right-angled junction between mixing motor 146 and the rotating shaft 310. The junctions between the mixing motor 146, the transmission set associated with the drive connection 340, and the rotating shaft 310, are directly exposed in an external environment to ensure effective transmission among the connected elements and ensure a rate of energy utilization of the mixing motor 146.

The drive connection 340 may include a first connection seat and a second connection seat that are detachably connected to facilitate maintenance and repair of the transmission set in the driving connection 340. The first connection seat is connected to the mixing motor 146 and the second connection seat is connected to the second coupling seat 314. An end of the rotating shaft 310 is rotatably connected to the second coupling seat 314 through a bearing to further ensure rotational stability of the rotating shaft 310.

The transmission set associated with the drive connection 340 is preferably a gear set for transmission of the mixing motor 146 and the rotating shaft 310 to reduce space occupied by the drive connection 340 and improve space utilization of the cooling/mixing vessel 142. Certainly, the specific structure of the transmission set are not limited to the gear set and may also be other transmission structures such as a chain transmission structure or a belt transmission structure. The specific structure of the transmission set may be set corresponding according to an actual condition.

In another embodiment, the mixing motor 146 can be coaxially coupled directly to the coupling assembly 210 in aligned with the vessel axis 200. The drive shaft protruding from the mixing motor 146 can directly connect to the rotating shaft 310 that extends through the first and second coupling seats 312, 314, the drive shaft protruding from the mixing motor 146 can be the rotating shaft 310 itself. The interaction between the first and second coupling seats 312, 314 and the first and second seals 318, 328 allows sufficient play to accommodate misalignment between the mixing motor 146 and the agitator 208 with respect to the vessel axis 200 by coupling to the rotating shaft 310. The coupling assembly 210 facilities alignment of the components with the vessel axis 200.

### Dispensing Apparatus

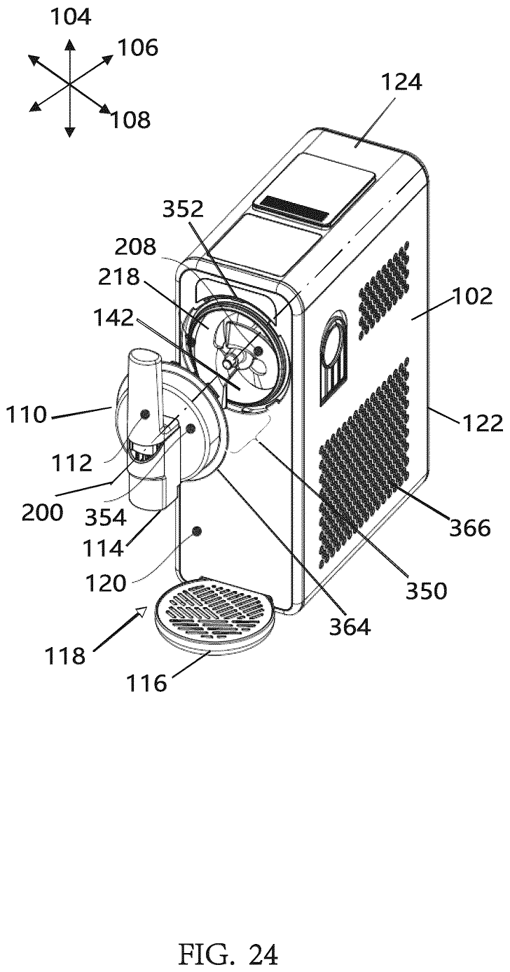

Referring to FIG. 24. for ease of disassembly and cleaning, the dispensing apparatus 110 can be configured as a separable assembly that can be removably mounted to the exterior housing 102 of the mixed-use refrigeration machine 100. For example, the dispensing apparatus 110 can be associated with a mounting clamp 350 that can be engaged by hand with corresponding structures located on the front panel 120 of the exterior housing 102 in a leak-tight manner. The hands-free mounting clamp 350 eliminates the needs for additional tools to remove the dispensing apparatus 110 through which the frozen beverages and edibles pass. The arrangement facilitates cleaning and improves sanitation without requiring complex disassembly or effort.

To enable communication for flow of material between the dispensing apparatus 110 located externally of the exterior housing 102 and the cooling/mixing vessel 142 disposed internally of the exterior housing 102, the front panel 120 has a dispensing opening 352 disposed therein. The dispensing opening 352 can be located at the upper half of the front panel 120 in the vertical direction 104 to correspond in location with the upper space 162 enclosed by the external housing 102. The dispensing opening 352 can be circular in shape and correspond in diameter to the dispensing outlet 218 defined in the second axial end 204 of the vessel barrel 220 associated with the cooling/mixing vessel 142. The dispensing opening 352 coaxially aligns with the vessel axis 200 and may be concentrically adjacent to the circumference of the second axial end 204 that defines the dispensing outlet 218.

The dispensing apparatus 110 is designed to attach to the front panel 120 via the mounting clamp 350 and interface with the dispensing opening 352. For example, to enclose the second axial end 204 and receive the mixed ingredients directed longitudinally through the cooling/mixing vessel 142 along vessel axis 200, the dispensing apparatus 110 includes a dispensing cap 354. The handle 112 and the dispensing spout 114 are attached to the dispensing cap 354 and function to selective redirect the flowable ingredients downward in the vertical direction 104 toward the dispensing region 118 where a receptacle like a cup or bowl may be located.

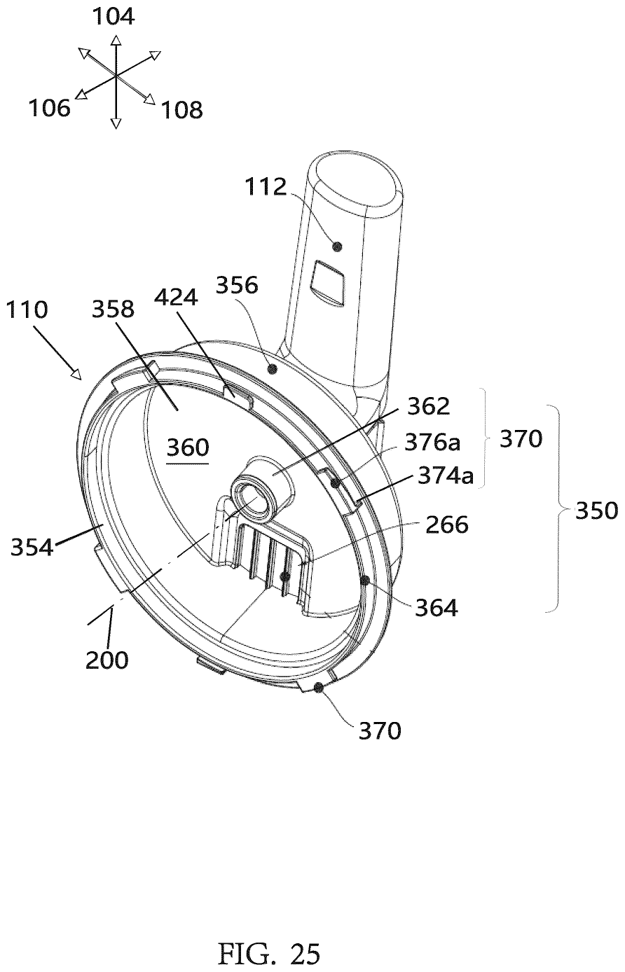

Referring to FIGS. 24 and 25, the dispensing cap 354 can be cylindrical structure to correspond with the cylindrical geometry of the cooling/mixing vessel 142. For example, the dispensing cap 354 can have an annular sidewall 356 adapted to align coaxially around the vessel axis 200 and an axial plate 358 at an axial end that is oriented perpendicular to the vessel axis 200. The annular sidewall 356 and the axial plate 358 structurally define a dispensing cavity 360 that communicates with the vessel chamber 206 when the dispensing cap 354 is interfaced with the cooling/mixing vessel 142. The handle 112 and spout 114 can be attached to the front exterior of the axial plate 358 and the dispensing port 266 associated with the dispensing apparatus 110 is disposed through the axial plate 358.

In a possible configuration, the dispensing cap 354 rotatably connects with and support the agitator 208. For example, the dispensing cap 354 includes a shaft bearing 362 located on the internal face of the axial plate 358. The shaft bearing 362 is centrally on the axial plate 358 to coaxially algin with the vessel axis 200 when the dispensing cap 354 is attached. The shaft bearing 362 can be embodied as a journal bearing or plain bearing and is structurally configured as an axially projecting cylindrical sleeve.

Referring back to FIG. 10, when the dispensing apparatus 110 is interfaced with the cooling/mixing vessel 142, the second shaft end 246 of the agitator shaft 240 is received in the shaft bearing 362. The second shaft end 246 and shaft bearing 362 can slide with respect to each other so that the agitator 208 can rotate with respect to the stationary dispensing apparatus 110 while supporting the agitator shaft 240. The shaft bearing 362 can freely release the second shaft end 246 for dismounting the dispensing apparatus 110 with respect to the cooling/mixing vessel 142.

In an embodiment shown in FIG. 10, the first and second stirring blades 242a, 242b can axially extend from the second axial end 204 of the cooling/mixing vessel 142 to be spatially accommodated in the dispensing cavity 360 defined by the dispensing cap 354. The axially distal ends of the stirring blades 242a, 242b can rotate adjacent to the axial plate 358 of the dispensing cap 354 and can sweep past the dispensing port 266 disposed therein. The reflow flange 260 associated with the stirring blades 242a, 242b at the second shaft end 246 can function to cyclically redirect the longitudinal flow of the mixed ingredients through the dispensing port 266 to clear amalgamation. By extending the agitator 208 axially into the dispensing cavity 360 defined by the dispensing cap 354, the flow of ingredients through the dispensing port 266 is effectively controller and material will not stagnate in the dispensing cap 354.

Referring to FIG. 25, the mounting clamp 350 can be a mechanical connection with interacting structures distributed on the dispensing cap 354 and the front panel 120 of the exterior housing 102. In an embodiment, the mounting clamp 350 can be configured as a bayonet mount or twist lock that is engaged by relative rotation between the interlocking structures. The dispensing apparatus 110 can be placed adjacent to the front panel 120 with the dispensing cap 354 aligned with the dispensing opening 352 and the mounting clamp 350 is engaged and/or disengaged by relative rotation of the dispensing apparatus 110 about the vessel axis 200. Twisting rotation can be applied to the dispensing apparatus 110 by, for example, by grasping the handle 112 and turning relative to the vessel axis 200. The mounting clamp 350 when engaged functions to hold the dispensing apparatus in axial alignment with the cooling/mixing vessel 142 and seals the dispensing outlet 218 of the cooling/mixing vessel 142 to prevent leakage.

It should be noted that the design of the detachable installation of the dispensing apparatus 110 to the exterior housing 102 using the handle 112 makes equipment maintenance and cleaning extremely convenient. When it is necessary to clean or replace the dispensing apparatus 110, users do not need to disassemble the entire device; quick installation and removal can be achieved with simple operations, greatly saving time and labor costs and improving work efficiency. At the same time, this design also facilitates the adjustment or replacement of dispensing system of different specifications and materials according to production needs, enhancing the flexibility and adaptability of the equipment. Since the dispensing apparatus 110 is a structure that can be replaced and maintained separately, it allows staff to replace or clean the dispensing apparatus 110 independently, reducing the difficulty of replacing the dispensing apparatus 110 solving the problem of difficulty in cleaning traditional dispensing system due to their difficult removal.

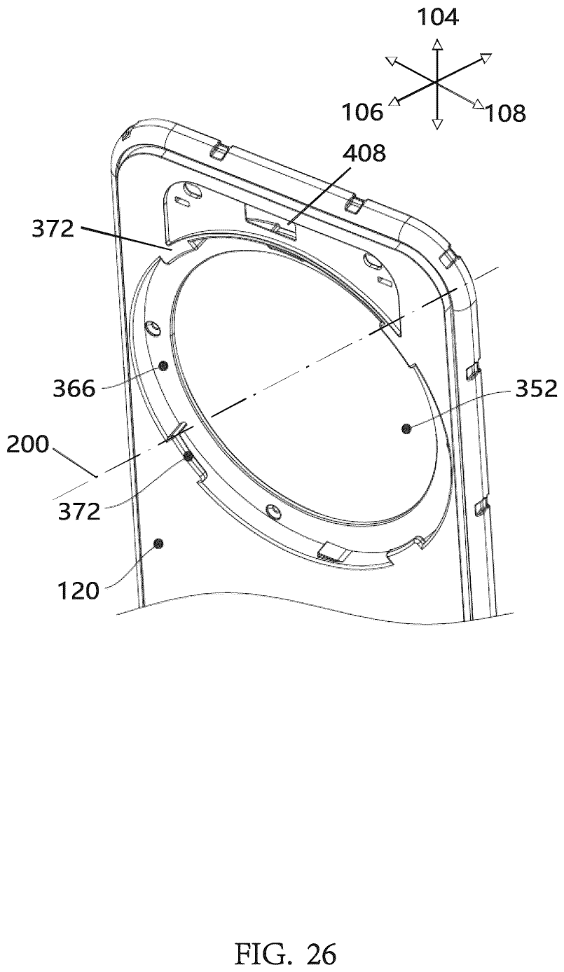

Referring to FIGS. 25 and 26, the bayonet mounting or twist lock configuration of the mounting clamp 350 can include a plurality of tabs and recess that are moved together and apart respectively for engagement and disengagement. The tabs and recesses can be angularly spaced around the vessel axis 200 and distributed between the dispensing cap 354 and the front panel 120 to be rotated together and apart. The tabs and recesses can be distributed on either structure at varied angular locations so mounting clamp 350 produces a circumferentially distributed axial force drawing the dispensing apparatus 110 and front panel 120 adjacently together. For example, when the dispensing apparatus 110 is rotated with respect to the vessel axis 200, the tabs and recesses engage, pulling the dispensing cap 354 axially adjacent to the front panel 120 and locking the mounting ring 364 in the annular mounting recess 366.

For example, referring to FIG. 25, the dispensing cap 354 can be provided with a mounting ring 364 that is located around the circumferential rim of the annular sidewall 356 axially opposite of the axial plate 358. The mounting ring 364 can include a plurality of first engaging blocks 370 that are angularly spaced around the rim of the annular sidewall 356 with respect to the vessel axis 200. Referring to FIG. 26, the dispensing opening 352 can be associated with an annular mounting recess 366 partly disposed into the exterior surface of the front panel 120. The annular mounting recess 366 is concentric to the dispensing opening 352 and aligned with the vessel axis 200. Disposed angularly around the annular mounting recess 366 is a corresponding plurality of second engaging block 372. The first engaging blocks 370 and second engaging blocks 372 are designed to engage with each other upon relative rotation of the dispensing apparatus 110 and front panel 120. The mounting ring 364 and the annular mounting recess 366 can be complementary diameter to fit together to resist leakage between the structures

The one-to-one correspondence design of the first engaging blocks 370 and the second engaging blocks 372 makes the installation and disassembly process simple and quick. Users only need to align the mounting ring 364 on the dispensing cap 354 with the annular mounting recess 366 on the front panel 120 and rotate or push the structure to lock or unlock the engaging blocks 370, 372, which not only improves work efficiency but also reduces operation difficulty and error rate.

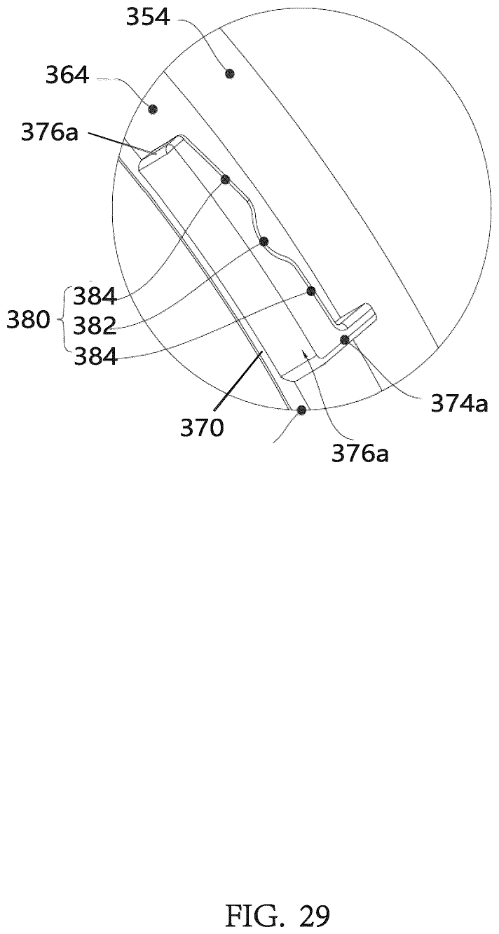

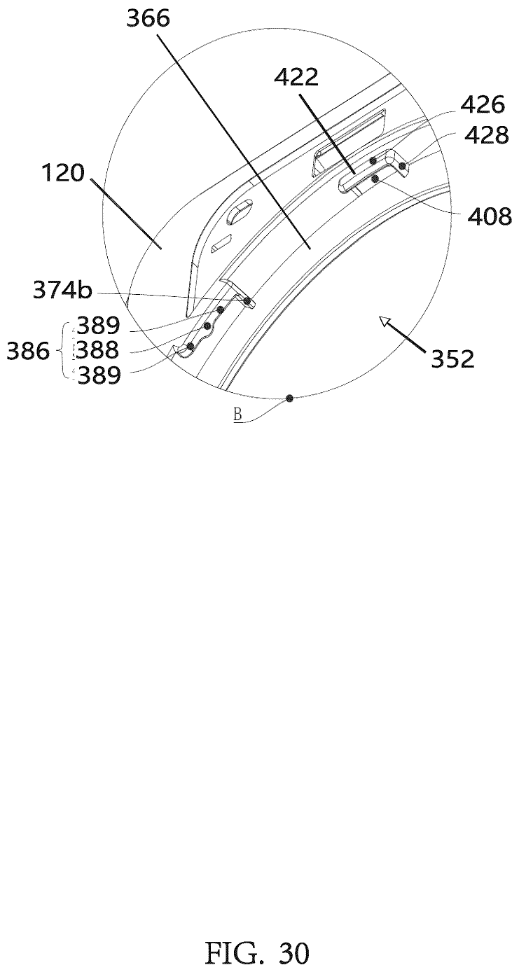

Referring to FIGS. 29 and 30, in an embodiment, the first and second engaging blocks 370, 372 can be geometrically configured as L-shaped interlocking blocks to facilitate rotational engagement and disengagement. For example, the first engaging blocks 370 can each comprise a first axial leg 374a and a first circumferential leg 376a. An end of the first axial leg 374a extends longitudinally from the annular face of the mounting ring 364 and the first circumferential leg 376a extends perpendicularly to the first axial leg 374a so as to be parallel to and offset from the mounting ring 364.

The second engaging blocks 372 can each include a second axial leg 374b and a second circumferential leg 376b that are also perpendicular to each other to provide the L-shape geometry. The second axial leg 374b extends axially in the annular mounting recess 366 disposed in the front panel 120 and the second circumferential leg 376b extends perpendicularly from the second axial leg 374a to provide a slot or gap parallel with the annular mounting recess 366. The axial lengths of the first and second axial legs 374a, 374b, are consistent with the vessel axis 200.

Since both the first engaging block 370 and the second engaging block 372 have an L-shaped structure, they can increase the strength and rigidity of the mounting ring 364 and the annular mounting recess 366. The first axial leg 374a is integrally mounted to the inner wall associated with the mounting ring 364 on the dispensing cap 354, and the second axial leg 374b is integrally connected to the inner wall of the annular mounting recess 366, ensuring that the first engaging block 370 and the second engaging block 372 do not easily loosen or fall off when subjected to force. The first circumferential leg 376a is flush with the end of the mounting ring 364 and the second circumferential leg 376b is flush with the outer surface of the front panel 120, further enhancing the strength and stability of the connection, making the connection between the dispensing apparatus 110 and the front panel 120 more secure and reliable, thereby being able to withstand greater external forces and impacts.

Moreover, the L-shaped design allows the first engaging block 370 and the second engaging block 372, when combined, to achieve preliminary fixation through the relative positioning of the first axial leg 374a and the second axial leg 374b, and to form a more stable supporting surface through the mutual abutment of the first circumferential leg 376a and the second circumferential leg 376b. This dual function significantly enhances the overall stability and load-bearing capacity of the mounting clamp 350, reducing the risk of loosening or deformation due to external forces.

In addition, rotating the dispensing apparatus 110 in the opposite direction about the vessel axis 200 causes the first engaging blocks 370 and the second engaging blocks 372 to move apart from each other, allowing staff to quickly disassemble the dispensing apparatus 110 when maintenance or replacement is needed, shortening maintenance time and improving the overall availability and operational efficiency of the equipment.

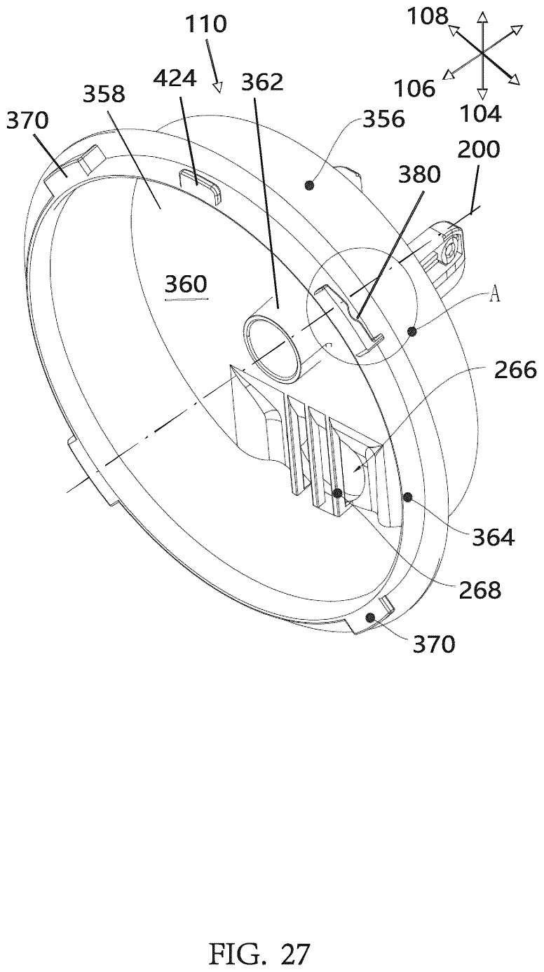

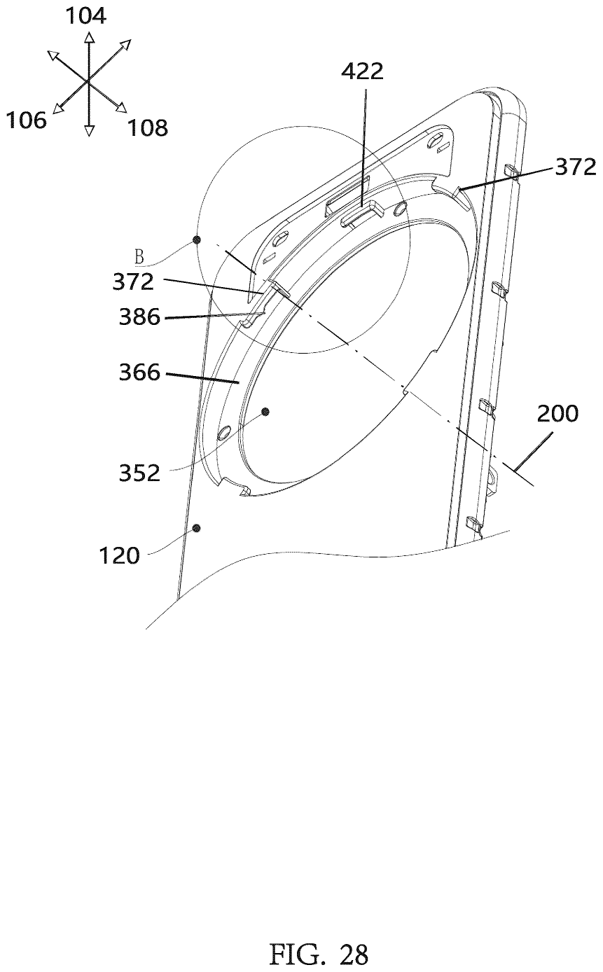

Referring to FIGS. 27 and 28, the first engaging blocks 370 and the second engaging blocks 372 are arranged clockwise, which greatly simplifies the assembly process of the dispensing apparatus 110. Rotating the dispensing cap 354 counterclockwise about the vessel axis 200 separates the first engaging blocks 370 and the second engaging blocks 372, allowing for quick disassembly of the dispensing apparatus 110. Rotating the dispensing cap 354 clockwise about the vessel axis 200 allows the first engaging portions to naturally and smoothly engage with the second engaging portions without the need for additional adjustment or alignment steps, significantly improving work efficiency and reducing operation time.

Referring to FIGS. 29 and 30, in a possible embodiment, the first and second engaging blocks 370, 372 are configured as interlocking male and female structures that lock to prevent unintended rotation and dismounting of the dispensing apparatus 110. The interlocking male and female structures can be circumferentially engaged by relative rotation of the dispensing apparatus 110 and front panel 120 with respect to the vessel axis 200 and can be disengage only upon a sufficient application of torque in the reverse rotational direction. The interlocking male and female structures hold the dispensing apparatus 110 axially secure to the front panel 120 in a leak-tight manner.

Referring to FIG. 29, the first engaging blocks 370 can be configured as the female structure having a female socket 380 formed as recess for receiving a corresponding male protrusion or detents. For example, the first circumferential leg 376a can be formed with a recessed subsection 382 and an inclined subsection 384, with the recessed subsection 382 located between two said second inclined subsections 384 at both ends.

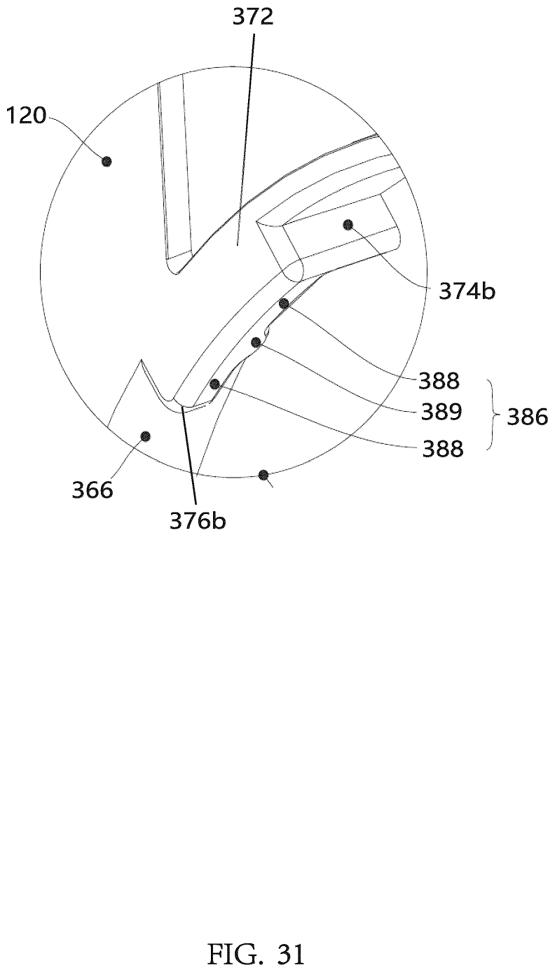

Referring to FIGS. 30 and 31, the second engaging blocks 372 can be configured as the male structure including a male detent or male protrusion 386. For example, the second circumferential leg 376b is formed with a first inclined subsection 388 and a protruding subsection 389, with the protruding subsection 389 located between two of said first inclined subsections 388 at both ends. The recessed subsection 382 engages with the protruding subsection 389, and the first inclined subsection 384 abuts against the second inclined subsection 388.

It is worth noting that the precise engagement design of the female socket 380 and the male protrusion 386 enables a tighter locking fit between the first engaging block 370 and the second engaging block 372, effectively preventing relative displacement due to vibration or external forces, thereby enhancing the overall structural stability and reliability.

The abutment between the first inclined subsection 384 and the second inclined subsection 389 not only increases the contact area but also, through the design of the inclination angle, guides and disperses the stress generated during the clamping process, effectively reducing local stress concentration and extending the service life of the mounting clamp 350. When the male protrusion 386 is fully inserted into the female socket 380, the presence of the inclined subsections creates a wedge-like locking effect. This self-locking mechanism enables the clamping structure to generate greater resistance when subjected to reverse tensile forces, further enhancing the stability of the connection.

### Dispensing Apparatus Sensors

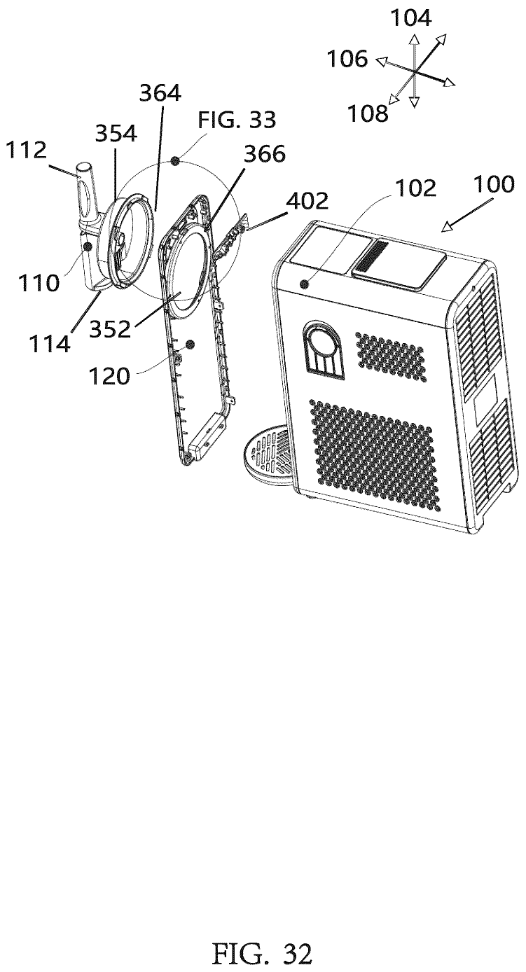

Referring to FIG. 32, when the dispensing apparatus 110 is clamped to the front panel 120 of the mixed-use refrigeration machine 100, the dispensing port 266 disposed in the dispensing cap 354 can receive the refrigerated ingredients dispensed in the longitudinal direction 106 through the dispensing opening 352 communicating with the cooling/mixing vessel 142 located inside the exterior housing 102. The mounting clamp 350 assists in ensuring there is little or no leakage of ingredients directed between the dispensing opening 352 in the front panel 120 and the dispensing port 266 in the dispensing cap 354.

When the dispensing port 266 is effectively sealed by the mounting clamp 350, the ice cream or the smoothies cannot be affected by the external environment (such as temperature fluctuation and dust) in preparation or storage. With the mounting clamp 350, the dispensing apparatus 110 can be detached or mounted easily. This simplifies the cleaning and maintenance of the dispensing apparatus and the mixed-use refrigeration machine 100.

Because of the ability to clamp and unclamp the dispensing apparatus 110 via the mounting clamp 350, misalignment may be possible and the dispensing cap 354 may not be properly sealed to the front panel 120. To detect proper attachment of the dispensing apparatus 110 to the front panel 120, the mounting clamp 350 can be associated with a microswitch sensor 400. The microswitch sensor 400 detects whether the dispensing cap 354 is correctly and firmly locked with respect to the dispensing opening 352 in the front panel 120 in real time. When identifying attachment of the dispensing cap 354 by the mounting clamp 350, the microswitch 400 completes an electrical circuit on to ensure normal discharge operation of the mixed-used refrigeration machine 100. This prevents accidental leakage or damage due to the dispensing apparatus 110 not being properly locked, greatly improves the safety of the operation, and solves the problems of low efficiency and high error rate of the conventional method that determines the locked state of the dispensing apparatus 110 through experience of the worker. For example, if the microswitch 400 detects the dispensing cap 354 is not properly installed in the annular mounting recess 366, the microswitch 400 can operate to electrically lock and prevent the mixing motor 146 from operating, for example, via the electronic controller 132.

Referring to FIG. 32, to connect the microswitch sensor 400, a sensor bar 402 embodied as an elongated plastic bar can be attached to the inner surface of the front panel 120 and located to extend tangentially to the dispensing opening 352. The sensor bar 402 is aligned with the lateral direction 108 of the mixed-use refrigeration machine 100. To attach the sensor bar 402, a pair of laterally spaced apart snap prongs 404 can protrude from the inner surface of the front panel 120 in the longitudinal direction 106. The snap prong 404 can snap into engagement with a corresponding pair of snap holes 406 disposed into the sensor bar 402. The sensor bar 402 is accordingly located perpendicular to the vessel axis 200 and tangential to the dispensing opening 352 of the front panel 120.

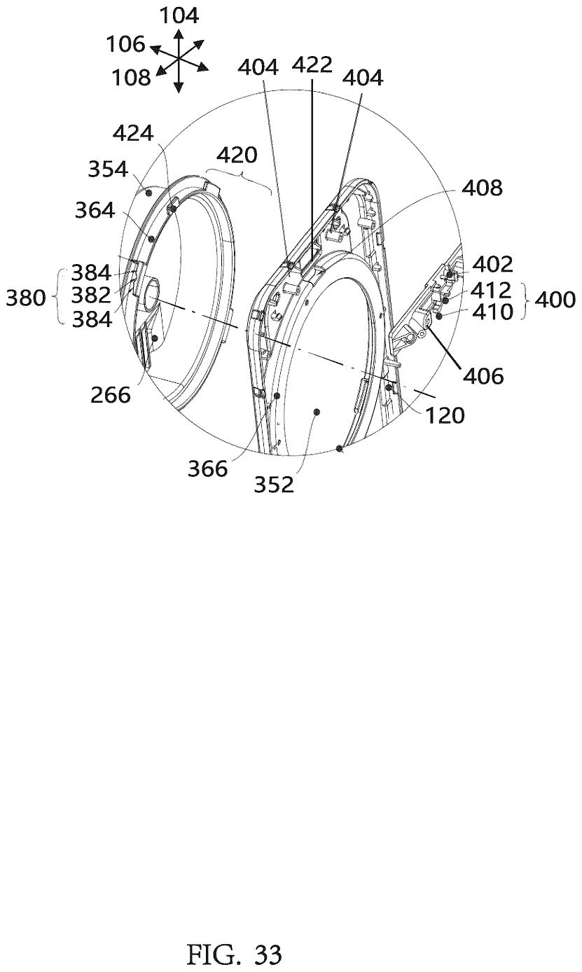

To enable the microswitch sensor 400 to interact with the dispensing apparatus 110, a reference hole 408 is disposed through the front panel 120. Referring to FIG. 33, the reference hole 408 is disposed as a slot or opening through the annular mounting recess 366. The reference hole 408 is radially offset from the vessel axis 200. When the sensor bar 402 is attached to the front panel 120, the microswitch sensor 400 can align with the reference hole 408 in angular relation to the vessel axis 200. When the dispensing cap 354 is mounted to the front panel 120, the mounting ring 364 formed at rim of the annular sidewall 356 is received into the annular mounting recess 366 disposed in the front panel 120. The mounting ring 364 is exposed to the microswitch sensor 400 via the reference hole 408.

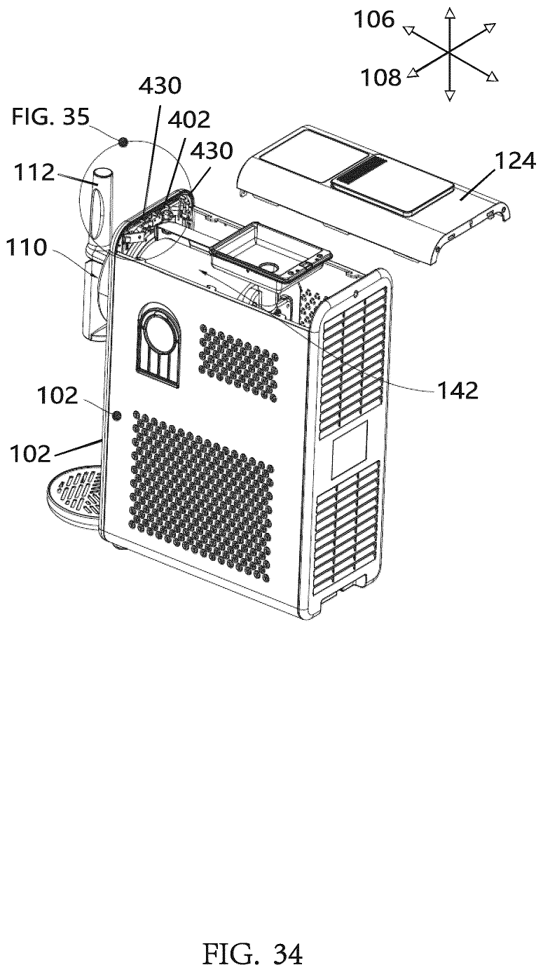

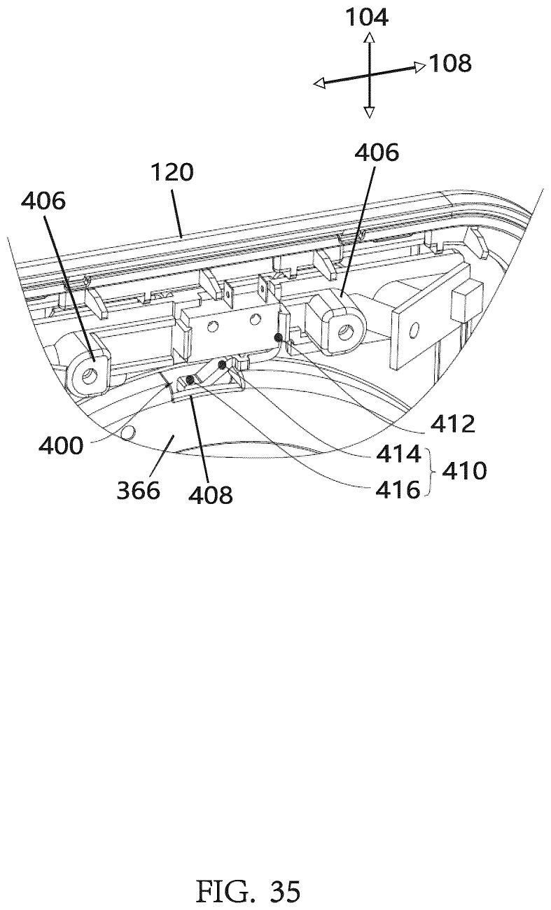

Referring to FIGS. 34 and 35, the microswitch sensor 400 includes a contact 410 and a sensor body 412. The contact 410 can be configured as a cantilevered leg that extends from the sensor body 412. When the sensor bar 402 is mounted to the front panel, the microswitch sensor 400 is arranged so that the contact 410 can extend through the reference hole 408. When the dispensing apparatus 110 is clamped front panel 120 using the mounting clamp 350, the contact 410 can contact the mounting ring 364 on the dispensing cap and deflect. For example, when the dispensing apparatus 110 is rotated with respect to the vessel axis 200 to engage the mounting clamp 350, the contact 410 make deflecting contact with the mounting ring 364 and can move upwardly through the reference hole 408.

The microswitch 400 is associated with an electric circuit that can be opened and closed by deflection of the contact 410 with respect to the sensor body 412. In response to an external force on the contact 410, the sensor body 412 registers the deformation of the cantilevered contact 410 and turns the circuit on. When the dispensing apparatus is rotated and demounted from the front panel, accordingly removing the mounting ring 364 from the annular mounting recess 366 disposed in the front panel 120, the contact 410 is no longer deflected and the sensor body 412 identifies the signal and turns off the circuit. It is to be noted that the contact 410 has desirable elasticity and restorability, and can remain stable performance after repeated use, thereby ensuring that the microswitch 400 can turn the circuit off or on timely. Meanwhile, the cantilevered contact 410 also takes a buffer action to some extent to reduce damage to the device for the mis-operation or external impact.

In an embodiment, the contact 410 includes a tilt portion 414 and an abutment portion 416. The tilt portion 414 is obliquely connected to the sensor body 412 and the abutment portion 416. The abutment portion 416 movably penetrates into the reference hole 408. In response to an external force on the abutment portion 416, the tilt portion 414 can cause certain elastic deformation, such that the sensor body 412 can sense microdeformation of the abutment portion 416 more accurately to determine the locked state of the dispensing apparatus 110. When the dispensing apparatus 110 is correctly locked, the mounting ring 364 pushes up the abutment portion 416, and the abutment portion 416 and the tilt portion 414 cause deformation. The microswitch sensor 400 can accurately capture the change of this state, to prevent the error possibly caused by the conventional subjective judgment.

In an embodiment, to ensure the microswitch sensor 400 is properly aligned with the mounting ring 364 of the dispensing cap 354 for deflection of the contact 410, the mounting clamp 350 can be associated with a keying feature 420. The keying feature 420 ensures keyed align when the dispensing apparatus 110 is mounted to the front panel 120.

Referring to FIG. 33, the keying feature 420 can include a keying slot 422 disposed into the annular mounting recess 366 of the front panel that can receive and engage with a keying tab 424 located on the mounting ring 364 of the dispensing cap 354 shown in FIG. J. The keying slot 422 and the keying tab 424 are in a one-to-one correspondence and are engaged to each other when the dispensing apparatus 110 is mounted to the front panel 120 so that the mounting ring 364 is received in the mounting recess 366. When the keying slot 422 and the keying tab 424 are engaged, the top of the keying tab 424 may abut the contact 410 associated with the microswitch sensor 400.

The keying slot 422 may have an L-shaped configuration and include a circumferential leg 426 and an axial leg 428. The circumferential leg 426 and the axial leg 428 are provided around the reference hole 408. The axial leg 428 includes one end connected to an inner wall of the annular mounting recess 366, and the other end perpendicularly connected to the circumferential leg 426. A length direction of the axial leg 428 is the same as a axial direction of the vessel axis 200.

By rotating the dispensing apparatus 110, the keying tab 424 on the mounting ring 364 is rotated with respect to the vessel axis 200. Under guidance of the circumferential leg 426, the keying tab 424 abuts against the keying slot 422, and the keying tab 424 is located in the reference hole 408 and upwardly abuts against the contact 410 of the microswitch sensor 400. This reduces the impact and abrasion caused by direct hard connection and effectively prolongs the service life of the microswitch sensor 400. Through mutual cooperation among the contact 410, the keying feature 420, and the sensor body 412, the present disclosure realizes automatic detection, without troublesome manual inspection of the worker or reliance on experience of the worker, thereby reducing the error rate caused by the human factor.

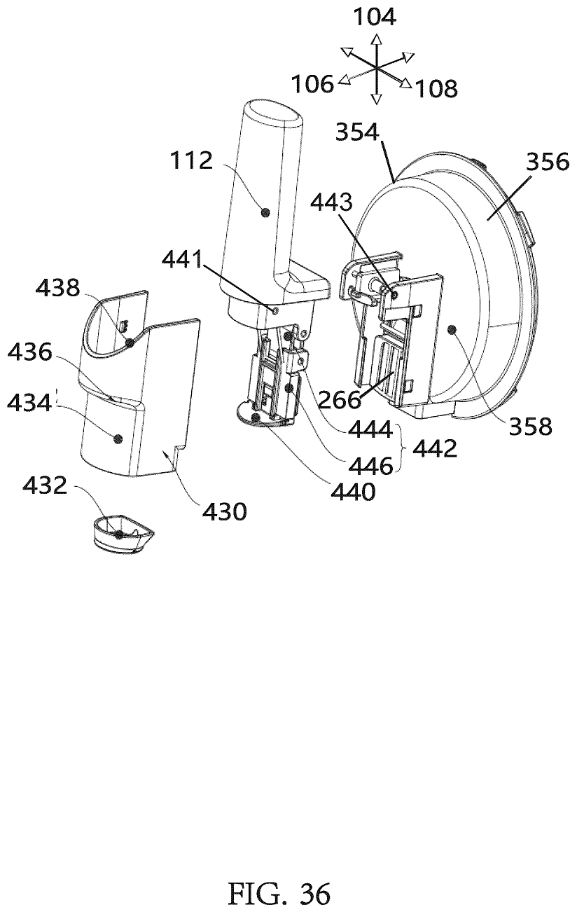

Referring to FIG. 36, manipulation of the handle 112 controls the dispensing apparatus 110 to dispense the refrigerated contents through the spout 114 downwardly in the vertical direction 104. To assist in directing the dispensed ingredients, the spout 114 can include a dispensing hood 430 or shroud that can be attached to the exterior of the axial plate 358 of the dispensing cap 354. The dispensing hood 430 that can be a U-shaped structure that, when attached to the dispensing cap 354, is located longitudinally forward of and covers the dispensing port 266 that is disposed in the axial plate 358. The dispensing hood 430 can be associated with a dispensing plate 432 at the vertically lower end that also functions as a valve seat and that is oriented in the vertical direction 104.

The refrigerated ingredients that enter the dispensing hood 430 in the longitudinal direction 106 from the dispensing port 266 of the dispensing cap 354 are redirected by the dispensing hood 430 to the vertical direction 104 and downwardly through the dispensing plate 432 at the bottom of the dispensing hood 430. The dispensing hood 430 effectively prevents the problem of ice cream or smoothies splashing everywhere when they are pushed out from the freezing cylinder in traditional cold drink dispensers.

The dispensing hood 430 comprises a U-shaped shroud 434 and a connecting portion 436. The U-shaped shroud 434 is provided with a cavity, the top and bottom of which extend vertically through the U-shaped shroud 434. The sidewalls of the U-shaped shroud are fixedly connected to the dispensing cap 354 and abut adjacent to the axial plate 358 that is provided with the dispensing port 266. The connecting portion 436 is installed obliquely at the bottom of the U-shaped shroud 434, connecting the bottoms of the two sidewalls of the U-shaped shroud 434. The connecting portion 436 and the bottom of the U-shaped shroud 434 jointly form the dispensing hood 430 that directs ingredients downwardly in the vertical direction 104.

The handle 112 is pivotally connected to the dispensing cap 354 through a pivotal connection. The handle 112 can rotate with respect to the U-shaped shroud 434 that is fixedly connected to the dispensing cap 354 allowing the handle 112 to swing flexibly to open or close the dispensing apparatus 110. The sidewall of the U-shaped shroud 434 is fixedly connected to the dispensing cap 354, forming an enclosed or semi-enclosed space. This effectively prevents ice cream or smoothies from splashing and leaking during the discharging process, reducing their contact with the external environment and ensuring their quality.

To allow pivotal movement of the handle 112, the dispensing hood 430 can include a cutout 438 disposed at the top of the U-shaped shroud 434. During the process of dispensing of ingredients, the handle 112 of the dispensing apparatus 110 is frequently swung longitudinal outwards to release the material, which may easily collide with the U-shaped shroud 434 and cause damage. Therefore, a cutout 438 provided at the top of the U-shaped shroud 434, allowing the handle 112 to slide along the slope during the dispensing process rather than directly hitting the hard edge of the U-shaped shroud 434. This extends the service life of both the handle 112 and the dispensing hood 430.

The connecting portion 436 is installed at the bottom of the U-shaped shroud 434 and forms a first discharge outlet together with the bottom of the U-shaped shroud 434. This allows ice cream or smoothies to slide down from the connecting portion 436 to the dispensing plate 432, further facilitating the smooth discharge of ice cream or smoothies. At the same time, the connecting portion 436 also helps reduce the accumulation and clogging of ice cream or smoothie at the dispensing port 266 located in the dispensing cap 354, improving the smoothness and efficiency of discharging.

The bottom of the dispensing hood 430 is detachably mounted with a dispensing plate 432, and the center of the dispensing plate 432 has a notch that forms the discharge outlet. The shape of the notch can be square, circular, or star-shaped. It is worth noting that the dispensing plate 432 is detachably mounted on the bottom of the dispensing hood 430, allowing replacement of the dispensing plate 432 at any time according to user needs, thereby enhancing the user experience.

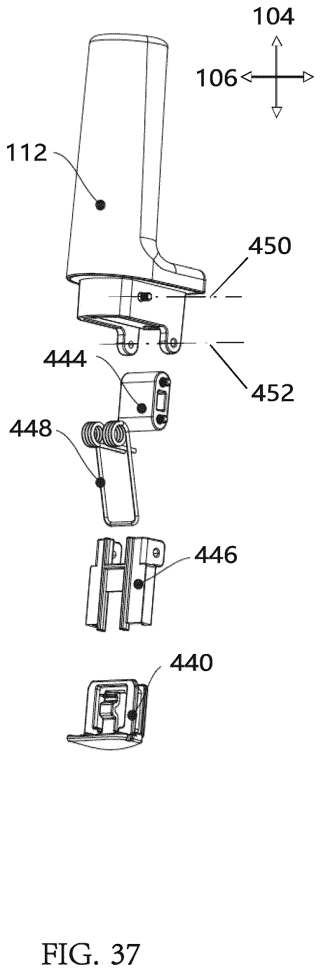

Referring to FIGS. 36 and 37, to occlude and open the dispensing plate 432, the dispensing apparatus 110 includes a sealing valve 440 that can be moved in the vertical direction 104 adjacently against and apart from the dispensing seat 432 by operation of the handle 112. When the sealing valve 440 is against the dispensing plate 432, material is unable to flow vertically through the orifice and out of the dispensing apparatus 110. The sealing valve 440 functions as a poppet valve and the dispensing plate 432 functions as a valve seat to control the dispensing of material from the spout 114. The sealing valve 440 is also located adjacent to the dispensing port 266 dispensing in the axial plate 358 of the dispensing cap 354. When the sealing valve is vertically moved with respect to the dispensing cap 354, the dispensing port 266 is resultingly opened allowing ingredients to flow from the cooling/mixing vessel 142 or is closed blocking the flow of ingredients. The sealing valve 440 functions as a gate valve that opens and closes the dispensing port 266 of the dispensing apparatus 110 thus controlling communication with the cooling/mixing vessel 142 and the flow of ingredients from the vessel chamber 206.

To move the sealing valve 440 in the vertical direction 104 by pivoting the handle 112, the handle 112 and sealing valve 440 are operatively linked by a linkage 442. The linkage 442 physically connects the handle 112 with the sealing valve 440, controlling the movement of the sealing valve 440, which in turn controls the opening and closing of the dispensing port 266 in the dispensing cap 354 and the dispensing plate 432 attached to the dispensing hood 430. Pivoting of the handle 112 causes the linkage 442 to move the sealing valve 440 in the vertical direction 104 relative to the dispensing cap 354. The movement of the linkage 442 moves the sealing valve 440 vertically from the dispensing plate 432 to open dispensing apparatus 110. Simultaneously the sealing valve 440 is moved vertically away from the dispensing port 266 in the dispensing cap 354. At this point, ingredients flow from the dispensing port 266 into the dispensing hood 430 and are then discharged from the dispensing apparatus 110 through the dispensing plate 432 attached to the dispensing hood 430, thereby completing the discharging of ice cream or ice smoothie.

Through the cooperation of the handle 112, linkage 442, and sealing valve 440, precise and rapid opening and closing of the second discharging port are achieved. This not only significantly improves the efficiency of the discharging process but also makes the entire production workflow more flexible, allowing for quick adjustments to the discharging volume based on actual needs and enhancing the discharging efficiency of ice cream or ice smoothie. The sealing valve 440 is partially or entirely made of food-grade rubber material, ensuring that ice cream or ice smoothie can be fully retained within the dispensing cap 354 when discharging is not required. For example, the sealing valve 440 may include a food-grade rubber piece affixed to a plastic or metal body. This avoids material leakage or splashing that may occur with traditional mechanical discharging methods, thereby reducing unnecessary material waste.

Referring to FIG. 37, the linkage 442 may include a first link part 444 and a second link part 446. The first hinging point of the handle 112 is rotatably installed on the dispensing cap 354, while the second hinging point of the handle 112 is rotatably connected to the top of the first link part 444. The bottom of the first link part 444 is pivotally connected to the top of the second link part 446, and the bottom of the second link part 446 is fixedly connected to the sealing valve 440. In the initial state, the first and second link part 444, 446 are aligned with the vertical direction 104. The linkage 442 is also associated with a return torsion spring 448 that biased to maintain alignment of the first and second link parts 444, 446 with respect to the vertical direction 104 and thereby normally closing the dispensing port 266 and dispensing plate 432.

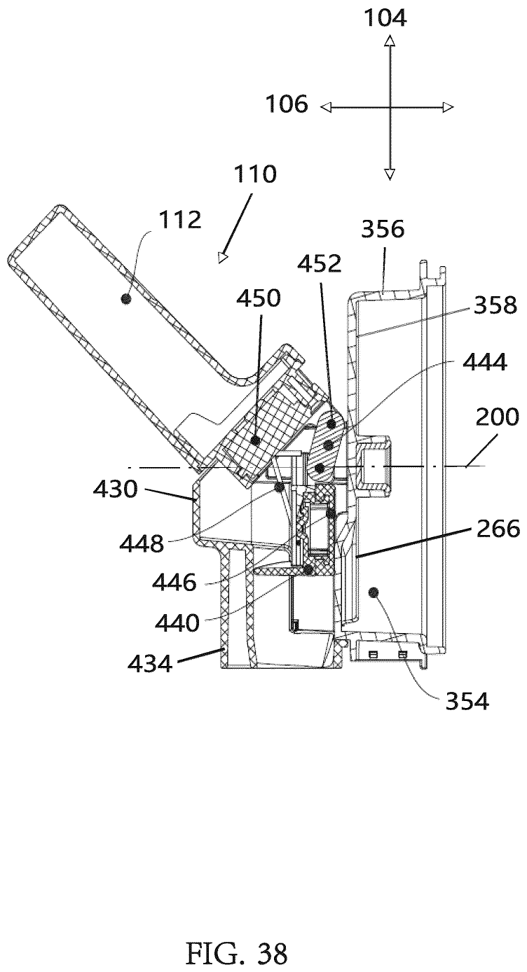

The hinge points of the handle 112 to the dispensing cap 354 and the linkage 442 are parallel to each other and aligned in the lateral direction 108. For example, referring to FIG. 38, the first hinge point 450 may correspond to the pivotal connection between the handle 112 and the dispensing cap 354. The second hinge point 452 may correspond to the pivotal connection between the handle 112 and the first link part 444 if the linkage 442.

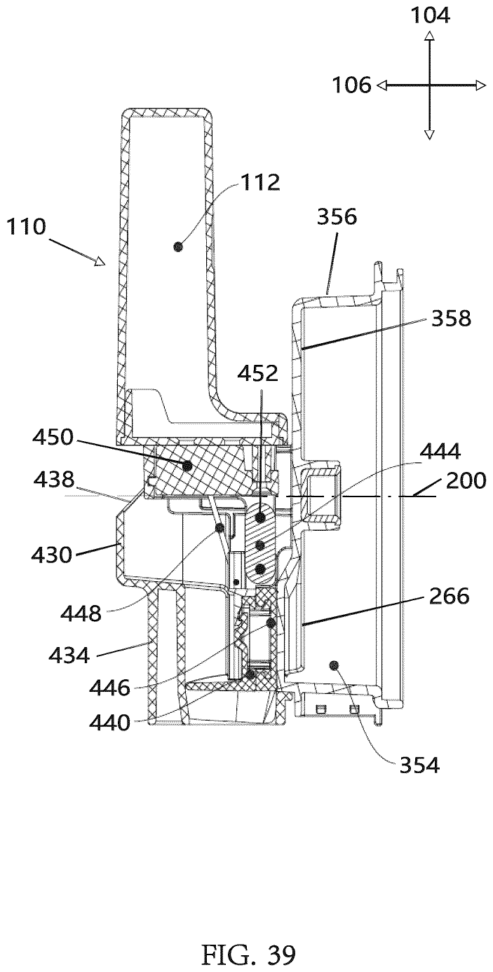

Referring to FIGS. 38 and 39, by defining the direction of the line connecting the first hinge point 450 and the second hinge point 452 of the handle 112, it can be effectively ensured that when the handle 112 is swung outwards, it sequentially drives the first link part 444 and the second link part 446 to move. This causes the bottom of the second link part 446 to drive the sealing valve 440 to move upwardly in the vertical direction 104, allowing the sealing valve 440 to open the dispensing port 266 in the dispensing cap 354 so that ingredients can be extruded from the into the dispensing hood 430 and redirected toward the dispensing plate 432, completing the dispensing of ice cream or smoothies. When the handle 112 is pivoted upright, it sequentially drives the first link part 444, the second link part 446, and the sealing valve 440 to move vertically downward, causing the sealing valve 440 to seal the dispensing port 266 of the dispensing cap 354, thereby stopping the dispensing of ingredients.

The cascaded design of the first link part 444 and the second link part 446 forms a stable linkage chain. This design not only enhances the stability of the transmission but also makes the movement of the sealing valve 440 smoother and more precise during the opening and closing processes.

The return torsion spring 448, which comprises a winding section and a transmission section from top to bottom if operatively connected to the linkage 442. The winding section is wound around the first hinge point 450 of the handle 112, and the transmission section is fixedly connected to the front side of the second link part 446. When the handle 112 is swung outwards, the rear end of the handle 112 lifts upwards in the vertical direction 104, causing the first link part 444 to move upwards, thereby driving the rear side of the second link part 446 to move upwards as well. At the same time, the return torsion spring 448 undergoes deformation under the action of the handle 112, and the linkage 442 drive the front side of the second link part 446 to move upwards. Both the front and rear sides of the second link part 446 are driven vertically upwards, causing the second link part 446 to drive the sealing valve 440 to move upwards together, ensuring that the sealing valve 440 opens the dispensing port 266.

When the operator releases the handle 112, the return torsion spring 448 resets the handle 112 to return to the upright position. The first link part 444 moves downwards in the vertical direction 104 under the action of the handle 112, causing the second link part 446 to move downwards under the action of both the return torsion spring 448 and the first link part 444. The downward movement of the linkage 442 in the vertical direction 104 causes the sealing valve 440 to move downwards and close the dispensing port 266 and the dispensing plate 432. The sealing valve 440 is made of food-grade rubber material.

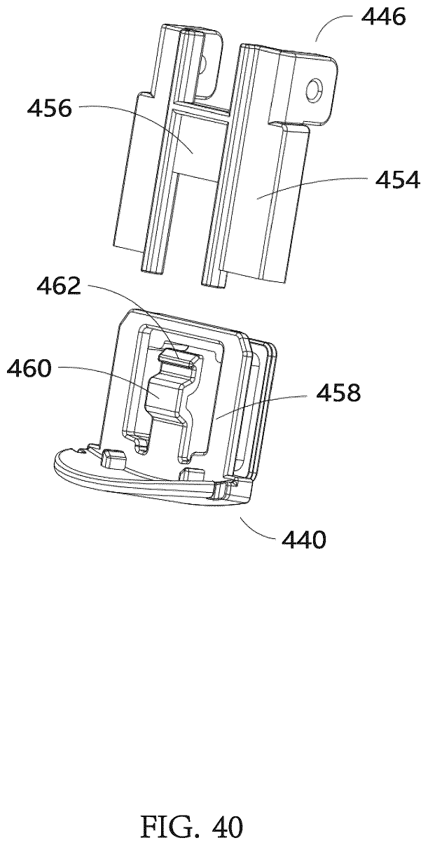

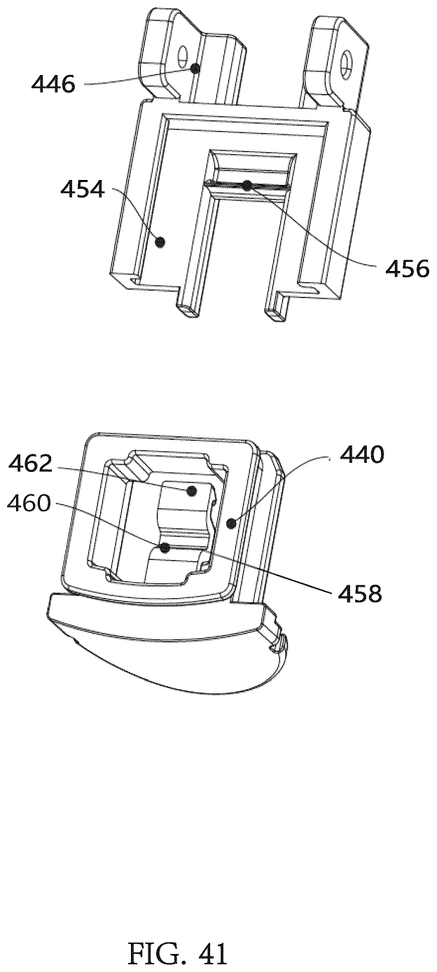

Referring to FIGS. 40 and 41, to moveably connect the sealing valve 440 with the linkage 442, the bottom of the second link part 446 is equipped with a downward-facing sealing slot 454, which slidingly connects with the left and right sides of the sealing valve 440. The second link part 446 is also provided with a first latching block 456 at the top rear side of the sealing slot 454, and the top front side of the sealing valve 440 is equipped with a second latching block 458. The first latching block 456 and the second sealing latching block 458 latch with each other.

Among them, the first latching block 456 is provided on the second link part 446, and the second sealing latching block 458 is provided on the sealing valve 440, allowing the sealing valve 440 to be detachably installed on the second link part 446. When users need to clean the equipment, they can quickly detach the sealing valve 440 by separating the first latching block 456 and the second latching block 458, facilitating cleaning and replacement of the sealing valve 440.The first latching block 456 has a hook structure with an upward-tilted end, and the second latching block 458 comprises an elastic protrusion portion 460 and a hook portion 462. The bottom of the elastic protrusion portion 460 is connected to the sealing valve 440, and the top of the elastic protrusion portion 460 is connected to the hook portion 462. The hook portion 462 latches with the hook structure on the second link part 446.

Pressing the elastic protrusion portion 460 causes it to sink inward, which in turn drives the hook portion 462 to move away from the hook structure of the second link part 446. By pulling the sealing valve 440 downwards, the sealing valve 440 can be quickly detached. When installing the sealing valve 440, the element is pushed upwards so that the hook portion 462 encounters the hook structure of the second link part 446. At this point, the elastic protrusion portion 460 cause the hook portion 462 and the hook structure of the second link part 446 together and latch them, thereby completing the installation of the sealing valve 440 to the linkage 442.

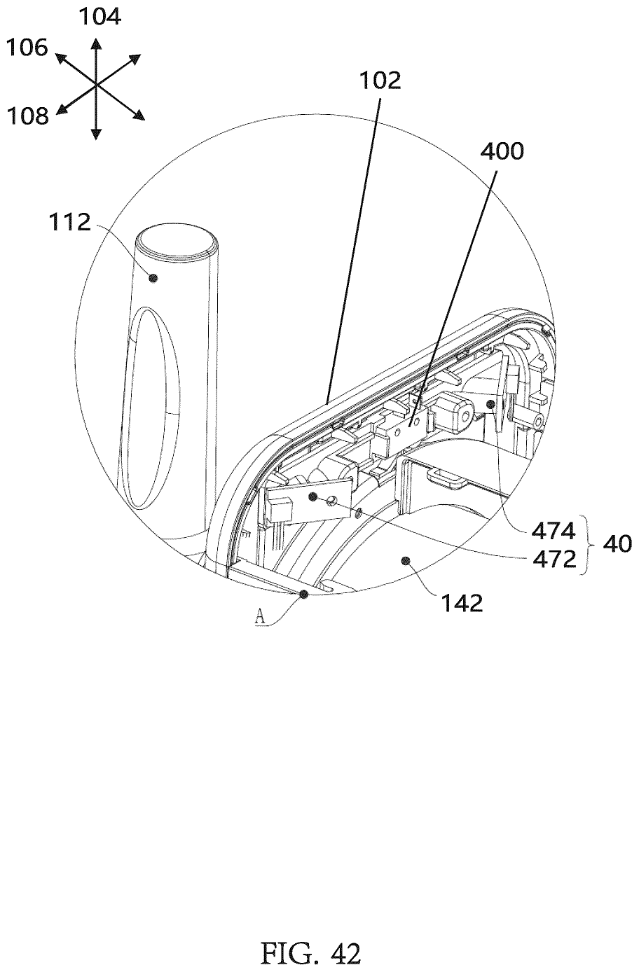

In a further embodiment, referring to FIG. 42, a dispensing sensor 470 may be included with the mixed-used refrigeration machine 100 to determine if refrigerated ingredients are being actively dispensed from the cooling/mixing vessel through the dispensing apparatus 110. To enable the dispensing apparatus 110 to be attached from the front panel 120, the dispensing apparatus 110 is configured to operate in a non-contacting manner. For example, the dispensing sensor 470 does not require any communication connections between the dispensing apparatus 110 and the exterior housing 102 of the mixed-used refrigeration machine 100. The dispensing sensor 470 is electrically connected to the mixing motor 146, for example, via the electronic controller 132 associated with the mixed-use refrigeration machine 100, and is configured to identify a positional state of the handle 112 of the dispensing apparatus 110 as to adjust an operating state of the drive motor 146; and the mixing motor 146 is configured to adjust a stirring speed of the cooling/mixing vessel 142.

Referring to FIG. 42, in an embodiment, the non-contacting dispensing sensor 470 is configured as an optical sensor that can send and receive infrared light to sense the position of the handle 112 of the dispensing apparatus 110. When the handle 112 is held naturally or swung down slightly, the dispensing sensor 470 captures the action instantaneously and identifies it as a discharge request. Then, the dispensing sensor 470 adjusts the operating state of the mixing motor 146 associated with the cooling/mixing vessel 142 and accelerates the stirring speed of the agitator to ensure the ice cream or smoothie is pushed out uniformly and delicately. This operation keeps the original soft mouthfeel of the ice cream or the smoothie and ensures that each bite of the ice cream or the smoothie can have the best flavor and the best mouthfeel.

When the handle 112 is released, the dispensing sensor 470 adjusts the operating state of the mixing motor 146 and lowers the stirring speed of the agitator within the cooling/mixing vessel 142. This prevents texture change or crystal formation of the ice cream or the smoothie for excessive stirring and excessive refrigeration and further ensures the mouthfeel and flavor of the ice cream or the smoothie. With cooperation among the dispensing sensor 470, the mixing motor 146, and the cooling/mixing vessel 142, the mixed-use refrigeration machine 100 starts a corresponding working mode only in case of a real discharge requirement. This solves the problem that the stirring system in the conventional cold beverage maker often operates continuously even in case of no discharge requirement to result in deterioration of the ice cream or the smoothie for longtime stirring.

Referring to FIG. 42, the dispensing sensor 470 is associated with the sensor bar 402 attached to the inner face of the front panel 120 and located tangentially above the dispensing opening 352 disposed through the front panel 120. The dispensing sensor 470 includes an infrared generator 472 and an infrared receiver 474. The infrared receiver 474 is electrically connected to the mixing motor 146, for example, via the electronic controller 132 associated with the mixed-use refrigeration machine 100. The infrared generator 472 is configured to emit infrared light toward the handle 112 of the dispensing apparatus 110. The infrared receiver 474 is configured to receive infrared light reflected by the handle 112.

The infrared generator 472 emits the infrared light accurately toward the handle 112. If the handle 112 is held or the handle 112 is swung down, as would occur during dispensing of the refrigerated ingredients, the infrared light cannot be irradiated on the handle 112 and cannot be reflected. The infrared receiver 474 cannot receive the infrared light reflected by the handle 112. The dispensing sensor 470 adjusts the operating state of the mixing motor 146 according to the signal and accelerates the stirring speed of the cooling/mixing vessel 142.

If the handle 112 is released, in response to the initial state of the handle 112, the infrared generator 432 can emit the infrared light to the handle 112 of the dispensing apparatus 110. The handle 112 reflects the light, and the infrared receiver 474 can receive the reflected infrared light. The infrared receiver 474 can adjust the operating state of the motor drive 146 associated with the cooling/mixing vessel 142 according to the signal and lowers the stirring speed of the cooling/mixing vessel 142, thereby preventing separation of ingredients due to high stirring speed.

Therefore, with cooperation between the infrared generator 472 and the infrared receiver 474, the present disclosure can accurately determine whether a discharge operation is required by the present cold beverage maker and correspondingly adjust the operating state of the mixing motor 146 and the operating state of the agitator 208. Such an instant response mechanism ensures that the ice cream or the smoothie is pushed out at the best time, keeps the original flavor and mouthfeel of the ice cream or the smoothie, and prevents the unnecessary energy waste.

Referring to FIG. 42, the infrared generator 472 and the infrared receiver 474 of the dispensing sensor 430 are respectively at opposite lateral sides of the handle 112. The infrared generator 472, the infrared receiver 474, and the handle 112 form a triangular arrangement. In the embodiment, the infrared generator 472 and the infrared receiver 474 are defined positionally. In response to a non-dispensing state of the mixed-use refrigeration machine 100, the infrared generator 472 can emit the infrared light to the handle 112, and the infrared receiver 474 can receive the infrared light reflected by the handle 112 thereby ensuring stability and reliability of the cold beverage maker. When the handle 112 is held or the handle 112 is pulled for dispensing, the triangular arrangement can ensure that the infrared receiver 474 cannot receive the infrared light from the infrared generator 472 to improve the operational accuracy of the mixed-use refrigeration machine 100.

In response to dispensing of the ice cream or the smoothie, a rotational speed of the cooling/mixing vessel 142 is accelerated by the mixing motor 146. This ensures that the mixed-use refrigeration machine 100 can convey the ice cream or the smoothie to the outside stably, but also can make agitator contact the inner wall of the cooling/mixing vessel 142 frequently and greatly increases a heat exchange area between the ice cream or the smoothie and the cooling/mixing vessel 142, thereby significantly accelerating release of heat in the ice cream or the smoothie, and improving the overall refrigeration efficiency. Consequently, the ice cream or the smoothie can keep the ideal mouthfeel and the ideal flavor when discharged.

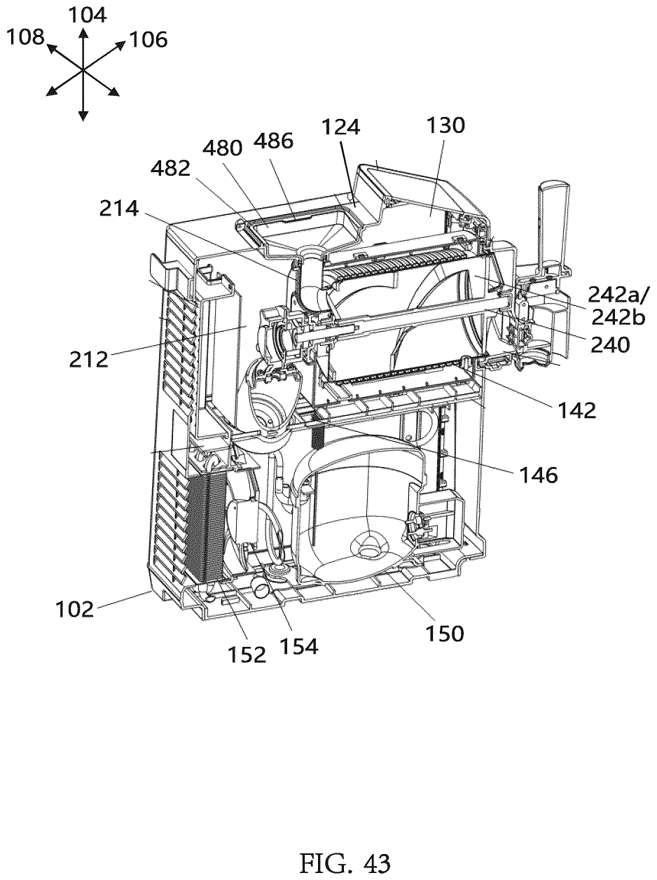

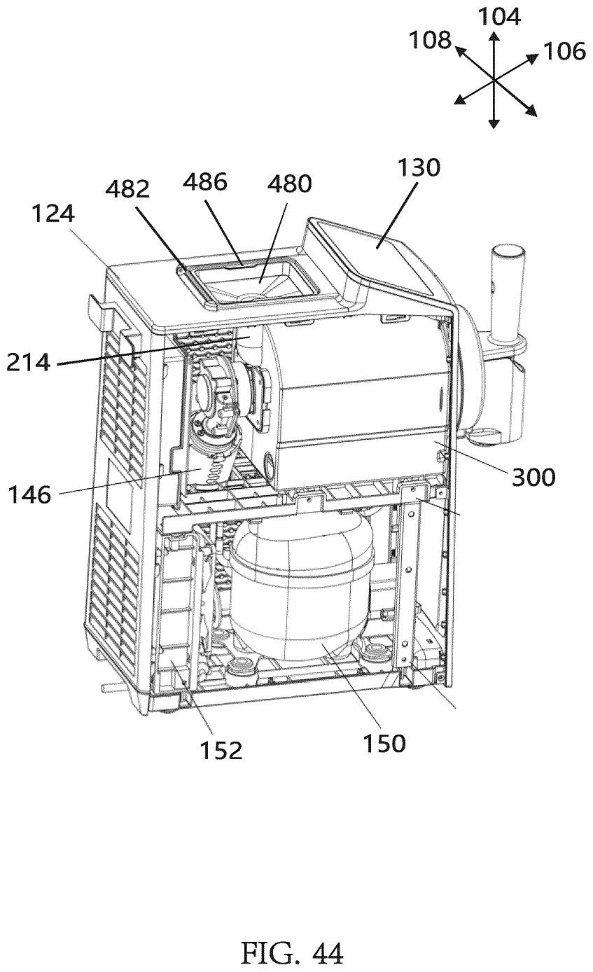

Referring to FIGS. 43 and 44, there is illustrated another embodiment of the mixed-use refrigeration machine 100. The internal arrangement of the components and the operations is generally as described above. The exterior housing 102 includes features to assist in operation. For example, the control panel 130 that is associated with the ceiling panel 124 can be disposed at an inclined angle with respect to the vertical and longitudinal directions 104, 106. The inclined angle is directed forwardly towards the front panel 120 so as to improve viewing during operation of the mixed-use refrigeration machine 100. The control panel 130 may still touch screen characteristics and the functionality described above.

The hopper 126 can be disassembled to improve cleanliness. For example, the hopper 126 can include a hopper basket 480 shaped as a prismatic funnel that connects to the feed pipe 214 that communicates with the feed inlet 212 to the cooling/mixing vessel 142. The hopper basket 480 includes inclined surfaces that descend in the vertical direction toward the feed pipe 214. The ceiling panel 124 can have a hopper opening 482 disposed into the surface that can accommodate the hopper basket 480. The hopper opening 482 can have a polygonal shape to correspond in geometry with the hopper basket 480 and is located longitudinal rearward of the control panel 130.

The hopper basket 480 is detachable from the exterior housing 102 and can be removed from the hopper opening 482 for periodic cleaning. For example, the bottom of the hopper basket 480 includes a feed aperture 484 that is circular in shape to correspond to the feed pipe 214. The circular aperture 484 and the feed pipe 214 are associated with a tongue and groove structure that allows the hopper basket 480 to mate with the feed pipe 214 in a leak-tight manner. The upper edges of the hopper basket 480 can include a finger hold 486 disposed into the lateral walls to allow for lifting of the hopper basket 480 from the hopper opening 482 and away from the ceiling panel 124 in the vertical direction 104. The tongue-and-groove structure between the feed aperture 484 and the feed pipe 214 enable simple and toolless detachment and reattachment of the hopper basket 480.

### Mixed Use Operation

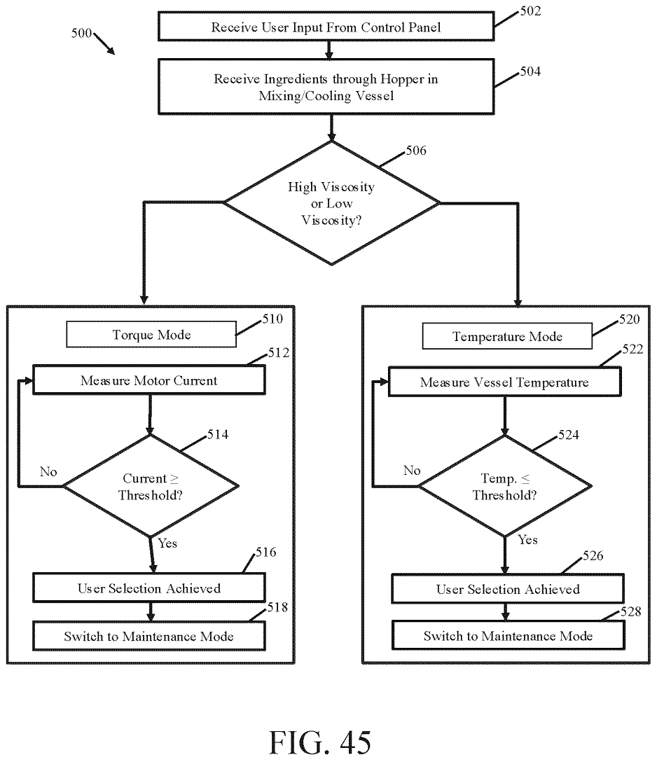

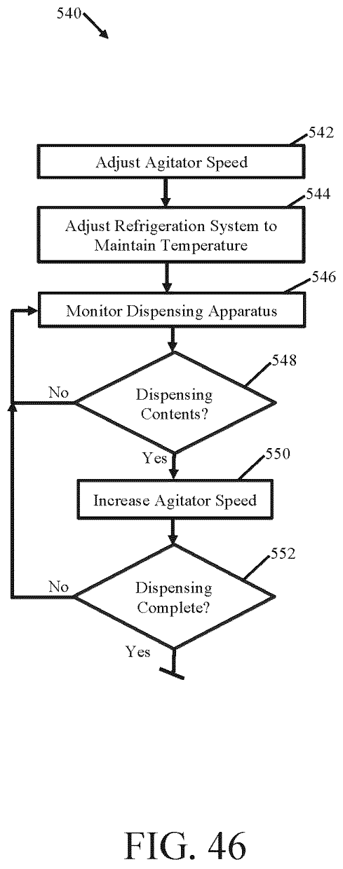

Referring to FIGS. 45 and 46, with continued reference to proceeding FIG. 1-44, the mixed-use refrigeration machine 100 is configured for mixed-use operation to produce a variety of edible products, which differ by viscosity/thickness, temperature and consistency. FIGS. 45 and 46 represent an algorithm 500 that the electronic controller 132 associated with the mixed-use refrigeration machine 100 can implement to produces low-temperature products such as ice cream, semi-frozen beverages, and cold drinks that differ in viscosity/thickness and temperature. The algorithm 500 shown in FIGS. 45 and 46 can be embodied as a computer-readable program and may be executed by the processor and stored in the memory associated with the electronic controller.

Two features of the mixed-use refrigeration machine 100 can regulate the operation of include the agitation speeds of the agitator as determined by the mixing motor, which may be a variable speed bi-directional motor, and temperature which can be adjusted by modulating the refrigeration system 144, such as by activating and deactivating the refrigeration system 144. The algorithm 500 may also control other operations of the mixed-use refrigeration machine 100.

Preparation of the low-temperature product can occur in multiple steps including a mixing or agitation step in which the ingredients introduced to the cooling/mixing vessel 142 are blended to produce the desired product and a maintenance step in which the blended ingredients are maintained until dispensing from the cooling/mixing vessel 142 through the dispensing apparatus 110. The mixing step is characterized by use of higher agitation speeds produced by the mixing motor to ensure throughout mixing and desired viscosity/thickness and consistency. The maintenance step is characterized by lower speeds to preserve the viscosity/thickness and consistency and modulating the refrigeration system 144 to conserve power.

In a selection step 502, the user may enter a selection through the control panel 130 located on the external housing 102 that indicates the type of product they desire the mixed-use refrigeration machine 100 to produce. The user selection may be indicative of the viscosity/thickness of the produce such as a frozen semi-solid product like ice cream or a flowable semi-liquid product like a smoothie. The user selection may also be indicative of the desired temperature of the produce such as a cold drink. The selection step 502 may be accompanied by an ingredient step 504 in which the ingredients for the desired product are introduced to the cooling/mixing vessel 142 using the hopper 126 located on the exterior housing 102 and which are directed to the vessel chamber 206 by the feed pipe 214. If the desired product is ice cream, the ingredients may comprise dairy items such as milk. If the desired product is a juice or slushy, the desired product may include fruit juices.

The two typical products can be categorized as frozen solids such as ice cream or soft server which are still flowable but have been cooled to the point of crystallization of the ingredients and beverages that are characterized as still substantially liquid. To produce products that differ by viscosity/thickness and temperature, the algorithm 500 regulates the refrigeration machine via different operations. The algorithm 500 may include a product recognition step 506 in which the electronic controller 132 determines if the user input is indicative of a solid frozen item like ice cream or a substantially more fluid item like a slushy or juice.

If the product recognition step 506 recognizes that the desired product is a frozen good or solid, the electronic controller 132 may implement a torque mode 510 in which the electronic controller primarily uses the torque output of the mixing motor 146 to regulate operation of the cooling/mixing vessel 142. For example, the electronic controller 132 is in electronic communication with the motor sensor 148 associated with the mixing motor 146 and can measure electrical characteristics associated with the mixing motor. As an example, the motor sensor 148 may be a current sensor measuring the current drawn by the mixing motor 146. The current draw of the mixing motor 146 is indicative of the power consumed and thus the torque produced. The torque applied to the agitator 208 is indicative of the viscosity and/or thickness of the ingredients in the cooling/mixing vessel 142 and thus the electronic controller 132 can utilize the torque measurements to indirectly assess the characteristics of the ingredients during operation.

The torque mode 510 may also use other characteristics of the mixing motor to estimate the torque such as power, voltage, and/or speed also measurable by the motor sensor 148. For example, the motor sensor 148 may be a speed sensor measuring the rotational speed of the mixing motor 146. The rotational speed of the mixing motor 146 may be indicative of the resistance to the agitator 208, which may be indicative of the viscosity and/or thickness of the ingredients of the cooling/mixing vessel 142. Thus, the electronic controller 132 may utilize the rotational speed to indirectly assess the characteristics of the ingredients during operation.

In an example, during the torque mode 510, the electronic controller 132 can conduct a current measurement step 512 using the motor sensor 148 to measure the current draw of the mixing motor 146. In a current comparison step 514, the electronic controller 132 compares the measured current with a threshold current that may have been determined empirically. In the example the measured current and threshold current are both representative of the torque produced by the mixing motor 146. Based on the current comparison step 514, the torque mode 510 can make a determination, for example in a determination step 516, as to the viscosity/thickness of the ingredients in the cooling/mixing vessel 142. The determination step 516 anticipates that a viscosity/thickness change of the ingredients will occur based on the initial selection by the user during the selection step 502.

If the determination step 516 recognizes that the viscosity/thickness of ingredients has changes, i.e., the ingredients have become fully mixed and thickened such that the viscosity of the ingredients increases, the torque mode 510 can switch to a maintenance mode 518 in which the electronic controller 132 regulates the operation of the mixed-use refrigeration machine 100 to maintain the frozen/thicken state of the ice cream. For example, the threshold current may be set to a level that indicates the mixing motor is exerting sufficient torque indicating that the ingredients are in a frozen or solid phase. The maintenance mode 518 can be characterized by lower the rotation speed of the agitator 208 and modulating activity of the refrigeration system 144 to conserve power.

In addition to the torque mode 510, the electronic controller 132 can be programed to implement a temperature mode 520. If the product recognition step 506 recognizes that the desired product is a low-temperature liquid or an ice-liquid mixture, the temperature mode 520 can be used in which the electronic controller 132 primarily uses the temperature of the ingredients to regulate operation of the cooling/mixing vessel 142. If the desired product is in a liquid state or an ice-liquid mixture state, temperature provides for a more accurate regulation since the ingredients do not undergo a substantial viscosity or thickness change or substantially alter the resistance to the mixing motor 146.

During the temperature mode 520, the electronic controller 132 can measure the temperature of the ingredients in the cooling/mixing vessel 142 in a temperature measurement step 522. For example, the electronic controller 132 is in electrical communication with at least one of the temperature sensors 228a, 228b and can measure directly the temperature of the ingredients in the cooling/mixing vessel 142. In other examples, the electronic controller may indirectly measure the temperature of the ingredients using characteristics of the refrigeration system 144.

Based on the measured temperature, the temperature mode 520 can make a temperature comparison 524 in which the measured temperature is compared with a temperature threshold. The temperature threshold can be related to the desired product and may be determined by the user selection during the selection step 502. For example, the electronic controller 132 may be programmed with a lookup table in electronic form that can relate the user selection to the desired output temperature of the product. In another example, the user may directly set the desired temperature using the control panel 130 associated with the electronic controller 132.

Based on the temperature comparison step 524, the electronic controller 132 can regulate operation of the refrigeration system 144 to produce the desired beverage. For example, if the measured temperature is greater than the threshold, the temperature mode 520 may determine that the desired beverage selected by the user has not been achieved and control the refrigeration system 144 to decrease the temperature of the ingredients in the cooling/mixing vessel 142. If the temperature comparison 524 determines that the measured temperature is lower than or equal to the threshold, the temperature mode 520 may proceed to a determination step 526 that determines the cooling/mixing vessel 142 has achieved the desired temperature of the beverage selected by the user. The temperature mode 520 can proceed to a maintenance mode 528.

Referring to FIG. 46, when the product in the cooling/mixing vessel 142 reaches the desired viscosity/thickness and/or temperature depending on the user selection, the algorithm 500 enters the maintenance mode 540 at steps 518 or 528. The maintenance mode 540 is characterized as maintaining those desired properties of the beverage product. For example, in the maintenance mode 540, the electronic controller 132 can conduct an initial adjustment step 542 in which the rotational speed of the agitator 208 is adjusted by adjusting the speed of the mixing motor 146. The speed of the mixing motor 146 may be increased or reduced at the adjustment step 542 depending on various factors, such as the temperature measurements by the temperature sensors 228a, 228b. For example, the motor speed may be reduced to maintain the consistency of the product in the cooling/mixing vessel 142 if the user selection is ice cream or soft serve, for which, prolonged agitation after freezing could breakdown the crystallization and result in undesired product characteristics. In the case of a slushy, excessive agitation could alter the desired consistency.

Accordingly, in an embodiment, the electronic controller 132 can operate the variable speed mixing motor 146 at different motor speeds. For example, a first mixing speed may be higher than a second maintenance speed to agitate the ingredients in the cooling/mixing vessel initially to ensure mixing and, in the example of ice cream, aeration. By way of example, the first mixing speed of the agitator 208 driven by the mixing motor 146 may be 90 to 140 RPM for frozen edibles like ice cream and 70-100 RPM for cold beverages. The second maintenance speed may be lower, e.g., 25-100 RPM, and preserve the achieved consistency. In some examples such as beverage, the motor speed may be constant between the mixing and maintenance steps.

In an alternative embodiment, the adjustment step 542 may be omitted. In the example of a cold drink such as juice or cocktail, the first mixing speed and the second maintenance speed of the mixing motor 146 may be the same. That is, when the ingredients in the cooling/mixing vessel reach the desired property, the mixing motor 146 continues to use the same speed during the maintenance mode 540.

The maintenance mode 540 is further characterized by an adjustment step 544 that adjusts the operation of the refrigeration system 144 to maintain the temperature of the edible product. In the example of ice cream or soft serve, when the ingredients reach a desired viscosity, e.g., a high viscosity corresponding to the current draw of the mixing motor that matches or exceeds the current threshold, the electronic controller 132 records the temperature of the ingredients and sets it as a temperature threshold. The adjustment step 544 may be characterized by an adjustment of the operation of the refrigeration system 144 to maintain the edible product at the temperature threshold corresponding to the desired viscosity. For example, the electronic controller 132 may compare the temperature measurements from the temperature sensor 228a/228b with the temperature threshold and activate/deactivate the refrigeration system 144 responsively.

In the example of a cold drink such as juice or cocktail, when the ingredients reach a desired temperature, e.g., the preset temperature corresponding to the product selected by the user, the electronic controller 132 sets the preset temperature as a temperature threshold. The adjustment step 544 may be characterized by an adjustment of the operation of the refrigeration system 144 to maintain the edible product at the temperature threshold. For example, the electronic controller 132 may compare the temperature measurements from the temperature sensor 228a/228b with the temperature threshold and activate/deactivate the refrigeration system 144 responsively.

Alternatively, if the cooling/mixing vessel 142 is accommodated in the insulation housing 300, the insulation housing can keep the temperature of the product adequately low to allow complete deactivation of the refrigeration system 144.

The maintenance mode 540 can be responsive to dispensing of the contents from the cooling/mixing vessel 142. For example, if the dispensing apparatus 110 is operated to dispense ice cream, the electronic controller 132 can responsively adjust operation of the mixed-use refrigeration machine 100. In a monitoring step 546, the electronic controller 132 monitors the dispensing apparatus 110, for example, using the dispensing sensor 430 that monitors operation of the handle 112. In a dispensing decision step 548, the electronic controller 132 may determine the contents of the cooling/mixing vessel 142 are being dispensed through the dispensing apparatus 110 by signals received from the dispensing sensor 430.

The electronic controller 132 may response to the affirmative determination of the dispensing decision step 548 by increasing the agitator speed in a speed adjustment step 550, for example by increasing the rotational speed of the mixing motor 146. Increasing the speed of the agitator 208 moves the ingredients longitudinally in the vessel chamber 206 toward the second axial end 204 and the dispensing apparatus 110 to assist in dispensing contents through the spout 114. In the example of thickened contents such as ice cream, gravity may not be sufficient to cause flow through the dispensing apparatus 110 and the speed adjustment step 550 assists in discharging the product.

The maintenance mode 540 may also include a completion determination 552 that determines that dispensing is complete and that causes the electronic controller 132 to again reduce the rotational speed of the agitator 208. The dispensing complete determination 552 can be accompanied by an operation to reduce the overflow from the cooling/mixing vessel 142. For example, the electronic controller 132 includes programming causing the rotational direction of the mixing motor 146 to be revered to cause the reflow flanges 260 to rotate past the dispensing port 266 disposed in the dispensing cap 254 of the dispensing apparatus 110. The reflow flanges 260 cause the ingredients to move longitudinally rearward via the reflow groove 265 from the second axial end 204 associated with the dispensing outlet 218 toward the first axial end 202 of the chamber barrel 220.

The foregoing operations and steps of the algorithm are examples only and the order and sequence of the steps may change, steps may be added or omitted, and the steps may be combined and reordered in any suitable manner.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A mixed-use refrigeration machine for preparing an edible product comprising:
a cooling/mixing vessel defining a vessel chamber for receiving ingredients for producing the edible product and an agitator rotatably disposed in the vessel chamber for mixing the ingredients;
a refrigeration system associated with the cooling/mixing vessel to refrigerate the ingredients;
a mixing motor coupled to the agitator to rotate the agitator;
a temperature sensor operatively arranged to measure a temperature of the ingredients;
a current sensor configured to measure operation of the mixing motor; and
an electronic controller operatively associated with the refrigeration system and the mixing motor and in communication with the temperature sensor and the current sensor, the electronic controller programmed to regulate operation of the mixed-use refrigeration machine in a torque mode in response to measurements from the current sensor and in a temperature mode in response to measurements from the temperature sensor.

2. The mixed-use refrigeration machine of claim 1, further comprising a control panel operatively associated with the electronic controller, the control panel adapted to receive a user input causing the electronic controller to operate in one of the torque mode and the temperature mode.

3. The mixed-use refrigeration machine of claim 1, wherein during the torque mode, the electronic controller compares a current draw of the mixing motor measured by the current sensor with a threshold current that is indicative of a high viscosity associated with the ingredients.

4. The mixed-use refrigeration machine of claim 3, wherein in response to the current draw matching or exceeding the current threshold, the electronic controller switches to regulate operation of the mixed-use refrigeration machine in a temperature maintenance mode that is responsive to measurements from the temperature sensor.

5. The mixed-use refrigeration machine of claim 4, wherein during the temperature maintenance mode, the electronic controller is configured to:
compares the temperature measurements with a temperature threshold corresponding to the high viscosity of the ingredients; and
activate and deactivate the refrigeration system responsively to the comparison of temperature measurements and the temperature threshold.

6. The mixed-use refrigeration machine of claim 1, wherein during the temperature mode the electronic controller is configured to compare measurements from the temperature sensor with a liquid temperature threshold indicative of a user input.

7. The mixed-use refrigeration machine of claim 6, wherein in response to the temperature measurements less than or equal to the liquid temperature threshold, the electronic controller switches to regulate operation of the mixed-use refrigeration machine in a temperature maintenance mode.

8. The mixed-user refrigeration machine of claim 7, wherein during the temperature maintenance mode, the electronic controller is configured to:
compares the temperature measurements with the temperature threshold; and
activate and deactivate the refrigeration system responsively to the comparison of temperature measurements and the temperature threshold.

9. The mixed-use refrigeration machine of claim 1, where the mixing motor is a variable speed motor and the electronic controller is configured to operate the mixing motor at a first mixing speed and a second maintenance speed, and the first mixing speed is faster than the second maintenance speed.

10. The mixed-use refrigeration machine of claim 1, wherein the electronic controller is configured to determine the ingredients are being dispensed from the vessel chamber and respond by increasing a speed of the mixing motor.

11. The mixed-use refrigeration machine of claim 1, further comprising a dispensing apparatus mounted with respect to the cooling/mixing vessel to dispense the ingredients from the vessel chamber, the dispensing apparatus associated with a handle for controlling dispensing.

12. The mixed-use refrigeration machine of claim 11, further comprising an optical sensor configured to detect operation of the handle.

13. The mixed-use refrigeration machine of claim 11 wherein:
the dispensing apparatus is detachably mounted to an exterior housing of the mixed-use refrigeration machine, and
the optical sensor is disposed on the exterior housing, the optical sensor comprising an infrared generator configured to direct light toward the handle and an infrared receiver configured to receive light reflected from the handle.

14. The mixed-use refrigeration machine of claim 11, wherein the cooling/mixing vessel further defines a vessel axis extending between a first axial end and a second axial, the second axial end associated with a dispensing outlet,
the mixed-use refrigeration machine further comprising a mounting clamp for mounting the dispensing apparatus to the exterior housing, wherein the mounting clamp is configured as a twist lock with tabs and recesses engaged by rotation with respect to the vessel axis, wherein the mounting clamp applies an axial force parallel to the vessel axis upon engagement by rotation with respect to the vessel axis.

15. The mixed-use refrigeration machine of claim 1, wherein the cooling/mixing vessel and the refrigeration system are operatively arranged for external cooling, and the refrigeration system includes a refrigerant conduit located externally on a vessel barrel surrounding the vessel chamber.

16. The mixed-use refrigeration machine of claim 15, wherein the cooling/mixing vessel includes a thawing gap proximate a dispensing outlet of the vessel barrel, the thawing gap characterized by the absence of the refrigerant conduit.

17. The mixed-use refrigeration machine of claim 1, wherein the cooling/mixing vessel further defines a vessel axis extending between a first axial end and a second axial, and the agitator includes at least one stirring blade spirally disposed about an agitator shaft coaxially aligned with the vessel axis, the at least one stirring blade and the agitator shaft radially offset from each other to define an agitator void for movement of the ingredients parallel to the vessel axis.

18. A method of preparing low-temperature edible products using a mixed-use refrigeration machine comprising:
receiving a user input indicative of a desired edible product;
receiving ingredients into a cooling/mixing vessel of the mixed-use refrigeration machine;
mixing the ingredients in the cooling/mixing vessel with an agitator coupled to a mixing motor;
cooling the ingredients in the cooling/mixing vessel with a refrigeration system operative associated with the cool/mixing vessel; and
in response to the user input, operating the cooling/mixing vessel in one of a torque mode responsive to operation of the mixing motor and a temperature mode responsive to temperature measurements of the ingredients.

19. The method of claim 18, further comprising, during the torque mode, comparing a current draw of the mixing motor with a threshold current that is indicative of a high viscosity associated with the ingredients and maintaining a temperature of the ingredients in response to the current draw matching or exceeding the current threshold.

20. The method of claim 19, wherein the step of maintaining the temperature of the ingredients comprises reducing a speed of the mixing motor and modulating the refrigeration system responsively to comparing the temperature measurements and a temperature threshold corresponding to the high viscosity of the ingredients.

21. The method of claim 18, further comprising, during the temperature mode, comparing the temperature measurements with a liquid temperature threshold indicative of the desired edible product and modulating the refrigeration system in response to comparing the temperature measurements with the liquid temperature threshold.

22. The method of claim 18, further comprising determining whether the ingredients are being dispensed from the cooling/mixing vessel and responsively increasing a speed of the mixing motor.

23. The method of claim 22, wherein the step of determining whether the ingredients are being dispensed includes directing light to a handle of a dispensing apparatus associated with the cooling/mixing vessel and receiving the light, by an optical sensor, reflected from the handle.

24. The method of claim 18, further comprising modulating the rotation of the mixing motor by reversing direction.

25. A mixed-use refrigeration machine for preparing edible products comprising:
a user-input unit for receiving a user input indicative of a desired edible product;
a vessel defining a vessel chamber for receiving ingredients and an agitator rotatably disposed in the vessel chamber for mixing the ingredients;
a refrigeration system associated with the cooling/mixing vessel to refrigerate the ingredients;
a motor coupled to the agitator to rotate the agitator; and
an electronic controller operatively associated with the motor and the refrigeration system and programmed to control the motor and the refrigeration system, in response to the user input, to selectively form the desired edible product in a first mode and form the desired edible product in a second mode according to the user input, wherein the desired edible product in the first mode includes an ice cream product and the desired edible product in the second mode includes a liquid product.
